(19) United States
(12) Patent Application Publication
(10) Pub. No.: US 2008/0207181 A1
(43) Pub. Date: Aug. 28, 2008

(54) Method and system for applying value added services on messages sent to a subscriber without affecting the subscriber's mobile communication

(75) Inventor: John Yue Jun Jiang, Danville, CA (US)

Correspondence Address: ARENT FOX LLP, 1050 CONNECTICUT AVENUE, N.W., SUITE 400, WASHINGTON, DC, 20036, US

(73) Assignee: Roamware

(21) Appl. No.: 11/711,891

(22) Filed: Feb. 28, 2007

(51) Int. Cl. H04Q 7/20; H04L 29/02; H04Q 7/22

(52) U.S. Cl. 455/414.1; 455/414.3; 455/432.1; 455/433; 455/466

(57) ABSTRACT

The present invention provides a method of applying one or more value added services (VAS) on messages sent to a subscriber without affecting the subscriber's mobile communication. The method includes receiving an activation request from the subscriber for activating one or more VAS, at a signaling gateway (SG). The method further includes retrieving the subscriber's visited switching address and the subscriber's address from a home location information database associated with the subscriber. Further, the method includes storing the subscriber's address, the subscriber's visited switching address, the home location information database address and an indication for activating the one or more VAS in a database associated with the SG. The method further includes updating the home location information database so as to redirect the messages, sent to the subscriber's address, to the SG. Finally, the method includes applying a logic corresponding to the VAS by the SG on the redirected messages.

### FIELD OF THE INVENTION

The present invention generally relates to providing one or more Value Added Service (VAS) to subscribers in communication networks. More specifically, the invention relates to facilitating subscriber's mobile communication while they are subscribed to one or more VAS in communication networks.

### BACKGROUND OF THE INVENTION

Mobile communication services are becoming increasingly popular. Therefore, there is a competition between different mobile operators for increasing their roaming revenues. More and more operators provide various VAS such as message (SMS) forwarding, call forwarding, message spam control etc to increase revenue. Also, many people own multiple handsets, so it is very likely that some subscribers would like to receive calls on one handset and messages on another handset. The subscribers may choose to have their messages forwarded to their alternate handset. In one instance, when the subscriber's handset runs out of battery or is left at home, the subscriber would like to forward both calls and messages to his alternate handset. In another instance, where the network operator(s) operates both Code Division Multiple Access (CDMA) and GSM networks, inter-standard message forwarding plays a vital role. There are various techniques for providing message forwarding solutions, such as, SMSC-based approach and SS7-based approach.

In the SMSC-based approach, the message can be sent, conditionally or unconditionally, by an SMSC, using standard routing procedure. When the SMSC receives a message, it performs an internal check to see if SMS forwarding is set or unset for the subscriber. In addition, the SMSC-based approach can send the messages to both, the subscriber and one or more alternate handsets, i.e., the forward-to numbers. However, this approach cannot forward the messages which are delivered from a non-home SMSC (national non-HPMN SMSC or international SMSC), which is directly sending the messages to an HPMN subscriber (roaming or non-roaming) via Signaling System 7 (SS7), without going through a home SMSC of the HPMN subscriber. To achieve the above, modifications are required at non-home SMSC to send SMS to the home SMSC first. Although in the national roaming case this solution might be possible, message delivery in case of international roaming will still be a problem, as it may require a global standard. In order to implement the above solution, a change in SMS interworking infrastructure is required, which will further require special efforts to handle billing and acknowledgements.

In some countries such as China, since all SS7 messages are intercepted to force international messages to be relayed through a gateway, message forwarding from international SMSC is possible. However, SMSC-based approach does not allow forwarding messages from non-home SMSC to the HPMN subscriber, unless, either every SMSC checks for a national database for all national subscribers, or every non-home SMSC is configured to forward all non-home destined messages to home SMSC. The first case is a non-scalable approach, and the second case requires a logistical and change in GSM/CDMA standard.

Alternatively, all SS7 signaling is to be intercepted to provide SMS forwarding. In the SS7-based approach, all SS7 Mobile Originating (MO) messages to SMSC and all SS7 Mobile Terminating (MT) messages from SMSC are intercepted to check for message forwarding or other VAS. In case of MO messages, an SMS intercepting platform may also perform direct message delivery or load balancing among several SMSCs in addition to providing various other VAS. However, this technique is very expensive especially, due to intercepting of SS7 signaling, and has redundancy, and greater load requirements.

In an alternate technique, based on the SS7-based approach, a routing query, such as a Send Routing Information for Short Message (SRI-SM) query is issued to a Home Location Register (HLR) associated with the subscriber. In this approach, when the messages associated with an MSISDN, corresponding to subscriber, are determined to be forwarded to another number or applied with a logic corresponding to VAS (either via querying HLR or retrieving from a registration database), the SRI-SM query is relayed through the SMS intercepting platform, which returns its own address as the subscriber's current location address. Subscriber's current location address corresponds to a VMSC/SGSN (Visited Mobile Switching Centre/Serving GPRS Support Node). Based on status of active VAS for the subscriber, the SMS intercepting platform relays the query to the real HLR without any modification. Further, when the message is redirected through SMS intercepting platform, the message is processed at the platform according to its logic corresponding to VAS. However, this technique is suitable only for inter-working (national or international) SMSC for small operator SMSC environment where there is only a handful of point interceptions required.

One technique combines the SS7-based approach with the SMSC-based approach to support message forwarding from the non-home (national or international) SMSCs. The adaptation always returns the SMS intercepting platform as the VMSC and VLR location to receive all the inter-working (national or international) messages. Another technique provides an integration of SMSC-based approach and SS7-based approach within the SMSC, with some functional changes.

In the combined approach, each home SMSC requires to be updated to support message forwarding and other VAS. For operators that deploy hundreds of home SMSCs, upgrading each SMSC and intercepting signaling from non-home SMSC may be expensive. For any SS7 intercepting approach, it is difficult to separate SMS signaling from non-SMS signaling for most operators and almost all SS7 signaling from non-home network to the home network could have gone through the SMS intercepting platform, leading to load problems and risk point of failure.

One or more of the above techniques are not scalable, as they require SMS intercepting platform to check for every message destined for all subscribers of an operator who deploys the SMS interceptor platform, to be routed via the SMS interception platform. For small volume of messages this check may be acceptable, however, in large volume of messages, this check at the platform, significantly slows down the process of message delivery, and deteriorates the subscriber's experience.

Co-pending U.S. patent application Ser. No. 11/294,329 filed on Dec. 6, 2005, which is incorporated herein by reference in its entirety, describes a service that provides a scalable SMS forwarding solution, which is SMSC and network infrastructure independent. This filing presented the scalable solution that affects only those subscribers who have subscribed to one or more VAS. It also presented the network infrastructure independent solution that does not require any SMSC, network routing or HLR changes. The application provides a solution to forward messages from the non-home SMSC to the home subscribers, when the delivery is via SS7. Similar concept also applies to any other VAS.

However, in this earlier filing, message forwarding was dependent on call forwarding in a way that for the subscriber to subscribe to message forwarding, the call forwarding needs to be active, otherwise the subscriber cannot receive calls while the SMS forwarding is active. While this restriction is not unreasonable for SMS forwarding, it is not suitable for other SMS VAS such as spam control. Further, if any MO activity or location change or re-registration activity is determined at the subscriber's handset, one or more active VAS will be automatically de-activated. This can be a problem for some people who still want to have MO-activities despite having set call forwarding and SMS forwarding.

In accordance with the foregoing, there is a need in the art of a system, method, and a computer product, which will provide a scalable and SMSC independent approach for message forwarding, which is completely independent of the call forwarding being set or unset. In addition, allow the subscriber to make and receive calls, as well as send and receive messages while message forwarding or any other VAS is active.

### SUMMARY

The present invention is directed to provide a method of applying one or more value added services (VAS) on messages sent to a subscriber without affecting the subscriber's mobile communication. The method includes receiving an activation request from the subscriber for activating one or more VAS, at a signaling gateway (SG). The method further includes retrieving the subscriber's visited switching address and the subscriber's address from a home location information database associated with the subscriber. Further, the method includes storing the subscriber's address, the subscriber's visited switching address, the home location information database address and an indication for activating the one or more VAS in a database associated with the SG. The method further includes updating the home location information database to redirect the messages, sent to the subscriber's address, to the SG. Finally, the method includes applying a logic corresponding to the VAS by the SG on the redirected messages.

An aspect of the invention presents a system for applying one or more value added services (VAS) on messages sent to a subscriber without affecting the subscriber's mobile communication. The system includes a Signaling Gateway (SG) coupled to the first network. The SG receives an activation request from the subscriber for activating one or more VAS. The SG further retrieves the subscriber's visited switching address and the subscriber's address from a home location information database associated with the subscriber. Further, the SG stores the subscriber's address, the subscriber's visited switching address, the home location information database and an indication for activating the one or more VAS in a database associated with the SG. The SG further updates the home location information database so as to redirect the messages to the SG. Finally, the SG applies a logic corresponding to the VAS on the redirected messages.

Another aspect of the present invention provides a computer program product including a computer usable program code for applying one or more value added services (VAS) on messages sent to a subscriber without affecting the subscriber's mobile communication by, receiving an activation request from the subscriber for activating one or more VAS, at a signaling gateway (SG). Further, retrieving the subscriber's visited switching address and the subscriber's address from a home location information database associated with the subscriber. Further, storing the subscriber's visited switching address, the home location information database address and an indication for activating the one or more VAS in a database associated with the SG. Further, updating the home location information database so as to redirect the messages, sent to the subscriber's address, to the SG. Finally, applying a logic corresponding to the VAS on the redirected messages, at the SG.

### BRIEF DESCRIPTION OF THE DRAWINGS

In the drawings, the same or similar reference numbers identify similar elements or acts.

FIG. 1 represents a system for providing one or more Value Added Service (VAS) to a subscriber without affecting subscriber's mobile communication, in accordance with an embodiment of the present invention;

FIGS. 2A and 2B represents a flowchart for providing one or more Value Added Service (VAS) to a subscriber without affecting subscriber's mobile communication, in accordance with an embodiment of the present invention;

FIGS. 3A and 3B is a flow diagram representing a Short Message Service (SMS) as an activation request from a subscriber for activating one or more VAS in a non-split approach, in accordance with a first embodiment of the present invention;

FIGS. 4A and 4B is a flow diagram representing a Short Message Service (SMS) as an activation request from a subscriber for activating one or more VAS in a split approach, in accordance with a second embodiment of the present invention;

FIGS. 5A and 5B represents a flow diagram for restoring subscriber's profile at a Visitor Location Register (VLR) associated with the subscriber's address in the non-split approach, in accordance with an embodiment of the present invention;

FIGS. 6A and 6B represents a flow diagram for a location update (LUP) by subscriber's handset in the non-split approach, while one or more VAS are active, in accordance with a first embodiment of the present invention;

FIGS. 7A and 7B represents a flow diagram for location update by subscriber's handset in the split approach, while one or more VAS are active, in accordance with a second embodiment of the present invention;

FIGS. 8A and 8B represents a flow diagram of Mobile Terminated (MT) Short Message Service (SMS) delivery to a forward-to address of the subscriber, in accordance with an embodiment of the present invention;

FIGS. 9A and 9B represents a flow diagram of MT SMS redelivery to the forward-to address of the subscriber, upon detecting failure in the previous attempt, in accordance with an embodiment of the present invention;

FIG. 10 represents a flow diagram for MT SMS delivery to the subscriber's address, in accordance with an embodiment of the present invention;

FIG. 11 represents a flow diagram of re-trying MT SMS delivery to the subscriber's address, upon detecting failure in the previous attempt, in accordance with an embodiment of the present invention;

FIG. 12 represents a flow diagram for applying spam control, as a VAS, for barring blacklisted senders, in accordance with a first embodiment of the present invention;

FIGS. 13A, 13B and 13C represents a flow diagram for applying a two-way confirmation based spam control for barring senders, upon the sender being confirmed to be blacklisted by the subscriber, in accordance with a second embodiment of the present invention;

FIGS. 14A and 14B represents a flow diagram of MMS delivery to the forward-to address of the subscriber, while subscriber is subscribed to SMS forwarding, in accordance with an embodiment of the present invention;

FIGS. 15A and 15B represents a flow diagram of MMS delivery to the forward-to address of the subscriber, when MMSC associated with the subscriber does not support MMS forwarding, while the subscriber is subscribed to SMS forwarding, in accordance with an embodiment of the present invention;

FIG. 16 represents a flow diagram of Mobile Terminated (MT) call to the subscriber's address, while one or more VAS are active, in accordance with an embodiment of the present invention;

FIG. 17 represents a flow diagram of Network Initiated USSD to the subscriber's address, while one or more VAS are active, in accordance with an embodiment of the present invention;

FIGS. 18A and 18B represents a flow diagram of Network Initiated Mobile Location Service to the subscriber's address, while one or more VAS are active, in accordance with a first embodiment of the present invention;

FIGS. 19A and 19B represents a flow diagram of the Network Initiated Mobile Location Service with Gateway Mobile Location Centre (GMLC) change, to the subscriber's address, while one or more VAS are active, in accordance with a second embodiment of the present invention;

FIG. 20 represents a flow diagram of Anytime interrogation (ATI) at the subscriber's address, while one or more VAS are active, in accordance with an embodiment of the present invention;

FIGS. 21A and 21B represents a flow diagram of RESET and Forward Check SS services at the subscriber's address, while one or more VAS are active, in accordance with an embodiment of the present invention;

FIG. 22 represents a flow diagram of subscriber data management at the subscriber's address, while one or more VAS are active, in accordance with an embodiment of the present invention;

FIG. 23 represents a flow diagram of PurgeMS messages at the subscriber's HLR, while one or more VAS are active, in accordance with an embodiment of the present invention;

FIG. 24 represents a flow diagram of GPRS location update by subscriber's handset, upon subscriber changing the location, while one or more VAS are active, in accordance with an embodiment of the present invention;

FIG. 25 represents a flow diagram of Network Initiated PDP context establishment with the subscriber, while one or more VAS are active, in accordance with an embodiment of the present invention;

FIG. 26 represents a flow diagram of MT SMS delivery in a first path via GPRS at the subscriber's address, while one or more VAS are active, in accordance with a first embodiment of the present invention;

FIGS. 27A and 27B represents a flow diagram of MT SMS delivery using a second path via GPRS at the subscriber's address, while one or more VAS are active, in accordance with a second embodiment of the present invention;

FIGS. 28A and 28B represents a flow diagram of Mobile Originated (MO) activities from the subscriber's handset, while one or more VAS are active, in accordance with an embodiment of the present invention;

FIGS. 29A and 29B represents a flow diagram of de-activation of one or more VAS, upon receiving a de-activation request, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practised without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the invention. The appearance of the phrase “in an embodiment”, in various places in the specification, does not necessarily refer to the same embodiment.

The present invention provides a system, method and a computer program product to facilitate subscriber's mobile communication, while one or more Value Added Service (VAS) are active. The system applies one or more VAS on messages sent to the subscriber, without affecting the subscriber's mobile communication. The system provides a scalable and SMSC independent approach to forward messages, which is independent of the status of call forwarding. This system facilitates the subscriber to subscribe to SMS forwarding without being concerned about the status of call forwarding being set or unset. The dependency of SMS forwarding on call forwarding is based upon operator's configuration. A configuration setting, such as, “CallForwardingRequired”, is used to tie SMS forwarding with call forwarding. Call forwarding in an embodiment is unconditional call forwarding, whereas, in another embodiment, call forwarding is conditional, such as, late call forwarding. The system further provides subscriber with an option whether he wants to receive calls/messages and make or send calls/messages, while being subscribed to one or more VAS. The system provides a seamless implementation to allow plurality of services, such as, but not limited to, call related and non-call related (i.e. VAS) for all its subscribers.

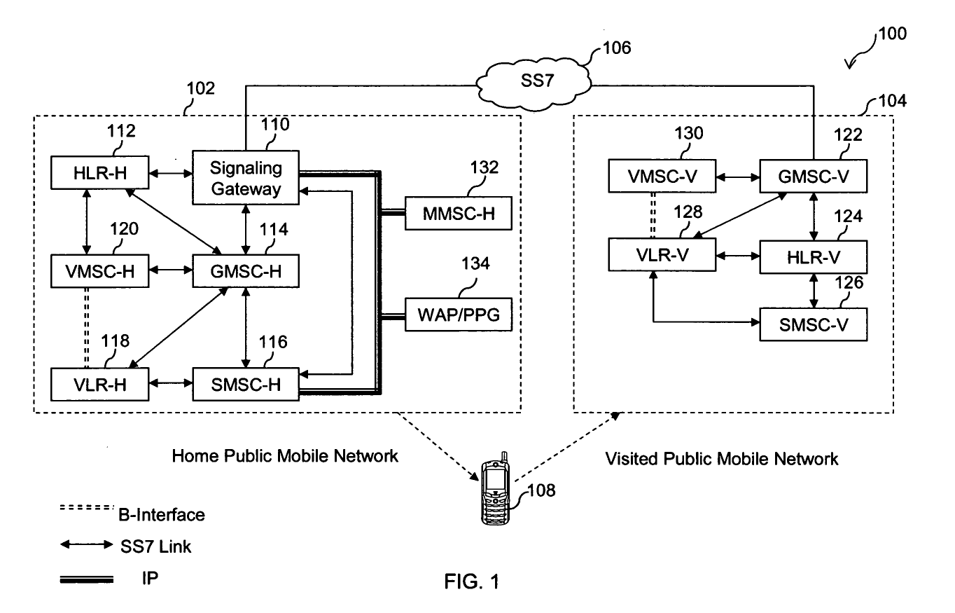

FIG. 1 represents a system 100 for providing one or more Value Added Service (VAS) to a subscriber without affecting subscriber's mobile communication. The system includes an HPMN 102, and a VPMN 104 exchanging signaling via Signaling System 7 (SS7 ) network 106. A subscriber 108 is originally associated with HPMN 102. In an embodiment of the present invention, subscriber 108 is present in HPMN 102. In another embodiment of the present invention, subscriber 108 may associate with VPMN 104. HPMN 102 includes a Signaling Gateway (SG) 110. HPMN 102 further includes a Home Location Register (HLR) 112, a Gateway Mobile Switching Center (GMSC) 114, a Short Message Service Center (SMSC) 116, a Visited Location Register (VLR) 118, and a Visited Mobile Switching Center (VMSC) 120. Since, HLR 112, GMSC 114, SMSC 116, VLR 118, and VMSC 120 reside in HPMN 102, they are hereinafter, referred to as an HLR-H 112, a GMSC-H 114, an SMSC-H 116, a VLR-H 118, and a VMSC-H 120, respectively. SG 110, HLR-H 112, GMSC-H 114, SMSC-H 116, VLR-H 118, and VMSC-H 120 are interconnected, and communicate with each other over an SS7 link.

System 100 further includes in VPMN 104 a Gateway Mobile Switching Center (GMSC) 122, a Home Location Register (HLR) 124, a Short Message Service Center (SMSC) 126, a Visited Location Register (VLR) 128, and a Visited Mobile Switching Center (VMSC) 130. Since, GMSC 122, HLR 124, SMSC 126, VLR 128, and VMSC 130 reside in VPMN 104, they are hereinafter, referred to as a GMSC-V 122, an HLR-V 124, an SMSC-V 126, a VLR-V 128, and a VMSC-V 130, respectively. GMSC-V 122, HLR-V 124, SMSC-V 126, VLR-V 128, and VMSC-V 130 are interconnected and communicate with each other over an SS7 link. System 100 further includes in HPMN 102, a Multimedia Messaging Service Center (MMSC) 132 and WAP Push Proxy Gateway (WAP/PPG) 134. Since, MMSC 132 and WAP/PPG 134 reside in HPMN 102, they are hereinafter, referred to as an MMSC-H 132 and a WAP/PPG 134. It would be apparent to a person skilled in the art that any network element in HPMN 102, and VPMN 104 may communicate with each other via SS7 network 106. Moreover, it would be apparent to a person skilled in the art that HPMN 102 and VPMN 104 may also include various other network components (not shown in FIG. 1) depending on the architecture under consideration.

HLR-H 112 is interchangeably referred to as home location information database, in accordance with the present invention. Also, VMSC-V 130 is interchangeably referred to as subscriber's visited switching address, in accordance with the present invention. Further, VLR-V 128 is interchangeably referred to as visited location information database, in accordance with the present invention. In one embodiment of the present invention, HPMN 102 is a first network and VPMN 104 is a second network. HLR-H 112 and SG 110 are coupled to the first network, whereas, VLR-V 128 and VMSC-V 130 are coupled to the second network. In an embodiment of the present invention, the first network and the second network are same.

SG 110 applies a logic corresponding to VAS, after receiving an activation request at SG 110 from subscriber 108. The logic corresponding to VAS is, hereinafter, referred to as VAS logic. The activation request is for subscribing and subsequently activating the VAS. In an embodiment of the present invention, the VAS logic is applied based on operator's preferences. In first embodiment of the present invention, the activation request includes request for activating one VAS. In second embodiment of the present invention, the activation request includes request for activating plurality of VAS. Hereinafter, subscriber 108 may interchangeably, be referred to as subscriber A. SG 110 sends a routing information query to HLR-H 112 to get an IMSI-A (of subscriber A) and VMSC-V 130 associated with subscriber's registered network. Thereafter, SG 110 stores subscriber's MSISDN, IMSI-A, VMSC-V 130, HLR-H 112 and an indication for activating VAS in a database associated with SG 110. In an embodiment of the present invention, SG 110 stores VLR-V 128 and SMSC-H 116 in its database. In another embodiment of the present invention, the database resides within SG 110. The indication for activating VAS corresponds to maintaining a setup at SG 110. SG 110 may use this setup to apply VAS logic based on the VAS indicated in the activation request. Subscriber 108 can send the activation request either from HPMN 102, or from VPMN 104. It would be apparent to a person skilled in the art that when subscriber 108 is located in HPMN 102, VMSC-H 120 and VLR-H 118 are active, instead of VMSC-V 130 and VLR-V 130 when subscriber 108 is present in VPMN 104.

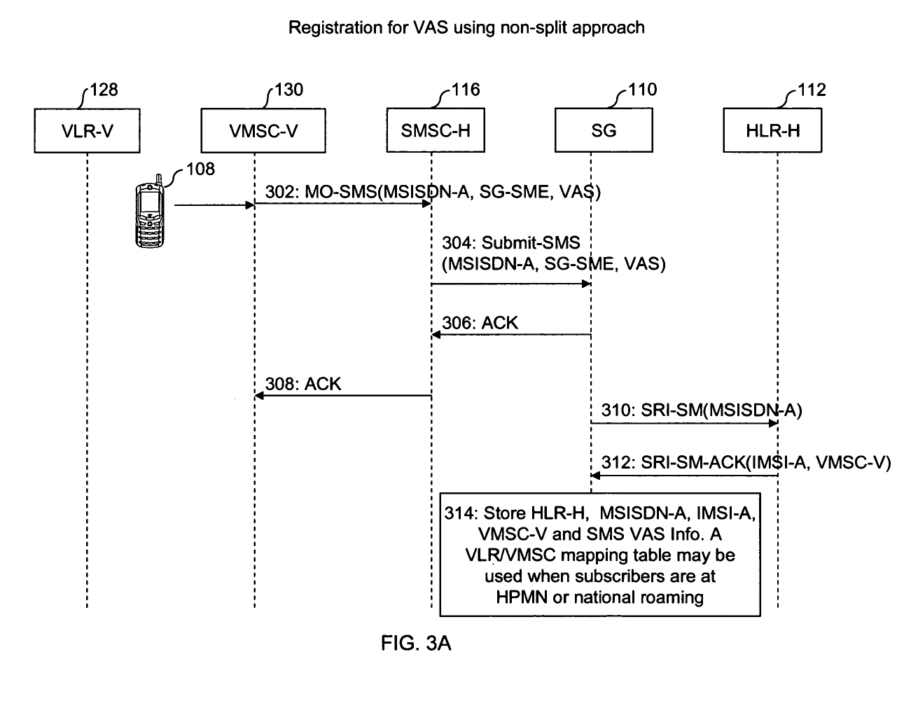

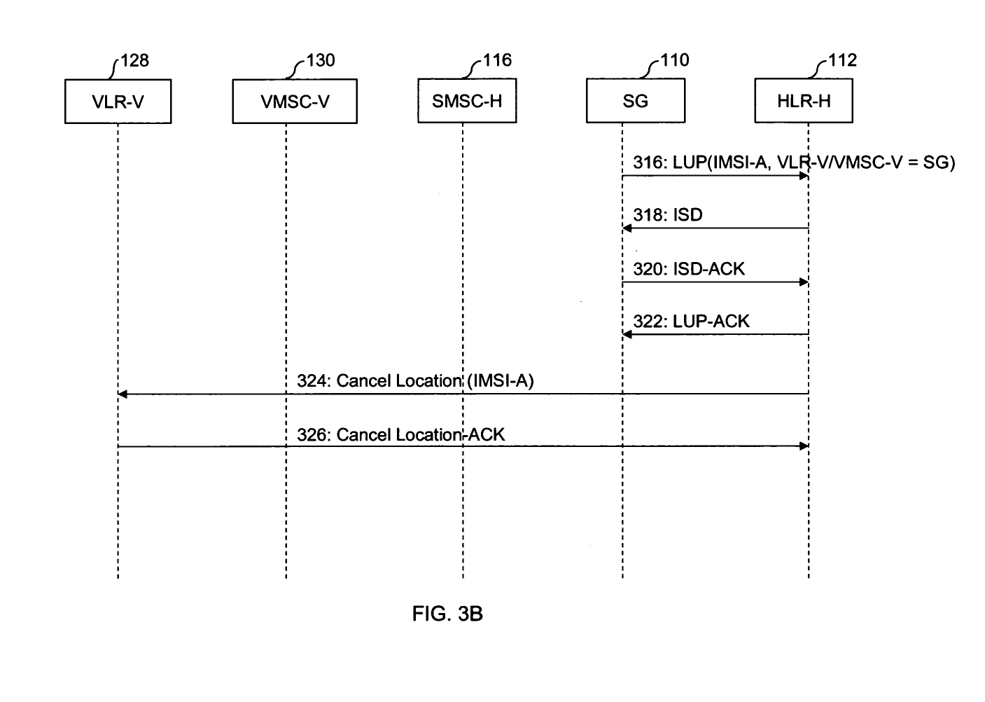

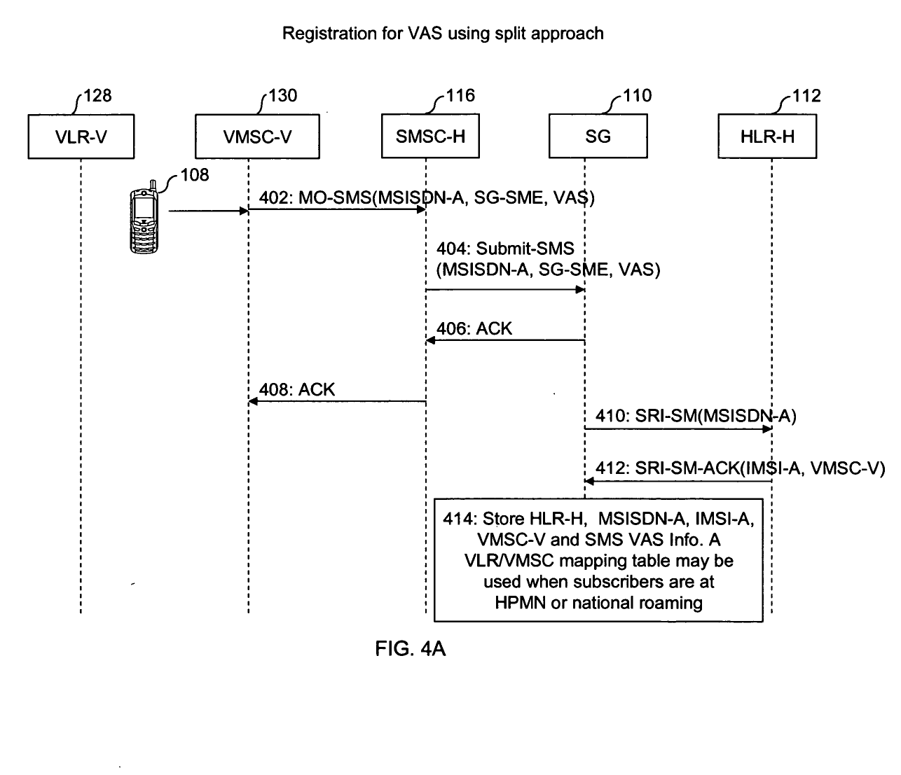

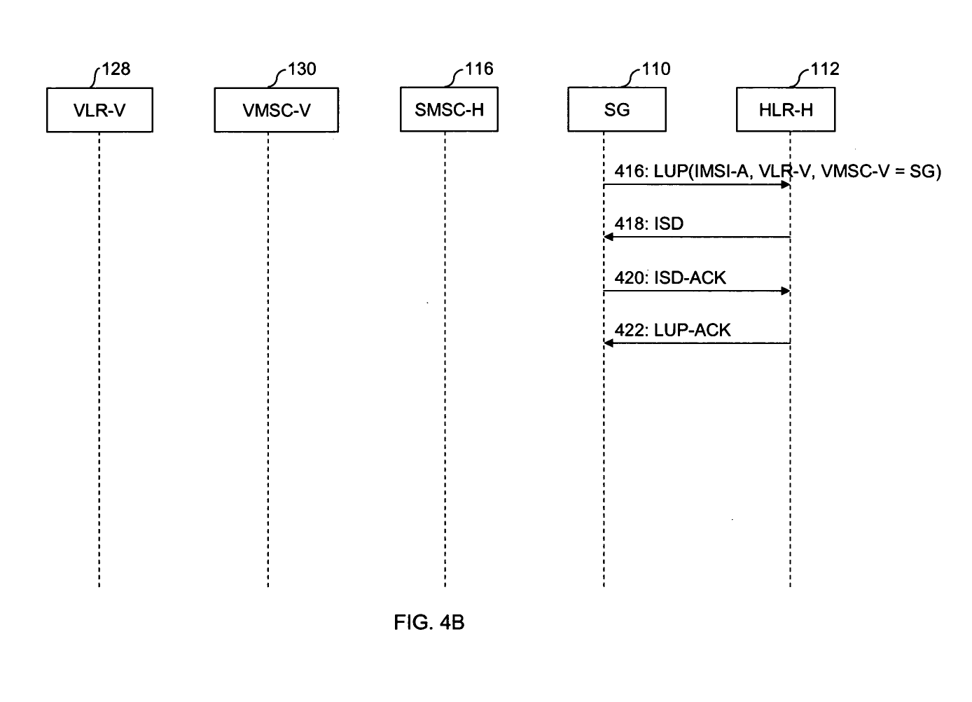

In one embodiment of the present invention, when subscriber 108 subscribes to one or more VAS using GPRS services, SGSN corresponding to subscriber 108 is active. Further, VMSC-V 130 is replaced with a VPMN SGSN, when subscriber 108 uses GPRS services for subscribing to one or more VAS. It would be apparent to a person skilled in the art that when subscriber 108 is located in HPMN 102, HPMN SGSN is active, instead of VPMN SGSN, when subscriber 108 is present in VPMN 104. Various embodiments of signal flow corresponding to subscriber 108 sending an activation request for subscribing to one or more VAS using non-split approach and split approach are described in conjunction with FIGS. 3A and 3B and FIGS. 4A and 4B, respectively.

Furthermore, in a first embodiment of the present invention, SG 110 updates HLR-H 112 by sending a registration message to HLR-H 112 to replace VMSC-V 130 and VLR-V 128, with an address of SG 110. This enables SG 110 to receive all signaling VPMN 104 and HPMN 102 for subscriber 108. Also, the subscriber's profile is removed from VLR-V 128 due to fake registration message by SG 110. VLR-V 128 and VMSC-V 130 are associated with the subscriber's registered network. In an embodiment of the present invention, subscriber's registered network can be either the first, or the second network. Since, SG 110 updates HLR-H 112 to replace both VMSC-V 130 and VLR-V 128, with the address of SG 110, this approach is, hereinafter, referred to as non-split approach.

In a second embodiment of the present invention, SG 110 updates HLR-H 112 by sending a registration message to HLR-H 112 to replace only VMSC-V 130 with the address of SG 110. In this embodiment, since VLR-V 128 is not affected, the subscriber's profile is still maintained at VLR-V 128. Therefore, this approach of replacing only VMSC-V 130 with the address of SG 110 is, hereinafter, referred to as split approach.

In an embodiment of the present invention, the address of SG 110 is modified to include a roaming identifier when subscriber 108 is present in VPMN 104. The roaming identifier may be a roaming GT assigned to SG 110 to signify that subscriber 108 is roaming. SG 110 thus updates HLR-H 112 by replacing VMSC-V 130 and VLR-V 128 with a modified SG 110, including the roaming identifier, in the non-split approach. However, in the split approach, SG 110 updates HLR-H 112 by replacing only VMSC-V 130 with the modified SG 110, including the roaming identifier. In another embodiment of the present invention, SG 110 is modified to include a non-roaming identifier when subscriber 108 is present in HPMN 102. The non-roaming identifier may be a non-roaming GT assigned to SG 110 to signify that subscriber 108 is in the home network (i.e. HPMN 102). Roaming identifier is, hereinafter, referred to as roaming GT and non-roaming identifier is, hereinafter, referred to as non-roaming GT.

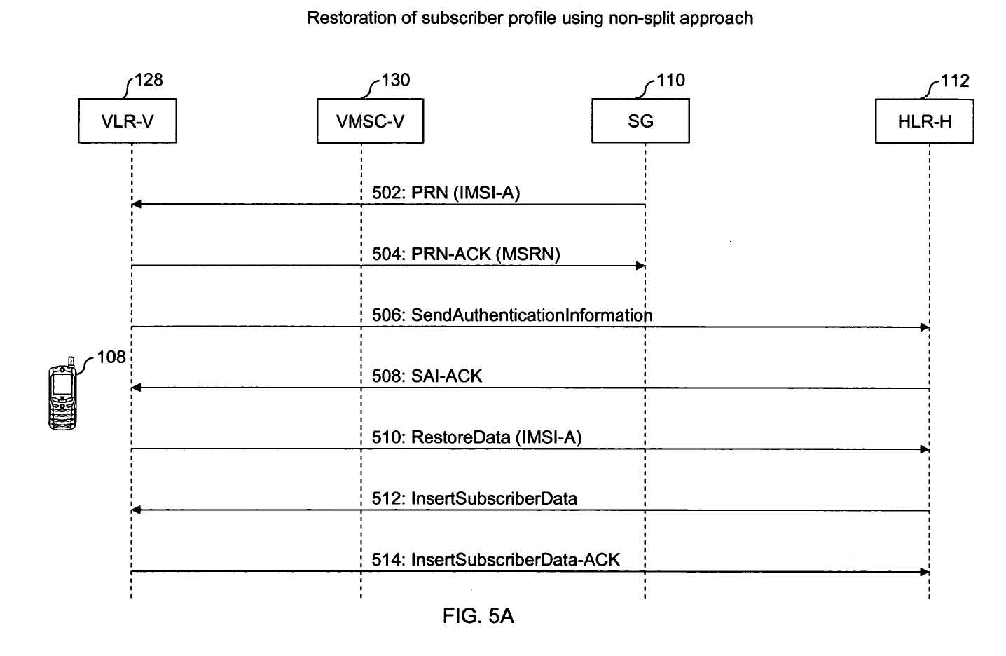

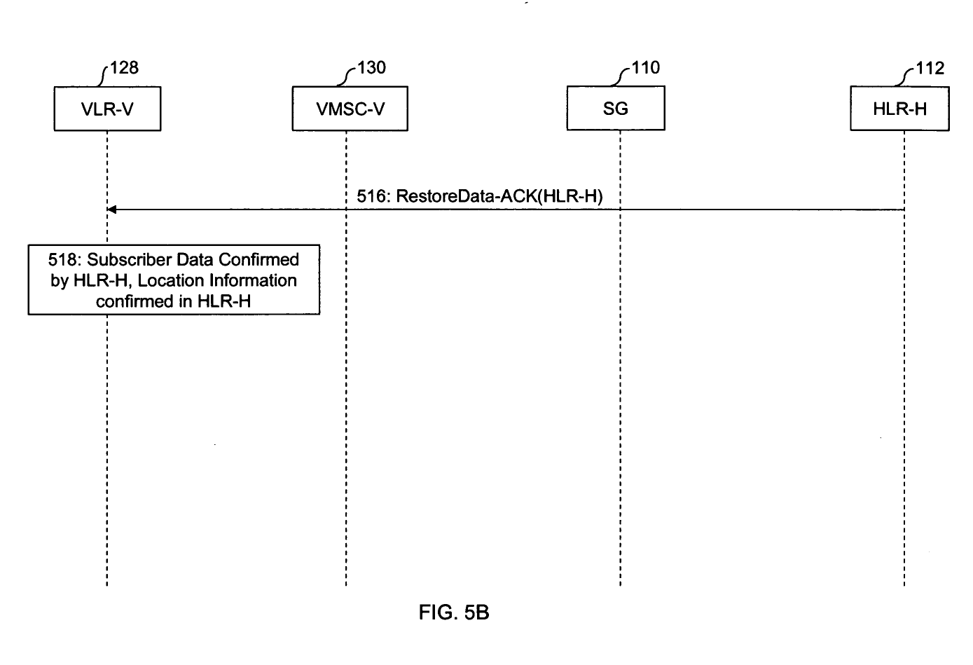

In the non-split approach, as VMSC-V 130 and VLR-V 128 is replaced, with the address of SG 110, subscriber's profile needs to be restored at VLR-V 128 to facilitate subscriber's mobile communication. SG 110 uses signaling messages, such as Signaling Connection and Control Part (SCCP) messages, for sending a roaming number request to VMSC-V 130 with called party as VLR-V 128. Therefore, SG 110 causes a restoration of subscriber's profile at VLR-V 128, when VMSC-V 130 forwards the roaming number request to VLR-V 128. As VLR-V 128 has restored the subscriber's profile, the subscriber's mobile communication is not affected, while he is subscribed to one or more VAS. Various embodiments of signal flow corresponding to the restoration of subscriber's profile at VLR for non-split approach is described in conjunction with FIGS. 5A and 5B. Since, SG 110 does not replace VLR-V 128, with the address of SG 110, the subscriber's profile is not affected at VLR-V 128. Thus, restoration of subscriber's profile is not required in split approach.

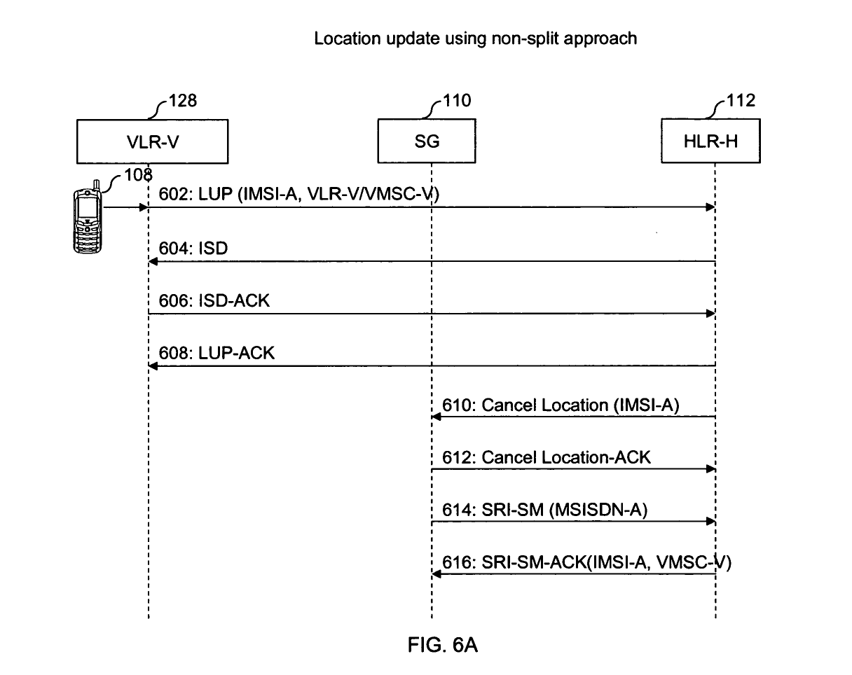

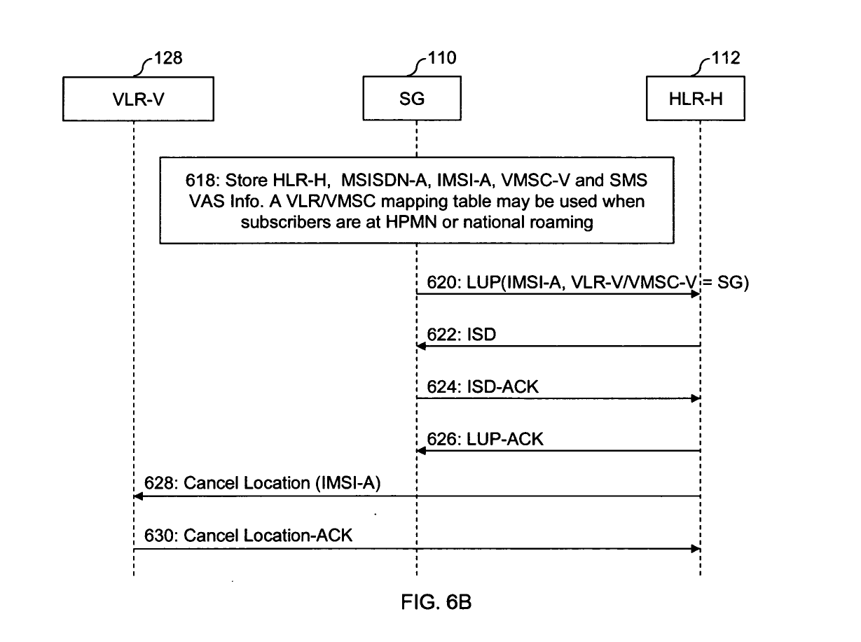

In non-split approach, when subscriber 108 changes his location, by leaving his last registered network, a second registration message from a new registered network is sent to HLR-H 112 that causes SG 110 to receive a registration cancellation message from HLR-H 112. It will be apparent to a person skilled in the art that the new registered network would be VLR-V 128 and VMSC-V 130 if subscriber 108 resets his handset while in VPMN 104. Thereafter, SG 110 sends a routing information query to HLR-H 112 to get IMSI-A, new VMSC and new VLR associated with the subscriber's new registered network. The new VMSC and new VLR are the updated VMSC and VLR respectively. In case of handset reset at the same location, updated VMSC is VMSC-V 130 and updated VLR is VLR-V 128. Thereafter, SG 110 stores the revised subscriber data, which includes MSISDN-A (of subscriber A), IMSI-A, HLR-H 112, updated VMSC-V 130 and the indication for activating one or more VAS in the database associated with SG 110. Optionally, SG 110 may also store updated VLR-V 128 in its database. Furthermore, SG 110 again updates HLR-H 112 by sending the first registration message to HLR-H 112 in order to replace the updated VMSC-V 130 and updated VLR-V 128 back to the address of SG 110. This again helps in SG 110 receiving all signaling associated with subscriber 108. Hereinafter, the first registration message is, interchangeably, referred to as location update (LUP) message. Various embodiments of signal flow corresponding to location update in non-split approach are described in FIGS. 6A and 6B.

Further, in case of split approach, when subscriber 108 changes his location, by leaving his last registered network, a monitoring system is used to detect the second registration message, sent from the updated VLR to HLR-H 112. Since, SG 110 implements one or more VAS for subscriber 108, every new second registration message at HLR-H 112 removes SG 110 from the signaling loop of subscriber 108. Hence, the monitoring system is used to monitor HLR-H 112 for any received second registration message so that none of the subscriber's VAS is affected. Thus, SG 110 sends a routing information query to HLR-H 112 to get IMSI-A and updated VMSC-V 130 and VLR-V 128 associated with the updated registered network of subscriber 108. In case of handset reset at the same location, updated VMSC is VMSC-V 130 and updated VLR is VLR-V 128.

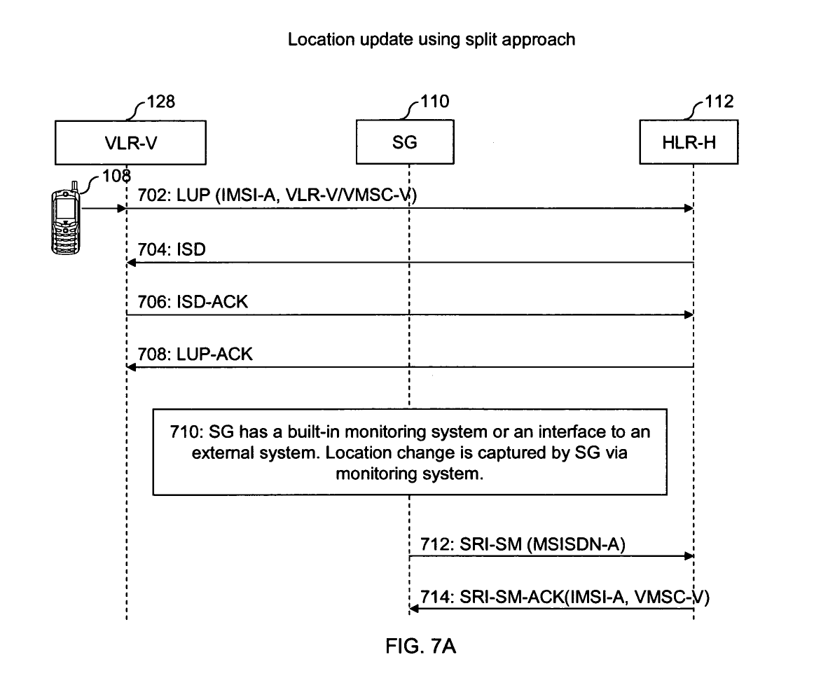

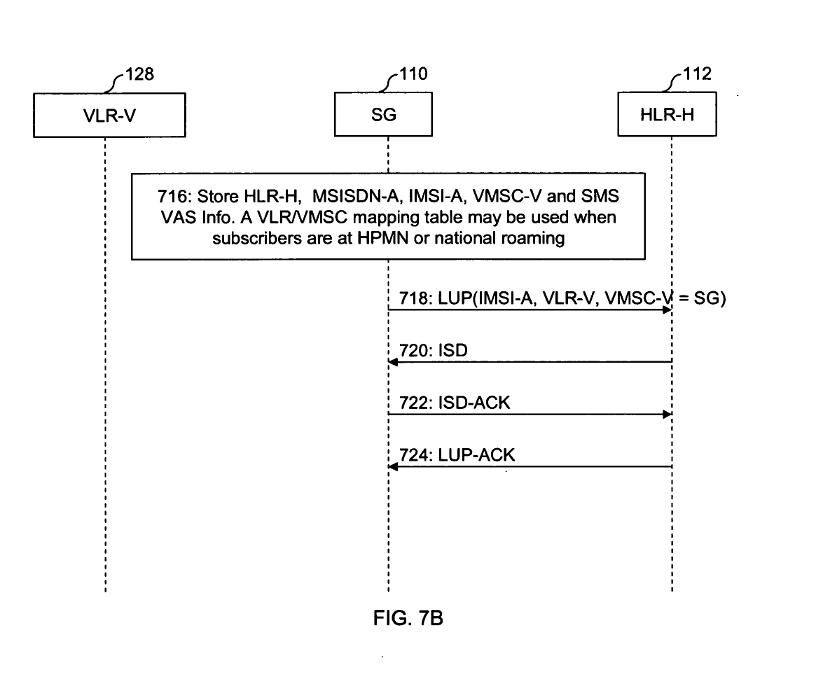

Thereafter, SG 110 stores the revised subscriber data, which includes MSISDN-A, IMSI-A, HLR-H 112, updated VMSC and the indication for activating VAS, in the database associated with SG 110. Furthermore, SG 110 again updates HLR-H 112 by sending the first registration message to HLR-H 112 in order to replace the updated VMSC-V 130 back to the address of SG 110. Various embodiments of signal flow corresponding to location update in split approach is described in conjunction with FIGS. 7A and 7B.

Further, when subscriber 108 has subscribed to message (like SMS) forwarding as a VAS, SG 110 forwards the messages destined to subscriber 108 to one or more forward-to addresses. SG 110 receives the messages intended for subscriber 108 from an SMSC-O. SMSC-O corresponds to originating SMSC that sends messages to subscriber 108. In an embodiment of the present invention, subscriber 108 can also receive messages from a non-home SMSC or an international SMSC, irrespective of whether subscriber 108 is a roaming subscriber or a non-roaming subscriber. In one embodiment of the present invention, SG 110 can redirect the messages received, to one or more forward-to addresses based on the VAS logic for subscriber 108. In an embodiment of the present invention, VAS logic is applied based on operator's preferences. SG 110 extracts subscriber's address from the activation request and can retrieve corresponding one or more forward-to addresses from SG 110's database. In another embodiment of the present invention, SG 110 stores in its database one or more forward-to addresses indicated by subscriber 108 in the activation request. Subscriber's address can be, but not limited to, a Mobile Station International Subscriber Directory Number (MSISDN), an International Mobile Subscriber Identity (IMSI), a Mobile Directory Number (MDN) and a Mobile Identification Number (MIN).

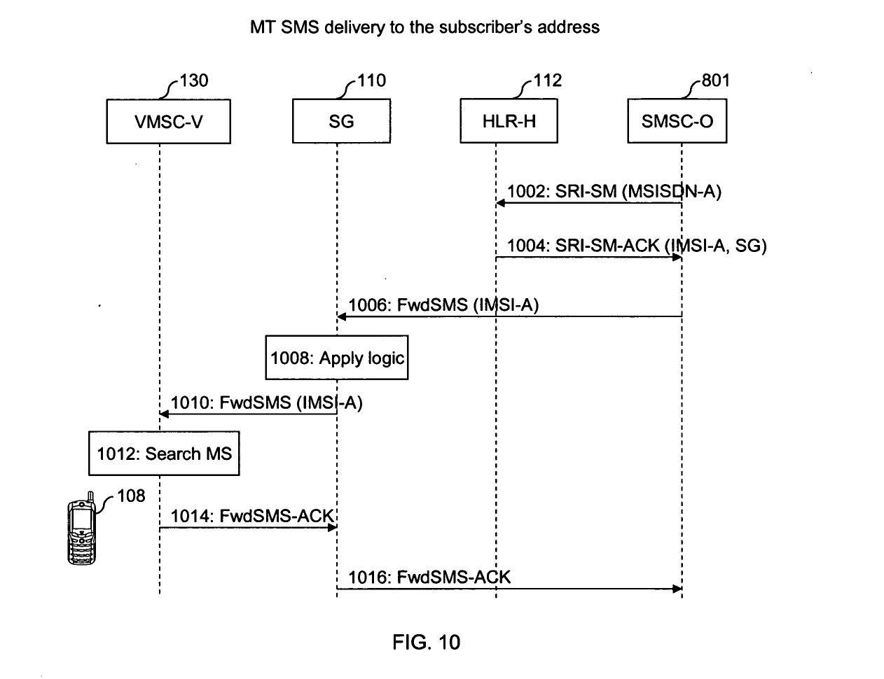

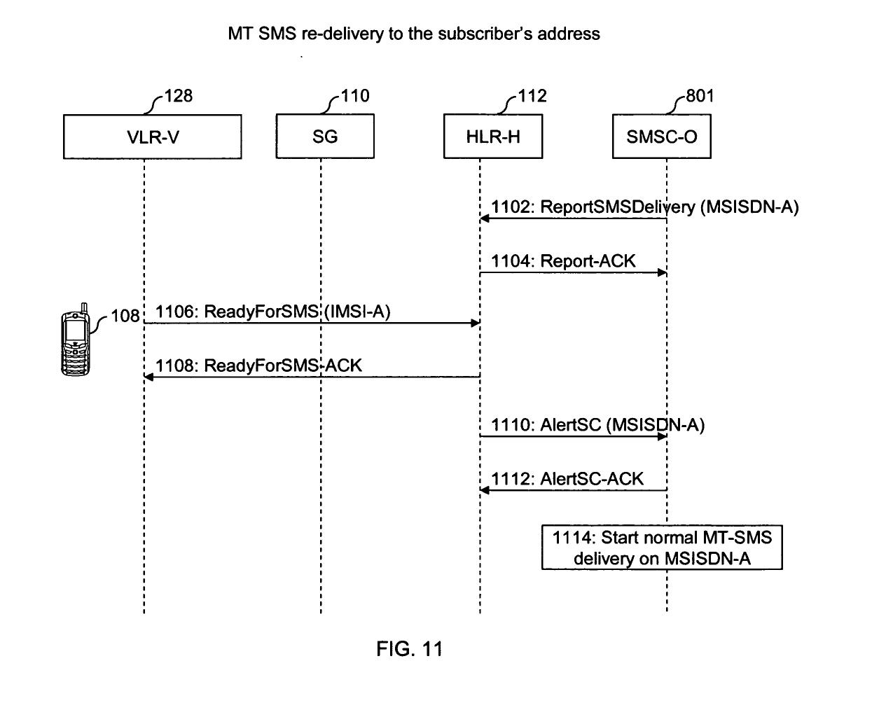

Further, when subscriber 108 has subscribed to SMS forwarding, SG 110 can query an HLR-F corresponding to the forward-to address indicated by subscriber 108 in the activation request, to retrieve routing information of forward-to address and thereby, sends the redirected message to the forward-to address. In one embodiment of the present invention, subscriber 108 forwards messages to one or more forward-to addresses present in HPMN 102. In second embodiment of the present invention, subscriber 108 forwards messages to one or more forward-to addresses present in VPMN 104. In third embodiment of the present invention, subscriber 108 forwards messages to one or more forward-to address present in some other visited network, other than VMPN 104. Subscriber 108 can forward messages to forward-to addresses, such as, but not limited to, a mobile number associated with the subscriber, a fixed-line number, an email address, an Session Initiation Protocol (SIP) address, a Voice over Internet Protocol (VoIP) number, or an RSS feed generator address. In another embodiment of the present invention, subscriber 108 requests for a copy of messages at his own forwarding address (i.e. subscriber's address), while his messages are also forwarded to one or more forward-to addresses. Various embodiments of SMS delivery to subscriber's address and redelivery of SMS to subscriber's address on detection of failure are described in conjunction with FIG. 10 and FIG. 11, respectively.

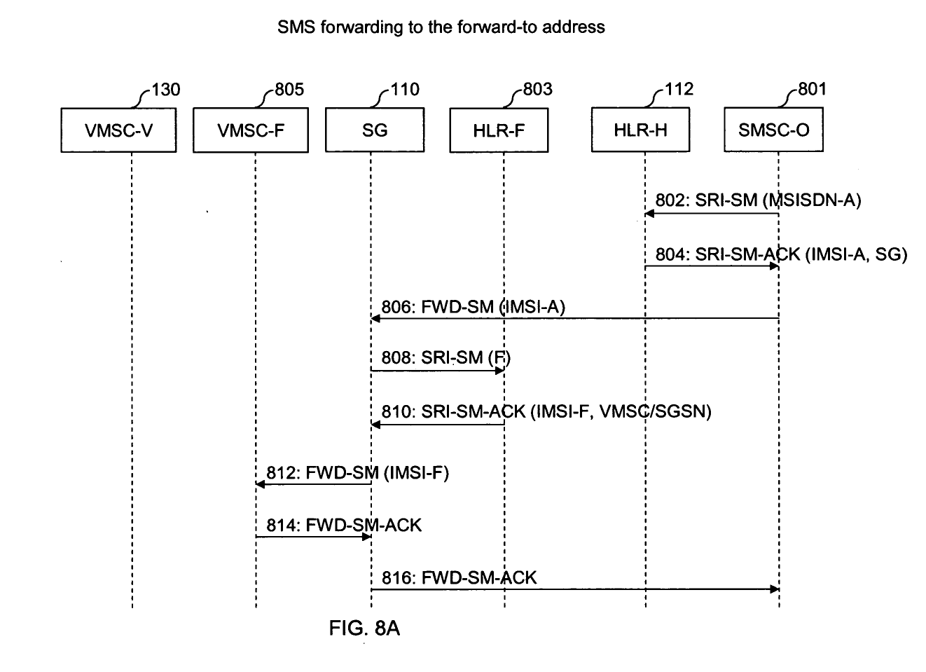

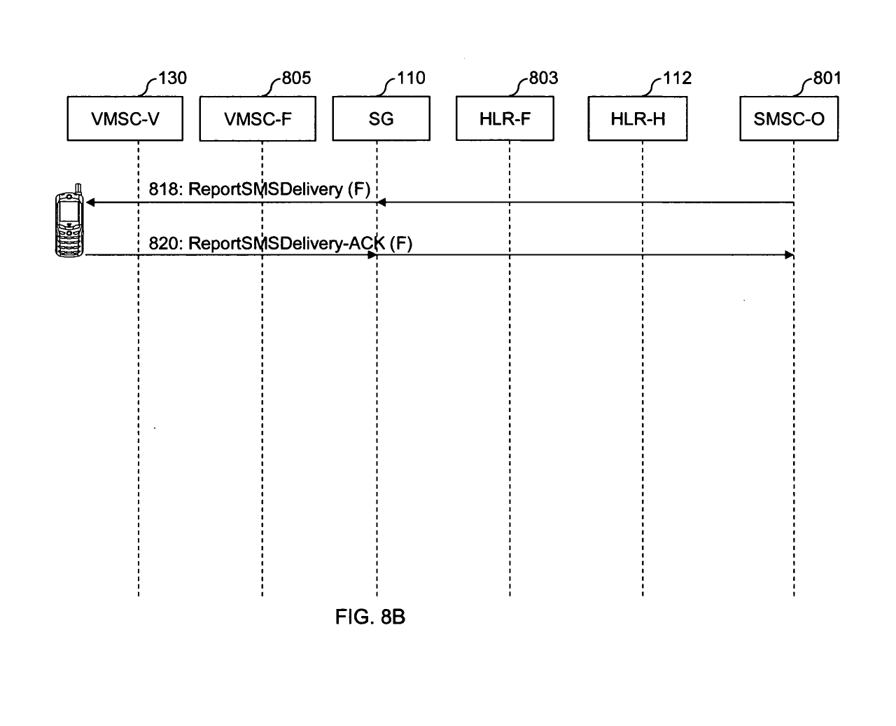

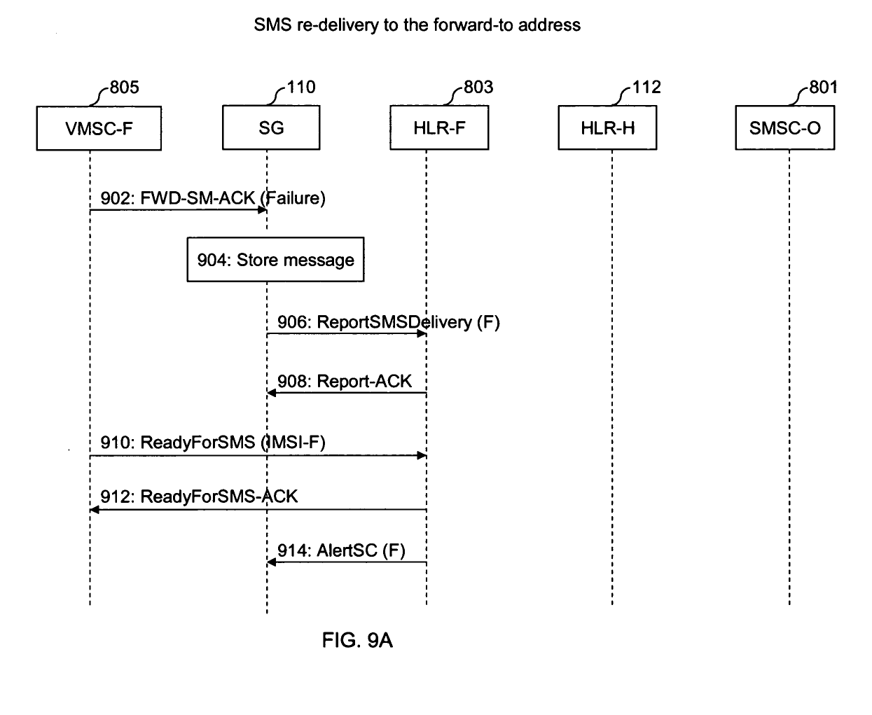

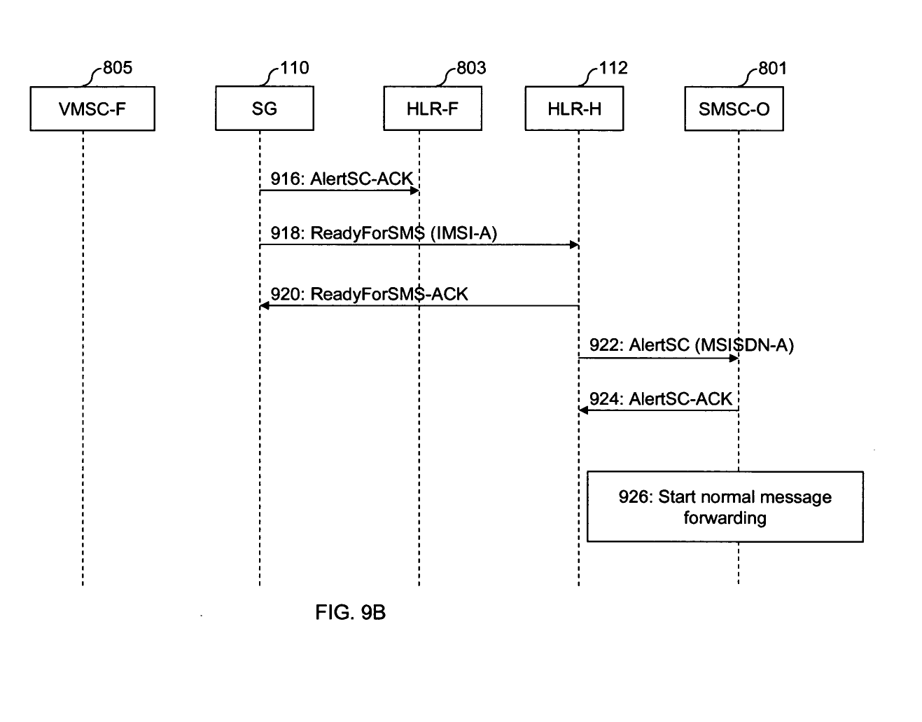

In case of a delivery failure to the forward-to address, SG 110 relays the failure reasons to SMSC-O. SG 110 stores the message in its database if the failure reasons are, but may not be limited to, forward-to handset powered off or SMS memory capacity full at the forward-to handset. Since forward-to address's recipient is associated with his own HLR-F, SG 110 can further send a delivery report to HLR-F. Various embodiments of SMS forwarding to forward-to address and redelivery of SMS to forward-to address when failure is detected are described in conjunction with FIGS. 8A and 8B and FIGS. 9A and 9B, respectively.

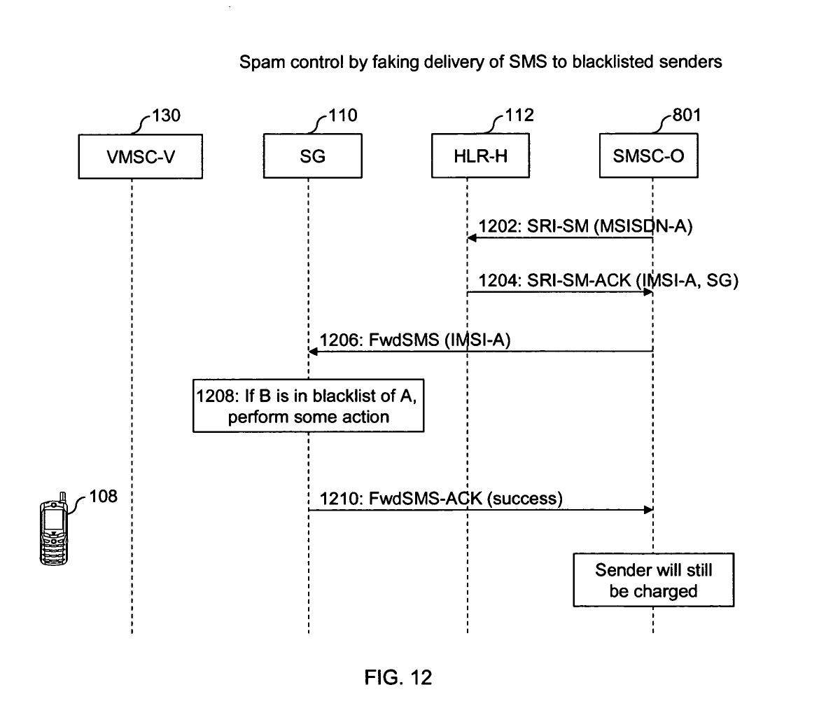

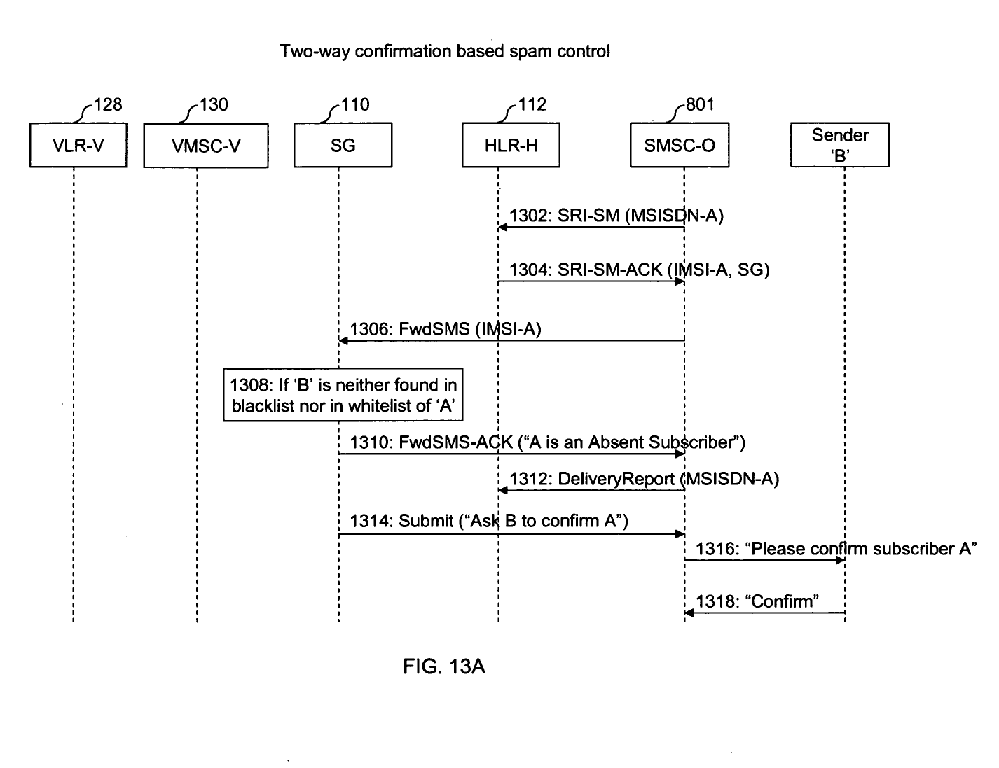

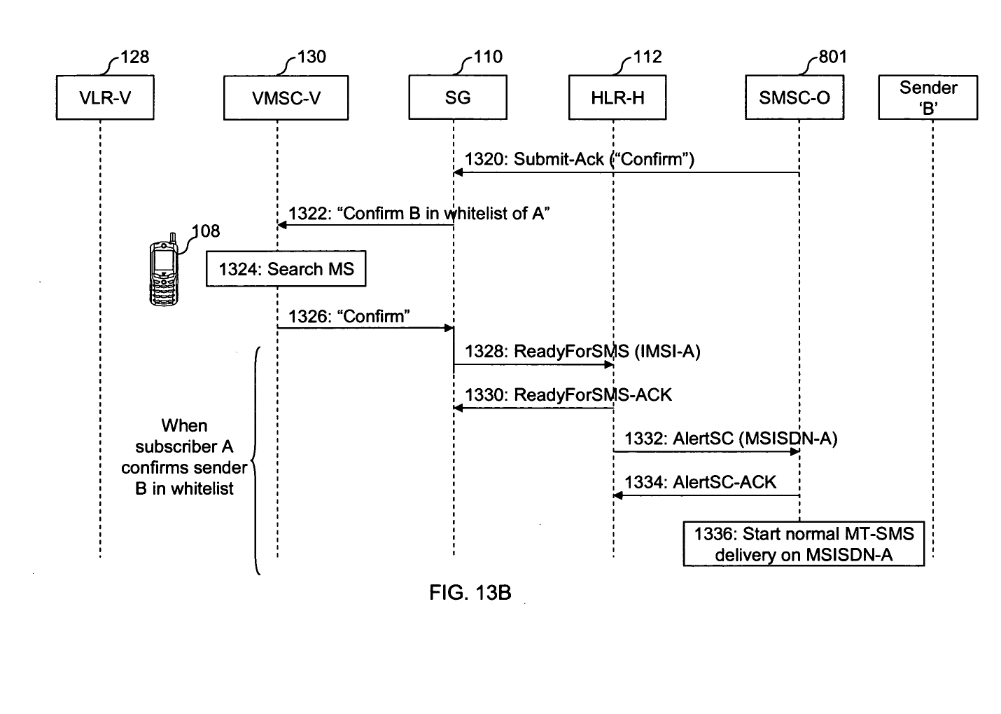

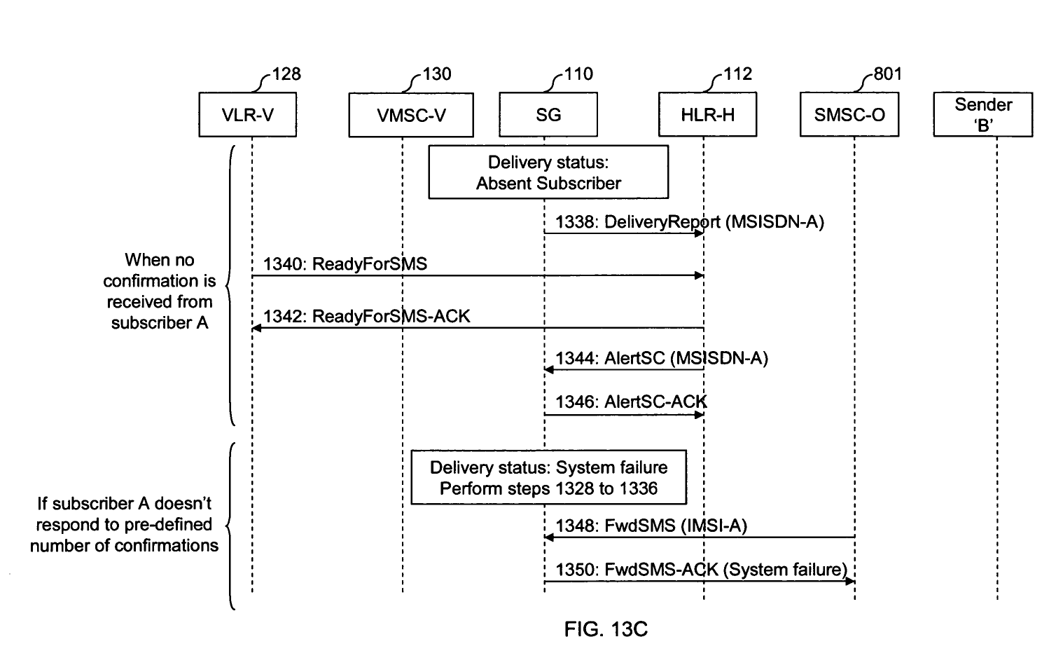

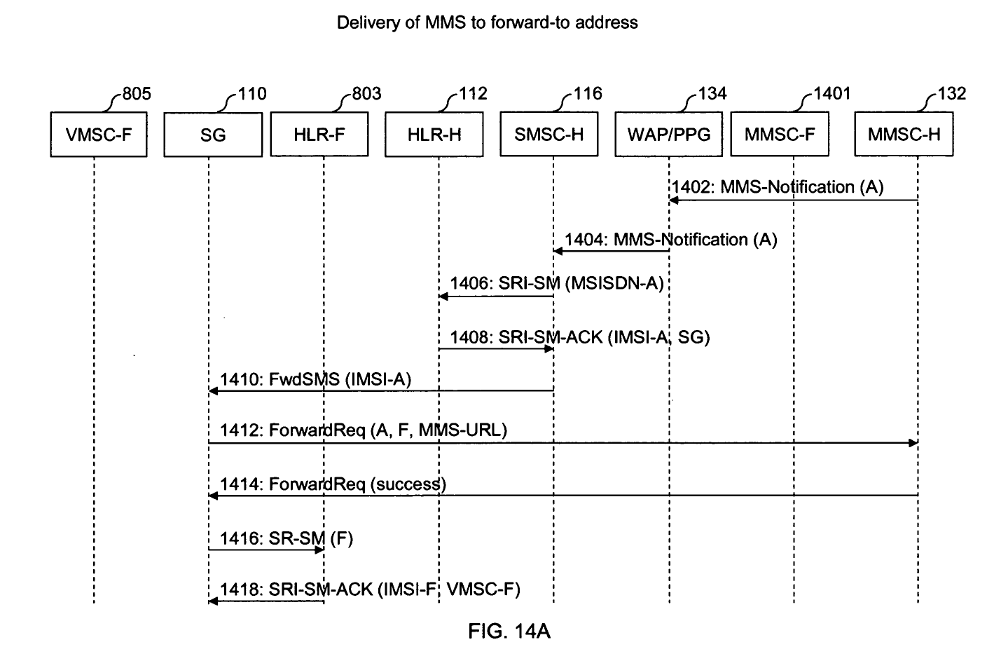

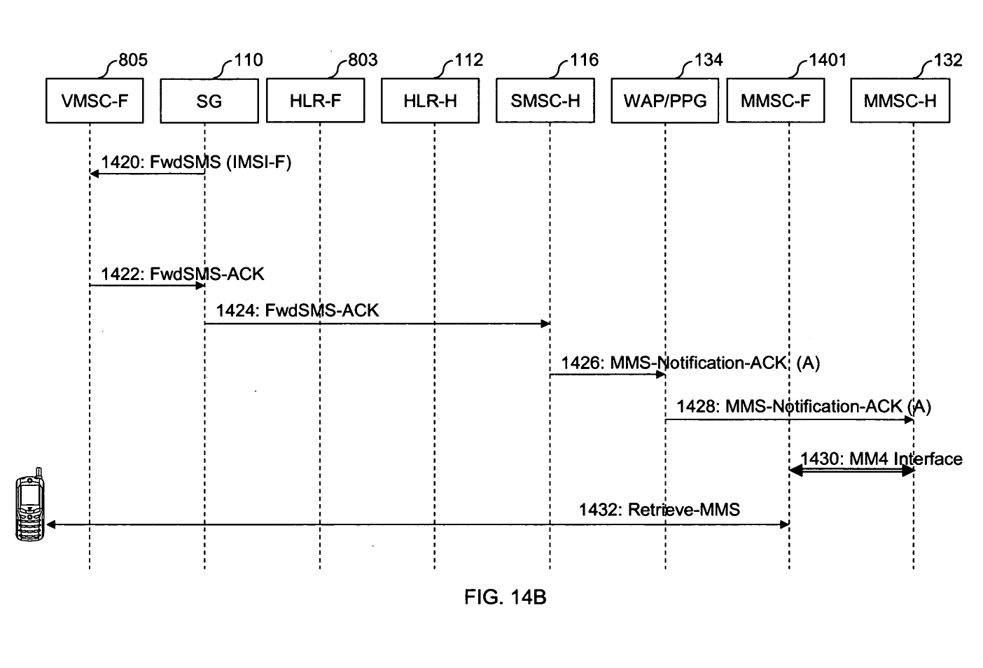

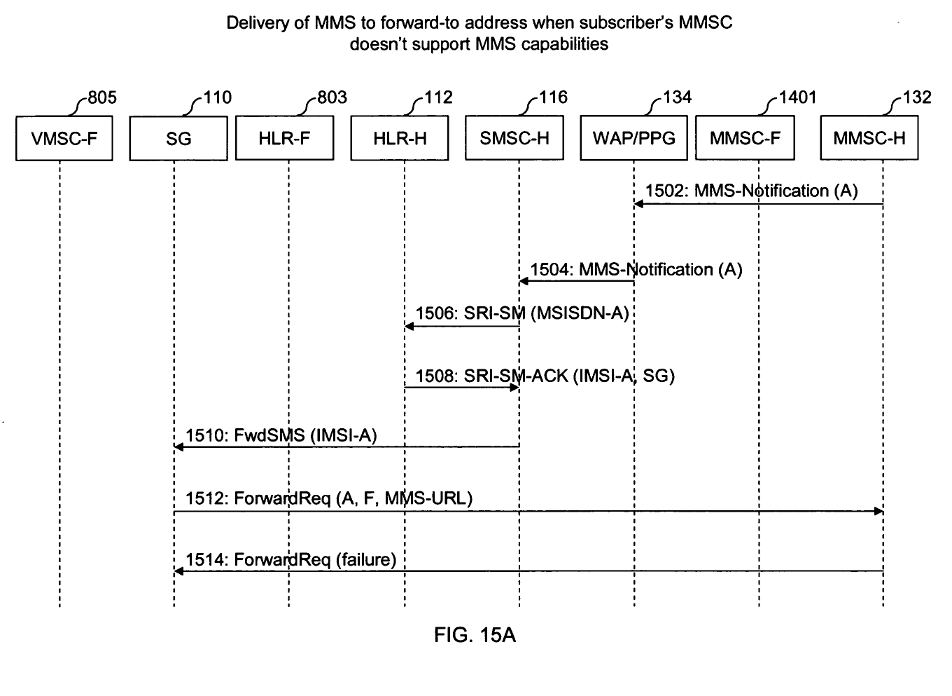

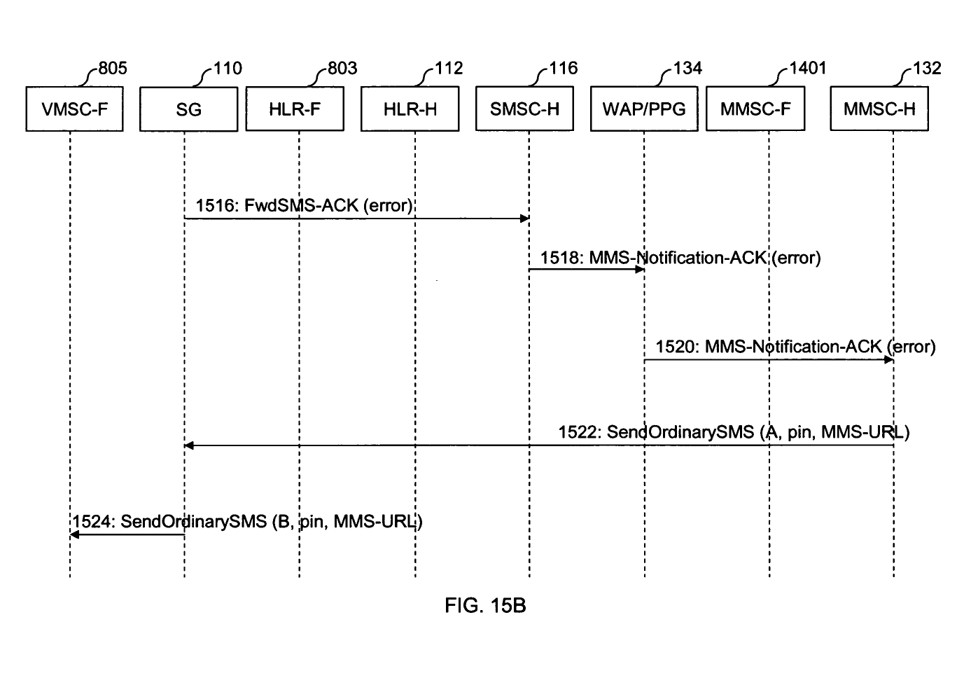

In an embodiment of the present invention, subscriber 108 is further provided with applications, such as, but not limited to, an SMS transcoding, an SMS translation, an SMS to multimedia message enhancement, an MMS forwarding, a spam control, a spam filtering, an SMS advertising, an SMS logging or a barring of blacklisted sender's messages. Various embodiments representing signal flow for MMS forwarding are described in conjunction with FIGS. 14A and 14B, and FIG. 15A and 15B. In addition, FIG. 12 and FIGS. 13A, 13B and 13C, describe, various embodiments of signal flow corresponding to barring of blacklisted senders and spam control applications, respectively. In another embodiment of the invention, subscriber 108 can opt for forwarding calls to a forward-to number, such as, but not limited to, a mobile number, a fixed line number or a VoIP number. In one embodiment of the present invention, SG 110 forwards all the messages to one forward-to address. In second embodiment of the present invention, SG 110 forwards each message to a distinct forward-to address.

In one embodiment of the present invention, message forwarding status is independent of status of call forwarding. In another embodiment of the present invention, status of all active VAS is independent of status of call forwarding. Message forwarding, spam control and all other value added service applications mentioned above are, hereinafter, collectively referred to as VAS. In an exemplary case, when subscriber 108 sends the activation request to activate both call forwarding and SMS forwarding in a single step, but either an operator or subscriber 108 cannot set the call forwarding at HLR-H 112, the forward-to number is still stored at SG 110. Thus, SG 110 has the setup for routing the MT calls, intended for subscriber's address, to the forward-to address.

Upon receiving a de-activation request for de-activating one or more VAS, SG 110 first queries its own database in order to check for status of one or more VAS. In first embodiment of the present invention, when a single VAS is active in the database, SG 110 first stores the de-activation request in its database and then re-updates HLR-H 112 in order to redirect the messages, sent to subscriber 108, to VMSC-V 130. Henceforth, SG 110 will no longer receive messages sent to subscriber 108. Further, SG 110 can send an acknowledgement to subscriber 108 for de-activation of VAS, upon receiving a de-activation request from subscriber 108, without affecting subscriber's mobile communication. However, in case of non-split approach, after SG 110 re-updates HLR-H 112 in order to redirect the messages, sent to subscriber 108, to VMSC-V 130, HLR-H 112 sends a registration cancellation message to SG 110, without affecting subscriber's mobile communication. Hence, the subscriber 108 continues with normal mobile communication.

In second embodiment of the present invention, when multiple VAS are detected to be active in the database, SG 110 simply stores an indication of a de-activation request in its database, and de-activates the requested VAS and acknowledges the same to subscriber 108, however, no further action is taken. Subscriber 108 can send the de-activation request from one of HPMN 102 or VPMN 104. The activation request and the de-activation request can be one of, but not limited to, a Short Message Service (SMS) message, an Unstructured Supplementary Service Data (USSD) message, a customer care interaction, a Wireless Application Protocol (WAP) interaction, a web interaction, an Interactive Voice Response (IVR) message and a SIM Tool Kit (STK) menu. The activation request and the deactivation request can be different. In an exemplary case, the subscriber 108 may send an SMS for activation request and an USSD message for de-activation request. Various embodiments of SMS forwarding to forward-to address and redelivery of SMS to forward-to address on detection of failure are described in conjunction with FIGS. 8A and 8B and FIGS. 9A and 9B, respectively.

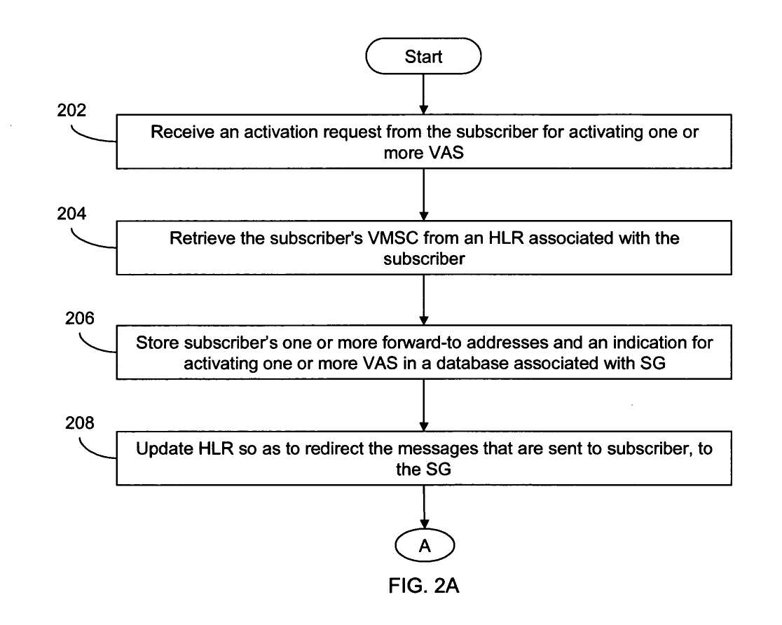

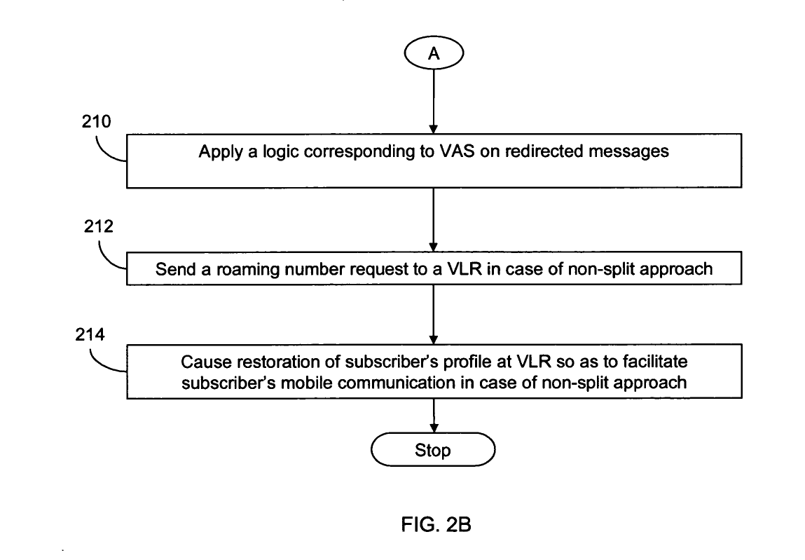

FIGS. 2A and 2B are a flow chart for providing one or more VAS to subscriber 108 of HPMN 102 without affecting subscriber's mobile communication, in accordance with an embodiment of the present invention. At step 202, an SG receives an activation request from a subscriber for activating one or more VAS. In an embodiment of the present invention, SG 110 receives an activation request from subscriber 108 for subscribing and subsequently activating one or more VAS. Thereafter, at step 204, the SG retrieves the subscriber's VMSC address from an HLR associated with the subscriber. In an embodiment of the present invention, SG 110 retrieves IMSI-A and VMSC-V 130 associated with subscriber's registered network by sending routing information query to HLR-H 112. Thereafter, at step 206, the SG stores subscriber's one or more forward-to addresses and an indication for activating one or more VAS in a database associated with SG. In an embodiment of the present invention, SG 110 stores MSISDN-A, IMSI-A, VMSC-V 130, HLR-H 112 and the indication for activating one or more VAS in the database associated with SG 110.

Furthermore, at step 208, the SG updates HLR in order to redirect the messages sent to subscriber, to the SG. In one embodiment of the present invention, SG 110 updates HLR-H 112 by sending a first registration message, such as a Location update (LUP) to HLR-H 112 which replaces VMSC-V 130 address and VLR-V 128 address with an address of SG 110, in case of the non-split approach. In another embodiment of the present invention, in case of split approach, SG 110 updates HLR-H 112 by sending a first registration message, such as a Location update (LUP) to HLR-H 112 which replaces only VMSC-V 130 address with an address of SG 110. In both approaches, the LUP message causes the redirection of the messages sent to subscriber 108, towards SG 110. Thereafter, at step 210, the SG applies a logic corresponding to VAS on redirected messages.

In first embodiment of the present invention, as a part of VAS subscribed by subscriber 108, SG 110 sends the redirected messages to one or more forward-to addresses, indicated in subscriber's preferences in the activation request. In this case, the VAS is a SMS forwarding service. In second embodiment of the present invention, SG 110 sends the redirected messages to one or more forward-to addresses depending on preferences of the operator deploying SG 110. In third embodiment of the present invention, SG 110 provides SMS advertising as VAS, where an advertisement is inserted in the message, based on the content of the message. For example, subscriber 108 may be offered a free MO-SMS for each ad-inserted SMS he receives. In another embodiment of the present invention, SG 110 logs the SMS intended for subscriber 108 for reporting and legal usage in future. Further, depending on the operator's configuration, SG 110 may forward an SMS for the subscriber 108 to a government agency as per any governmental or corporate defined rules.

Further steps in the current flowchart as discussed below, describe the facilitation of subscriber's mobile communication while subscriber's one or more VAS are active. The following steps will be observed only in case of a non-split approach, as VLR-V 128 needs subscriber's profile for facilitating subscriber's mobile communication while subscriber's one or more VAS are active.

Thus, at step 212, an SG sends a roaming number request to a VLR. In an embodiment of the present invention, SG 110 sends PRN as the roaming number request to VLR-V 128 in order to get an MSRN associated with subscriber 108. Finally, at step 214, SG 110 causes restoration of subscriber's profile at VLR in order to facilitate subscriber's mobile communication. In an embodiment of the present invention, SG 110 causes VLR-V 128 to send a profile restoration request to HLR-H so that VLR-V 128 receives the subscriber's profile information, required for facilitating subscriber's mobile communication.

In one instance, subscriber 108 can subscribe to spam filtering using web interaction. In second instance, subscriber 108 can define his own filtering rules, such as, blacklisting senders or white-listing senders, using the SMS request message. Applying VAS using blacklist and whitelist of subscriber 108 are described in conjunction with FIG. 12 and FIGS. 13A, 13B and 13C. Further, all active VAS are independent of call forwarding status, in accordance with various embodiments of the present invention.

The subscriber is generally accustomed to set and unset call forwarding via his mobile handset. In one embodiment of the present invention, the subscriber can set multiple VAS in a similar way as he sets call forwarding. In one embodiment of the present invention, if a configuration setting such as “CallforwardingRequired” is set, which indicates message forwarding is dependent on call forwarding status at HLR-H 112. In second embodiment of the present invention, if. “CallforwardingRequired” setting is unset, which indicates message forwarding is independent of call forwarding status at HLR-H 112. The activation request includes a forward-to address, such as, but not limited to, a mobile number associated with the subscriber, a fixed-line number, an email address, a Session Initiation Protocol (SIP) address, a Voice over Internet Protocol (VoIP) number, or an RSS feed generator address. Subscriber 108 can also use a single step for subscribing to one or more VAS, as described later.

In one instance, when forward-to address is found to be an empty value in activation request from subscriber 108, SG 110 queries for routing information from HLR-H 112 to obtain IMSI-A associated with subscriber 108. Further SG 110 interrogates HLR-H 112 to retrieve the forward-to number associated with subscriber 108. Subscriber 108 can then send a registration message, such as, RegisterSS, for IMSI-A to HLR-H 112, to register call forwarding number and cancel any existing call forwarding setting, at HLR-H 112. However, if no forward-to number is set at HLR-H 112, and “CallforwardingRequired” setting is set, an error message, such as “no forwarding number is set”, is sent to subscriber 108.

In another instance, when a forward-to number exists at HLR-H and CallforwardingRequired setting is also determined to be set, SG 110 sends a registration message, such as, RegisterSS, for IMSI-A to HLR-H 112, to register call forwarding number and cancel any existing call forwarding setting, at HLR-H 112. This allows subscriber 108 to use a single step message to register both call forwarding and message forwarding.

In an embodiment of the present invention, subscriber 108 registers to call forwarding as a VAS via MO SMS instead of a phone menu. In this case, text can be prefixed to a forward-to number, for example, “Call” to indicate unconditional call forwarding. In various embodiments of the present invention, a network operator allows call forwarding and message forwarding on distinct numbers. In such a case, subscriber 108 can chose one amongst the possible solutions. One of the solutions allow subscriber 108 to use distinct SME addresses to indicate call forwarding and message forwarding. Alternatively, subscriber 108 can use the same SME address by applying a prefix before the forwarding number, such as “SMS”, for indicating message forwarding and “Call” as prefix for indicating call forwarding. Subscriber 108 can also use “SC” as the prefix before the forwarding number for subscribing to set call forwarding and message forwarding to be same number. In an exemplary case, if the same SME address is used, subscriber 108 can send MO SMS to the SME address, with the following possible text options:

SC—same as call forwarding number (CFU)

SMS +19255551212—message forwarding number different from CFU

Call +19255553455—set call forwarding number

SC +19255551212—set both call forwarding and message forwarding to be same number

SMS abc@xyz.com—message forwarding to an email address

When subscriber 108 uses SC to set unconditional call forwarding and SMS (message) forwarding, the network operator or the subscriber himself cannot set call forwarding at HLR-H 112. Since the forward-to number is present at SG 110, whenever an MT call for subscriber's number reaches subscriber's GMSC, the call is redirected to the forward-to number, even though HLR-H 112 does not have forward-to setup for subscriber 108.

In an embodiment of the present invention, the network operator can define rules on subscribers to allow or disallow one or more subscriber from subscribing to one or more VAS. In another embodiment of the present invention, subscriber 108 can indicate whether he wants MO and MT activities to be allowed from his handset or not, while being subscribed to one or more VAS. Exemplary messages are shown as follows:

SMS +19255551212 on—SMS forwarding number set and subscriber 108 is allowed to execute MO and MT communication

SMS +19255551212 off—SMS forwarding number set but subscriber 108 cannot execute MO and MT communication

In an embodiment of the present invention, when SMS is sent by the subscriber's forwarding number to register with one or more VAS, subscriber's forwarding number is retrieved by SG 110 and stored in its database, further, message forwarding status is set to ON for subscriber 108. SG 110 will also store forward-to number and an IMSI of the forwarding number (i.e. IMSI-A), in its database subscriber 108 will receive an acknowledgement message, for instance, “OK”, to inform that the message forwarding status is set. Once the message forwarding for subscriber 108 is set, SG 110 will thereafter register its address as the subscriber's current VMSC address in the HLR associated with subscriber 108.

In another embodiment of the present invention, when subscriber 108 is subscribed to SMS forwarding as a VAS, the messages intended for subscriber 108 are redirected to the forward-to address associated with subscriber 108. In one instance, subscriber's forward-to address may be unreachable and SMS is not delivered to the subscriber's forward-to address. Thereafter, SMS redelivery may occur on forward-to address as described in conjunction with FIGS. 9A and 9B. There may also be a case when subscriber 108 may be unreachable and SMS is not delivered to subscriber's address. Therefore, SMS redelivery will occur on subscriber's address as described in conjunction with FIG. 11. In another embodiment of the present invention, subscriber 108 has not subscribed SMS forwarding as VAS but maybe subscribed to any other VAS. Thus, SMS sent to subscriber 108 may only be delivered at subscriber's address, as no forward-to address is present in this case.

In one or more of the above described instances, the process of re-delivery of the messages to subscriber's address (or forward-to address) may continue for a pre-defined number of attempts. This pre-defined number of attempts may either be based on subscriber's preferences or operator's preferences. For example, the operator may configure in its database for message redelivery to be attempted only for three times. However, if still the SMS is not delivered to either subscriber's address or his forward-to address, SG 110 may send a notification message to originating SMSC (i.e. SMSC-O), which further relays the notification message to sender's handset. The notification message informs the sender that subscriber 108 is unavailable and the SMS is not delivered to subscriber's handset. The response in the notification message sent to the sender may be configured based either on subscriber's preferences or on operator's preferences. For example, the notification message sent to the sender may represent subscribers' unavailability with a message, such as, but not limited to, “I forgot my handset at home”, “My handset is out-of order”, “I am currently on vacation”, “I am on a plane”, “I have lost my handset” and “My handset's battery is discharged so unable to respond to your SMS”.

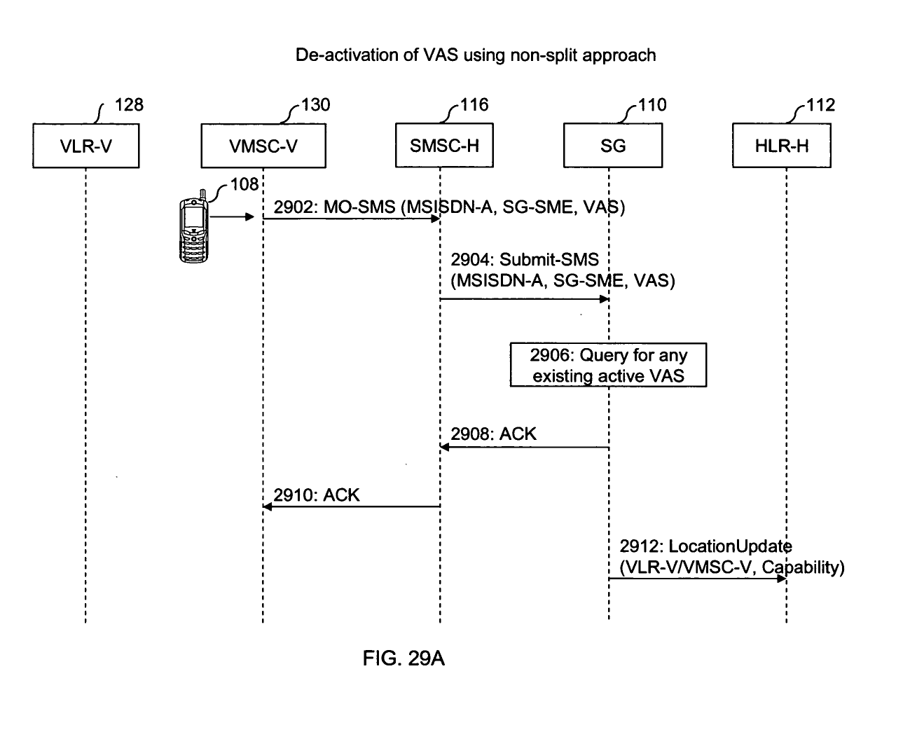

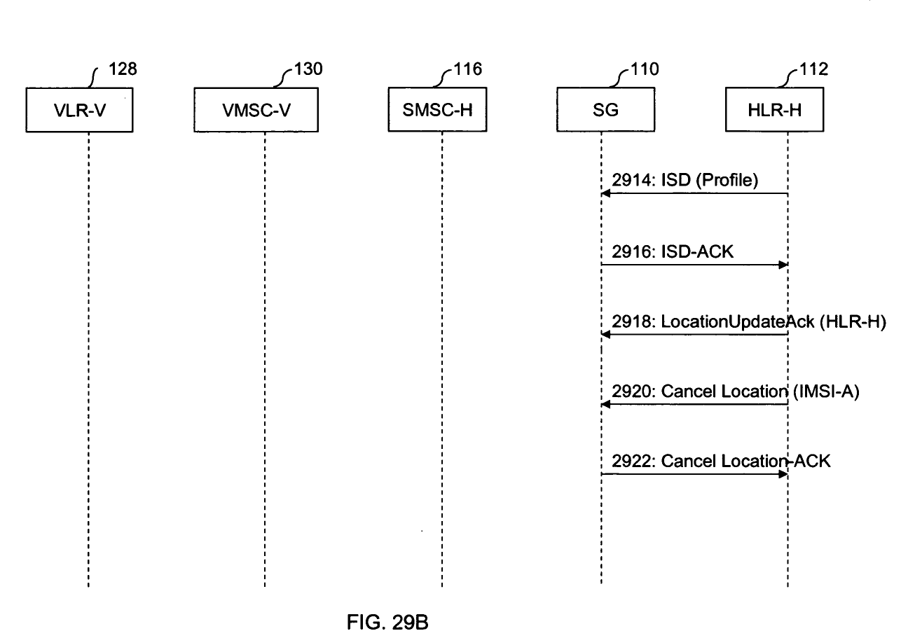

When the subscriber's handset sends a de-activation request for de-activating one or more VAS, SG 110 will use stored addresses of VMSC-V 130 and VLR-V 128 to update HLR-H 112 with VMSC-V 130 and VLR-V 128. In an embodiment of the present invention, subscriber 108 may send a subscription de-activation SMS request to the SME number of SG 110 to de-activate the subscription of one or more VAS. Various embodiments representing signal flow corresponding to de-activation of VAS are described in conjunction with FIGS. 29A and 29B.

In one embodiment of the present invention, a mapping table for VMSC-V 130 and VLR-V 128 is used to restore VMSC-V 130 and VLR-V 128 at HLR-H 112, when location update is performed. Mapping table can be created from IR 21 database or from information retrieved by monitoring signaling exchange associated with subscriber 108. In one instance when VMSC address associated with subscriber 108 is determined to be empty in the database, re-registration will be a purging message, such as PurgeMS message. In another instance of the present invention, when VMSC address associated with subscriber 108 is successfully determined in the database, SG 110 will re-register subscriber's VMSC address and VLR address by sending the location update message to HLR-H 112.

In case of the non-split approach, SG 110 will then receive a registration cancellation message such as CancelLoc from HLR-H 112 and subscriber's location will now be set to original VLR and VMSC addresses at HLR-H 112. However, in case of split approach, SG 110 will not receive the CancelLoc message, as VLR-V 128 is unaffected during LUP.

FIGS. 3A and 3B is a flow diagram representing an SMS as an activation request from a subscriber for activating one or more VAS in a non-split approach, in accordance with a first embodiment of the present invention. The operator deploying SG 110 creates a Short Message Entity (SME) number, which points to the address of SG 110. Subscriber 108 can send the subscription activation SMS request from VPMN 104 if subscriber 108 is the roaming subscriber of HPMN 102 in VPMN 104. Subscriber 108 sends subscription activation SMS request, which first reaches VMSC-V 130. At step 302, VMSC-V 130 sends the subscription activation SMS request to SMSC-H 116 with the SME number to activate one or more VAS. At step 304, SMSC-H 116 submits the subscription activation SMS request to SG 110 since the SME number points to the address of SG 110. SG 110 further stores the indication of subscription activation SMS request in the database associated with SG 110. Thereafter, at step 306, SG 110 sends an acknowledgement to SMSC-H 116. SMSC-H 116 further acknowledges VMSC-V 130, at step 308. The acknowledgement message, for instance, “OK”, is sent to subscriber 108 to inform that the requested one or more VAS are active for subscriber 108. Thereafter, SG 110 looks for VMSC-V 130 address in the database. However, if VMSC-V 130 address is not present in the database, it indicates a fake location of SG 110's own address is already set at HLR-H 112. SG 110, at step 310, then sends a routing information query for MSISDN-A to HLR-H 112 using a message, such as Send Routing Information for Short Message, SRI-SM (MSISDN), to find IMSI-A and VMSC-V 130. Thereafter, at step 312, HLR-H 112 responds to SG 110 with IMSI-A and VMSC-V 130 in the acknowledgement message. Further, at step 314, SG 110 stores in its database records of HLR-H 112, VMSC-V 130, IMSI-A and MSISDN-A corresponding to subscriber 108. In another embodiment of the present invention, SG 110 stores address of SMSC-H 116 and VLR-V 128 in its database. These records are maintained for bookkeeping purpose. VMSC-V 130 and IMSI-A are retrieved at step 312, when HLR-H 112 responds to SG 110 with IMSI-A and VMSC-V 130. In an embodiment of the present invention, VLR-V 128 is determined by using a mapping table for VMSC and VLR. It will be apparent to a person skilled in the art that VMSC and VLR usually have a one-to-one mapping and a B-interface between VLR and VMSC is a proprietary interface, which helps VLR and VMSC to exchange messages with SSN intended for the other. In one embodiment of the invention, when subscriber 108 is registered neither with HPMN 102 nor with VPMN 104, VMSC entry is returned empty in the acknowledgement at step 312.

Thereafter, at step 316, SG 110 updates HLR-H 112 so as to redirect the messages sent to subscriber 108, to SG 110 by sending the registration message, such as Location Update (LUP), to HLR-H 112. Further, at step 318, SG 110 receives subscriber data included in a message, such as InsertSubscriberData (ISD) from HLR-H 112 in response to the LUP received at HLR-H 112. Thereafter, at step 320, SG 110 responds to HLR-H 112 with an acknowledgement, such as, ISD-ACK, to indicate successful addition of subscriber data at SG 110. Further, at step 322, SG 110 receives the acknowledgement from HLR-H 112, to indicate successful replacement of VMSC-V 130 and VLR-V 128 with the address of SG 110, at HLR-H 112. In an embodiment of the present invention, address of SG 110 is modified, to include a roaming GT when subscriber 108 is present in VPMN 104. In this embodiment, SG 110 updates HLR-H 112, at step 316, by replacing VMSC-V 130 and VLR-V 128 with the roaming GT. In another embodiment of the invention, address of SG 110 is modified, to include a non-roaming GT when subscriber 108 is present in HPMN 102. In this embodiment, SG 110 updates HLR-H 112, at step 316, by replacing VMSC-H 120 and VLR-H 118 with the non-roaming GT.

Since HLR-H 112 received a fake LUP from SG 110, HLR-H 112 cancels the registration of subscriber 108 with real VLR-V 128. Hence, at step 324, VLR-V 128 receives a registration cancellation message, such as CancelLoc, from HLR-H 112. Thus, HLR-H 112 cancels the VLR-V 128 location and all subsequent messages to subscriber 108 are redirected to SG 110, instead of VMSC-V 130 and VLR-V 128. This results in VLR-V 128 to remove the IMSI-A records from its database. In case of GPRS registration, an SGSN-V instead of VLR-V 128 receives the registration cancellation message from HLR-H 112. Finally, at step 326, VLR-V 128 responds to HLR-H 112 with the acknowledgement to registration cancellation message. This confirms that VLR-V 128 has removed the subscriber's profile from its database. The acknowledgement, received at step 326, further confirms that HLR-H 112 is now having information that subscriber's VMSC address and subscriber's VLR address is a roaming GT associated with SG 110. This results in redirecting messages intended for subscriber 108 to SG 110, as the address of SG 110 is the new VMSC address and VLR address of subscriber 108. Hence, in order to enable mobile communication from subscriber's handset, his profile needs to be restored at his current location, i.e. VLR-V 128. The restoration of subscriber's profile is described in conjunction with FIGS. 5A and 5B.

FIGS. 4A and 4B is a flow diagram representing SMS as an activation request from a subscriber for activating one or more VAS in a split approach, in accordance with a second embodiment of the present invention. The basic idea for subscribing to one or more VAS remains the same as in non-split approach. Subscriber 108 will send the subscription activation SMS request, which first reaches VMSC-V 130. Steps 402 to 414 are identical to steps 302 to 314 as described above. In the split approach, unlike the non-split approach, only subscriber's VMSC address is replaced with the address of SG 110. In an embodiment of the present invention, VLR-V 128 is determined by using a mapping table for VMSC and VLR.

At step 416, SG 110 updates HLR-H 112 to redirect the messages to SG 110 by sending a registration message, such as Location Update (LUP), to HLR-H 112. HLR-H 112 replaces VMSC-V 130 address with the address of SG 110 so as to redirect the messages that are sent to subscriber 108, to the address of SG 110. Further, at step 418, SG 110 receives subscriber data included in the message, such as InsertSubscriberData (ISD) from HLR-H 112 in response to the LUP received at HLR-H 112, at step 416. Thereafter, at step 420, SG 110 responds to HLR-H 112 with an acknowledgement, such as, ISD-ACK, indicating successful addition of subscriber data at SG 110. Finally, at step 422, SG 110 receives an acknowledgement from HLR-H 112 that VMSC-V 130 address is replaced with the address of SG 110, at HLR-H 112. However, in the split approach, as VLR-V 128 is not affected during LUP, the subscriber's profile is still maintained at VLR-V 128, thus enabling subscriber's mobile communication. In an embodiment of the present invention, address of SG 110 is modified, to include a roaming GT when subscriber 108 is present in VPMN 104. In this embodiment, SG 110 updates HLR-H 112 by replacing VMSC-V 130 with the roaming GT. In another embodiment of the invention, SG 110 is modified, to include a non-roaming GT when subscriber 108 is present in HPMN 102. In this embodiment, SG 110 updates HLR-H 112 by replacing VMSC-H 120 with the non-roaming GT.

In one embodiment of the present invention, subscriber 108 may receive a Mobile Terminated (MT) call, after the registration process is performed in conjunction with FIGS. 3A and 3B and 4A and 4B. In case of the non-split approach, as VLR-V 128 receives CancelLoc at step 324, VLR-V 128 sends a data restore message to HLR-H 112 to restore the subscriber's profile, using a message, such as RestoreData message. Call can still be received in case of split approach as VLR-V 128 does not receive any CancelLoc and thus maintains the subscriber's profile. Various embodiments representing signal flow of restoration of subscriber's profile for non-split approach is described in conjunction with FIGS. 5A and 5B. In another embodiment of the present invention, when subscriber 108 associates with the updated VLR, such as when subscriber 128 resets the power of the handset or when a subscriber 108 changes his current location, then VLR-V 128 (or new VLR) sends a LUP to HLR-H 112. Various embodiments representing signal flow corresponding to an LUP message for non-split approach and split approach are described in conjunction with FIGS. 6A and 6B and FIGS. 7A and 7B, respectively.

FIGS. 5A and 5B represents a flow diagram for restoring subscriber's profile at VLR associated with the subscriber's address in the non-split approach, in accordance with an embodiment of the present invention. In case of the non-split approach as both VMSC-V 130 and VLR-V 128 are replaced with the address of SG 110, subscriber's profile needs to be restored at VLR-V 128 for facilitating subscriber's mobile communication. SG 110 uses signaling messages, such as Signaling Connection and Control Part (SCCP) messages, for sending the roaming number request to VMSC-V 130 with called party address as VLR-V 128. In one embodiment of the present invention, roaming number request is sent to VMSC-V 130 with SCCP CdPA set to SSN equal to 7, which corresponds to called party as VLR-V 128. In second embodiment of the present invention, SG 110 sends the roaming number request directly to VLR-V 128 based on a mapping table for VMSC and VLR. VMSC-V 130 is located from stored subscriber records as maintained in FIGS. 3A and 3B. At step 502, SG 110 sends roaming number request message such as, Provide Roaming Number (PRN) for IMSI-A to VMSC-V 130 with signaling message, SCCP CdPA SSN set to 7 that corresponds to called party address as VLR-V 128. VMSC and VLR usually have a one-to-one mapping use the proprietary B-interface to exchange messages with SSN intended for the other, as described above. Thereafter, at step 504, VLR-V 128 responds to the PRN request, sent by SG 110, with a roaming number such as, Mobile Station Roaming Number (MSRN), to SG 110. The MSRN is the roaming number provided to subscriber 108 while he is roaming in VPMN 104. VLR-V 128 can send an authentication request to HLR-H 112 so as to get authentication for IMSI-A, when IMSI-A is not found in VLR-V 128 records. IMSI-A may not be present in VLR-V 128, as VLR-V 128 received the registration cancellation message as described earlier. Thus, at step 506, since VLR-V 128 has no authentication to IMSI-A records, VLR-V 128 sends an authentication request message such as, Send Authentication Information (SAI) to HLR-H 112 for acquiring an authentication corresponding to IMSI-A. SAI is sent from VLR-V 128 to HLR-H 112 with signaling message, SCCP CdPA set to E214 address for IMSI-A. It will be apparent to a person skilled in the art that in case of GPRS, SGSN-V corresponding to subscriber 108 can send SAI message to HLR-H 112. In an alternate embodiment, VLR-V 128 sends the authentication request to SG 110, which relays the authentication request to HLR-H 112. Thereafter, at step 508, VLR-V 128 receives an acknowledgment to SAI message with the authentication information for acquiring IMSI-A. In an alternate embodiment, HLR-H 112 sends the authentication information to SG 110, which further relays to VLR-V 128.

After, receiving the authentication from HLR-H 112, VLR-V 128 sends a Restore Data (RSD) message to HLR-H 112 for acquiring at VLR-V 128 with subscriber's profile information, required for facilitating subscriber's mobile communication. Step 510 is invoked by VLR-V 128 when it receives a PRN message for an unknown IMSI-A or for a known IMSI-A with the indicator “Confirmed by HLR-H 112” set to “Not confirmed”. The Restore Data message is sent from VLR-V 128 to HLR-H 112 with signaling message, SCCP CdPA set to E214 address for IMSI-A. In an alternate embodiment, VLR-V 128 sends the profile restoration request and authentication request to SG 110, which further can relay to HLR-H 112 in order to restore subscriber's profile at VLR-V 128. It will be apparent to a person skilled in the art that in case of GPRS, SGSN-V sends the profile restoration request to HLR-H 112. Thereafter, at step 512, HLR-H 112 sends the message, such as InsertSubscriberData, ISD, to update VLR-V 128 with the subscriber data in response to the profile restoration request received at HLR-H 112. In an alternate embodiment, HLR-H 112 sends the ISD to SG 110, which further relays ISD to VLR-V 128. Thereafter, at step 514, VLR-V 128 acknowledges the ISD message with a message such as ISD-ACK to HLR-H 112. In an alternate embodiment, VLR-V 128 sends the ISD-ACK to SG 110, which further relays to HLR-H 112. Further, at step 516, HLR-H 112 sends the RSD-ACK message to VLR-V 128, to indicate successful restoration of subscriber's profile at VLR-V 128. The profile restoration provides VLR-V 128 with updated subscriber's profile to enable mobile communication. Since, restore data does not affect entries for VMSC-V 130 and VLR-V 128 stored in HLR-H 112, messages sent to subscriber 108, are still redirected to SG 110. In an alternate embodiment, HLR-H 112 sends the RSD-ACK message to SG 110, which further relays the acknowledgement to VLR-V 128. Finally, at step 518, VLR-V 128 stores the updated subscriber data and location information confirmed by HLR-H 112.

In one embodiment of the present invention, when SG 110 relays the signalling exchange, Transaction Capabilities Application Part (TCAP) relay is used. In this case, SG 110 establishes a transaction with the initiating party and creates a new transaction with the destination party. Thereafter, SG 110 uses a single GT for multiple VLRs and multiple HLRs, as transaction IDs are used for identifying between different VLRs and HLRs. Alternatively in accordance with another embodiment of the invention, SCCP is used for relaying. In this case, SG 110 does not create a new transaction on receiving a transaction from the initiating party, instead, simply relays the transaction to the destination party by changing CdPA and Calling Party Address (CgPA), and various other parameters in the messages.

During the registration process, subscriber's location at HLR-H 112 is set to address of SG 110 as explained in conjunction with FIGS. 3A and 3B and FIGS. 4A and 4B. However, VLR-V 128 maybe changed when subscriber 108 resets the power of handset or when a subscriber 108 changes his current location. FIGS. 6A and 6B represents a flow diagram for a location update (LUP) by subscriber's handset in the non-split approach, while one or more VAS are active, in accordance with a first embodiment of the present invention. At step 602, as subscriber 108 has reset his handset, VLR-V 128 sends a new LUP message (second registration message) to re-update HLR-H 112 for IMSI-A, VLR-V 128 and VMSC-V 130. It will be apparent to a person skilled in the art that location update in FIGS. 6A and 6B is considered for a case when subscriber 108 has reset the power of handset. However, in an alternate embodiment of the present invention, when location update is performed due to change of subscriber's location, modified VLR corresponding to subscriber's modified location, sends LUP message to update HLR-H 112 for IMSI-A, modified VLR-V and modified VMSC-V. In an embodiment of the present invention, when location update occurs due to change of subscriber's location, HLR-H 112 is updated with a modified IMSI corresponding to subscriber's registered network when subscriber's SIM can manage multiple IMSIs or subscriber 108 changes the SIM at the modified location.

Thereafter, at step 604, HLR-H 112 sends subscriber data to VLR-V 128 using InsertSubscriberData (ISD) message. Further, at step 606, VLR-V 128 responds to HLR-H 112 with an acknowledgement, such as ISD-ACK, indicating successful addition of subscriber data at VLR-V 128. Thereafter, at step 608, HLR-H 112 sends an acknowledgement, such as LUP-ACK, of the LUP message to VLR-V 128. VLR-V 128 receives the LUP-ACK indicating that HLR-H 112 has been updated with IMSI-A, updated VMSC-V 130 and updated VLR-V 128. Since HLR-H 112 confirms new registration with VLR-V 128, HLR-H 112 cancels the earlier registration with SG 110. Hence, at step 610, HLR-H 112 sends a registration cancellation message, such as CancelLoc, to SG 110. SG 110 receives CancelLoc from HLR-H 112, due to second registration message received at HLR-H 112. Further, at step 612, SG 110 sends the CancelLoc acknowledgement to HLR-H 112, indicating successful cancellation of the earlier registration.

Now in order to continue providing one or more VAS to subscriber 108, SG 110 needs to intercept the messages intended for subscriber 108 at its own address. Hence at step 614, SG 110 sends a routing information query for MSISDN-A to HLR-H 112 using a message, such as Send Routing Information for Short Message, SRI-SM (MSISDN-A), to find IMSI-A and updated VMSC associated with subscriber 108. At step 616, HLR-H 112 acknowledges to SG 110 with the IMSI-A and VMSC-V 130. In an alternate embodiment of the present invention, when subscriber 108 changes location, HLR-H 112 acknowledges SG 110 with modified VMSC. At step 618, SG 110 then stores in its database the updated records of HLR-H 112, VMSC-V 130, IMSI-A and MSISDN-A. In an embodiment of the present invention, VLR-V 128 is determined by using a mapping table for VMSC and VLR. Further, in order to continue providing one or more VAS to subscriber 108, SG 110 at step 620, updates HLR-H 112 by sending a new LUP registration message. This LUP message from SG 110 once again replaces VMSC-V 130 address and VLR-V 128 address with the address of SG 110 redirecting the messages sent to subscriber 108, to SG 110. In an alternate embodiment of the present invention, when location update occurs due to change of subscriber's location, modified VMSC address and modified VLR address is replaced with the address of SG 110 redirecting the messages that are sent to subscriber 108, to SG 110.

Subsequently, at step 622, SG 110 again receives an InsertSubscriberData (ISD) message from HLR-H 112. Thereafter, at step 624, SG 110 sends the ISD-ACK message to HLR-H 112, indicating successful addition of subscriber data at SG 110. At step 626, SG 110 receives the LUP acknowledgement from HLR-H 112, indicating successful replacement of VMSC-V 130 address and VLR-V 128 address with the address of SG 110, at HLR-H 112. Subsequently, at step 628, HLR-H 112 sends a CancelLoc message to VLR-V 128 to de-register subscriber 108 from VLR-V 128's database. Thus, HLR-H 112 will not include VLR-V 128 location in its database and all messages to subscriber 108 are redirected to SG 110, instead of VLR-V 128. In an embodiment of the present invention, when GPRS registration is considered, SGSN-V in VPMN 104 receives the registration cancellation message from HLR-H 112. Finally, at step 630, VLR-V 128 acknowledges the registration cancellation message by sending CancelLoc-ACK to HLR-H 112. This acknowledgement confirms that HLR-H 112 has subscriber's VMSC address and subscriber's VLR address as a roaming GT associated with SG 110. This enables SG 110 to implement various logics on the messages sent to subscriber 108 as a part of one or more VAS. Hence, SG 110 is able to provide an uninterrupted VAS to subscriber 108. In order to facilitate subscriber 108 for continuing his mobile communication from his current location, SG 110 repeats the process of subscriber's profile restoration at VLR-V 128, as described in conjunction with FIGS. 5A and 5B. In another embodiment of the present invention, when subscriber 108 changes location and hence changes his associated VLR, SG 110 performs subscriber's profile restoration at modified VLR associated with subscriber's registered network.

In the above embodiment for non-split approach, there is a requirement for restoration of subscriber's profile at VLR-V 128, since both VLR-V 128 and VMSC-V 130 are replaced with SG 110, during the fake LUP process by SG 110. FIGS. 7A and 7B represents a flow diagram for location update by subscriber's handset in a split approach, while one or more VAS are active, in accordance with a second embodiment of the present invention. At step 702, as subscriber 108 resets his handset, VLR-V 128 sends LUP message to update HLR-H 112 for IMSI-A, VLR-V 128 and VMSC-V 130. It will be apparent to a person skilled in the art that location update in FIGS. 7A and 7B is considered for the case when subscriber 108 resets his handset. However, in an alternate embodiment of the present invention, when location update is performed due to change of subscriber's location, modified VLR corresponding to subscriber's modified location, sends LUP message to update HLR-H 112 for IMSI-A, modified VLR-V 128 and modified VMSC-V 130. In an embodiment of the present invention, when location update occurs due to change of subscriber's location, HLR-H 112 is updated with a modified IMSI corresponding to subscriber's registered network when subscriber's SIM can manage multiple IMSIs or subscriber 108 changes the SIM at the new location. Thereafter, at step 704, HLR-H 112 sends subscriber data to VLR-V 128 with the message, such as InsertSubscriberData (ISD). Further, at step 706, VLR-V 128 responds to HLR-H 112 with the acknowledgement, such as ISD-ACK, indicating successful addition of subscriber data at VLR-V 128. Thereafter, at step 708, HLR-H 112 sends an acknowledgement, such as LUP-ACK, of the LUP message to VLR-V 128. VLR-V 128 receives the LUP-ACK indicating that HLR-H 112 has been updated with IMSI-A, updated VMSC-V 130 and updated VLR-V 128. In case of the split approach, since VLR-V 128 is not replaced with SG 110 during the registration process, SG 110 does not receive any CancelLoc when VLR-V 128 this time sends a new LUP message. Thus, at step 710, a monitoring system is required which monitors all LUP messages received at HLR-H 112 due to subscriber 108 resetting the power of handset or changing his location. If no monitoring is perfomed, SG 110 will not be informed for any location update from subscriber 108. This may affect one or more subscribed VAS of subscriber 108. Thus, a solution is required that monitors all location updates occurring at HLR-H 112 associated with subscriber 108. The monitoring of the location updates are required which are performed at HLR-H 112 due to subscriber 108 resetting the power of handset or changing his location. Various solutions for monitoring location updates associated with subscriber 108 are described later.

In first embodiment of the present invention, SG 110 has a built-in monitoring system, which uses OMAP or IP-based provisional interface to register in order to inform SG 110 with location update events associated with subscriber 108, at HLR-H 112. HLR vendor's IN/CAMEL can support this solution of monitoring location updates to HLR-H 112. In an alternate embodiment of the present invention, monitoring system is located at third party vendor's location and SG 110 interfaces with the monitoring system.

In second embodiment of the present invention, SG 110 has a built-in monitoring system in which, HLR-H 112 sends Mobility Camel Subscription Information (M-CSI) to VLR-V 128 to register in order to inform SG 110 with location update events associated with subscriber 108, at HLR-H 112. Network vendor's can support this solution of monitoring location updates to HLR-H 112. This kind of monitoring system may also be located at third party vendor's location.

In third embodiment of the present invention, SG 110 has a built-in monitoring system in which, SG 110 periodically polls HLR-H 112 at configurable time intervals for any location update messages received at HLR-H 112. The time interval for polling may vary with the time of the day, like, every half an hour in night, while every 5-10 minutes during afternoon lunch time, when more subscribers are roaming and changing locations. While polling HLR-H 112, a case maybe detected where VMSC stored at HLR-H 112 does not match with the address of SG 110, which indicates that HLR-H 112 has been updated with subscriber's location information. Thus, SG 110 can again send location update message to HLR-H 112 to change the updated VMSC address to back the address of SG 110 as in explained in conjunction with FIGS. 4A and 4B.

After receiving the location update information at SG 110, SG 110 further sends a routing information query for MSISDN-A to HLR-H 112 using a message, such as Send Routing Information for Short Message, SRI-SM (MSISDN-A), to find IMSI-A and updated VMSC associated with subscriber 108. In an alternate embodiment of the present invention, when subscriber 108 changes location, updated VMSC received at SG 110 from HLR-H 112 is the modified VMSC. At step 714, HLR-H 112 acknowledges to SG 110 with the IMSI-A and VMSC-V 130. In an alternate embodiment of the present invention, when subscriber 108 changes location, HLR-H 112 acknowledges SG 110 with modified VMSC. At step 716, SG 110 then stores in its database the updated records of HLR-H 112, VMSC-V 130, IMSI-A and MSISDN-A. In an embodiment of the present invention, VLR-V 128 is determined by using mapping table for VMSC and VLR. In an embodiment of the present invention, VLR-V 128 is stored in the database. As explained earlier, VMSC and VLR usually have a one-to-one mapping and use the proprietary B-interface between them to exchange messages with SSN intended for the other. Thereafter in order to facilitate one or more VAS to subscriber 108, at step 718, SG 110 re-registers with HLR-H 112 by sending a new LUP message. This new LUP message from SG 110 replaces only VMSC-V 130 address with the address of SG 110 redirecting the messages sent to subscriber 108, to SG 110. VLR-V 128 is not changed, rather, SG 110 only sends the mapped VLR-V during the new LUP. In an alternate embodiment of the present invention, when location update occurs due to change of subscriber's location, modified VMSC address is replaced with the address of SG 110, redirecting the messages that are sent to subscriber 108, to SG 110. Since VLR-V 128 is still maintaining subscriber 108 profile, mobile activities are not affected.

Subsequently, at step 720, SG 110 receives data update request in a message, such as InsertSubscriberData (ISD) from HLR-H 112 in response to LUP received at HLR-H 112. Thereafter, at step 722, SG 110 sends the acknowledgement to HLR-H 112 with an ISD-ACK message, indicating successful addition of subscriber data at SG 110. Finally, at step 724, SG 110 receives the acknowledgement for the LUP message from HLR-H 112 indicating successful replacement of VMSC-V 130 address with the address of SG 110, at HLR-H 112. VLR-V 128 does not receive any CancelLoc message, in case of split approach, as only the VMSC address is replaced with the address of SG 110. Moreover, SG 110 is still able to provide an uninterrupted VAS to subscriber 108 without affecting subscriber's mobile communication. Thus, subscriber 108 is able to continue with his mobile communication (i.e. MO and MT activities) as subscriber's profile stored at VLR-V 128 is not altered when location update occurs.

FIGS. 8A and 8B represents a flow diagram of MT SMS delivery to a forward-to address of the subscriber, in accordance with an embodiment of the present invention. Subscriber 108 can activate one or more VAS using various methods as described before. SMS forwarding technique is same for both, split approach and non-split approach. In an embodiment of the present invention, an SMSC-O 801 sends an MT SMS to subscriber 108. SMSC-O 801 corresponds to an originating SMSC that sends messages from a sender to subscriber 108. The sender corresponds to a person sending the messages to subscriber 108. When SMSC-O 801 receives a message, then at step 802, SMSC-O 801 sends a routing information query for short messages, such as SRI-SM, for MSISDN-A (i.e. subscriber A) to HLR-H 112. Thereafter, at step 804, HLR-H 112 responds to SMSC-O 801 with the routing information like IMSI-A and address of SG 110. IMSI-A is already present in subscriber's profile information stored at HLR-H 112. HLR-H 112 returns address of SG 110 instead of VMSC address associated with subscriber 108, due to faking performed during registration process as explained earlier. Since, SMSC-O 801 is informed of SG 110 as the VMSC address, at step 806, SMSC-O 801 forwards the messages to SG 110 with IMSI-A. Further, SG 110 also has HLR-H 112 information in its database.

Since, the messages sent to subscriber 108, are redirected to SG 110, and subscriber 108 has opted for SMS forwarding in his activation request, these SMS are forwarded to a forward-to number (F) after retrieving the routing information of the forward-to number. Thus, at step 808, SG 110 sends a routing information query to an HLR-F 803, for obtaining the routing information of the forward-to number (F). HLR-F 803 corresponds to a forward-to number's HLR that has the forward-to number's profile information and routing information.

Further, at step 810, HLR-F sends the routing information like IMSI-F and address of a VMSC-F 805, corresponding to forward-to number's registered network, to SG 110. VMSC-F 805 corresponds to a forward-to number's VMSC that has forward-to number's call request handling information and switching information. In an embodiment of the present invention, when GPRS services are used, routing information of SGSN-F is sent to SG 110, instead of VMSC address. Thereafter, at step 812, SG 110 forwards the SMS to VMSC-F 805 for IMSI-F. VMSC-F 805 then sends the message to forward-to handset associated with IMSI-F. VMSC-F 805 may also use SearchMS message to locate the forward-to handset. In an embodiment of the present invention, SMS received at SG 110 is stored in SG's database for various reasons, such as, but not limited to, call logs, CDR details, SMS failure due to absent subscriber and memory capacity exceeded at forward-to handset. However, SG 110 changes the SMSC parameter during the relay from VMSC-F 805 so that the subsequent acknowledgments due to further handset activities such as, but not limited to, SMS read, and user menu response are relayed via SG 110 to SMSC-O 801. In an embodiment of the present invention, VMSC-F 805 acknowledges SMS delivery directly to SMSC-O 801.

Alternatively, VMSC-F 805 sends an acknowledgement to SG 110, at step 814, indicating successful delivery of SMS at forward-to handset. Thereafter, at step 816, SG relays the acknowledgment of SMS delivery back to SMSC-O 801. SMSC-O 801 can further relay the delivery report to a sender associated with SMSC-O 801, if sender has requested for the delivery report, in accordance with the present invention. SMS delivery report to sender's handset associated with SMSC-O 801 can also be used in various instances, such as, but not limited to, Read Ack, user menu response and intermediate notification. Further, at step 818, if SMSC-O 801 supports the feature of sending delivery report to subscriber 108, SMSC-O 801 can also send the SMS delivery report to subscriber 108 via SG 110, indicating successful delivery of SMS to F's handset. Further, SG 110 also handles message types such as, but not limited to, delivery receipt, Read ACK, user menu response, and intermediate notification and message modes such as, but not limited to, datagram mode, store and forward mode, and transaction mode of SMSC-O 801 relaying through SG 110. Finally, at step 820, subscriber's handset acknowledges SMSC-O 801 which can be used by SMSC-O 801 to detect the subscriber's handset activities, such as, but not limited to, Read ACK, user menu response, and intermediate notification.

However, if the delivery of SMS to the F's handset fails, SG 110 relays the failure reasons back to SMSC-O 801. In addition, if SMS delivery fails due to a power off of the forward-to handset (F) or because the SMS memory capacity exceeds maximum limit, then SG 110 can optionally store the message and send the SMS delivery report to HLR-F 803 to alert for future re-delivery of SMS. FIGS. 9A and 9B represents a flow diagram of MT SMS redelivery to the forward-to address of the subscriber, upon detecting failure in the previous attempt. Redelivery of SMS to subscriber's forward-to address is also same for the split approach as well as the non-split approach. SMS redelivery occurs when SMS delivery failure reason due to absent subscriber or because the SMS memory capacity exceeds maximum limit. At step 902, VMSC-F 805 sends to SG 110, the acknowledgement failure message indicating SMS failure occurred while delivering the SMS to subscriber 108. In addition, if the failure reasons are due to forward-to handset power OFF or SMS memory capacity exceeding maximum limit, SG 110 stores the SMS, at step 904. Thereafter, at step 906, SG 110 sends a report for SMS delivery message to HLR-F 803 so that whenever the handset is ready for SMS, HLR-F 803 alerts SG 110 for redelivery of SMS to F's handset. HLR-F 803 sends the acknowledgement to SG 110, at step 908, indicating successful acceptance of delivery report at HLR-F 803. At step 910, when the forward-to handset is ready to receive SMS, VMSC-F 805 sends an indication to HLR-F 803 for IMSI-F with a ready alert message, such as ReadyForSMS. Further, at step 912, HLR-F 803 sends the acknowledgement to VMSC-F 805, indicating successful alert at HLR-F 803 for SMS redelivery. Thereafter, at step 914, HLR-F 803 sends an alert message, such as AlertSC, to SG 110 for alerting SG 110 for redelivery of SMS. SG 110 on receiving alert message for redelivery of SMS sends an acknowledgement to HLR-F 803, at step 916.

Thereafter, at step 918, SG 110 sends HLR-H 112 with the ready alert message, such as, ReadyForSMS, for IMSI-A. Further, at step 920, HLR-H 112 acknowledges SG 110 that HLR-H 112 is successfully been alerted for redelivering SMS for IMSI-A. At step 922, HLR-H 112 further alerts SMSC-O 801 with the alert message, such as, AlertSC, for MSISDN-A. In an alternate embodiment of the present invention, SG 110 directly sends AlertSC to SMSC-O 801. At step 924, HLR-H 112 receives the acknowledgment from SMSC-O 801, indicating that SMSC-O 801 has been successfully altered to initiate SMS re-delivery process. Finally, at step 926, SMSC-O 801 will initiate normal SMS delivery to subscriber 108. Since, SMSC-O 801 retrieved the address of SG 110 as the subscriber's VMSC address, SMSC-O 801 will once again redirect messages to SG 110, which further redirects to F's handset as described in FIGS. 8A and 8B. In an embodiment of the present invention, SMS during redelivery process, is delivered to a different forward-to address based on network operator's preferences.

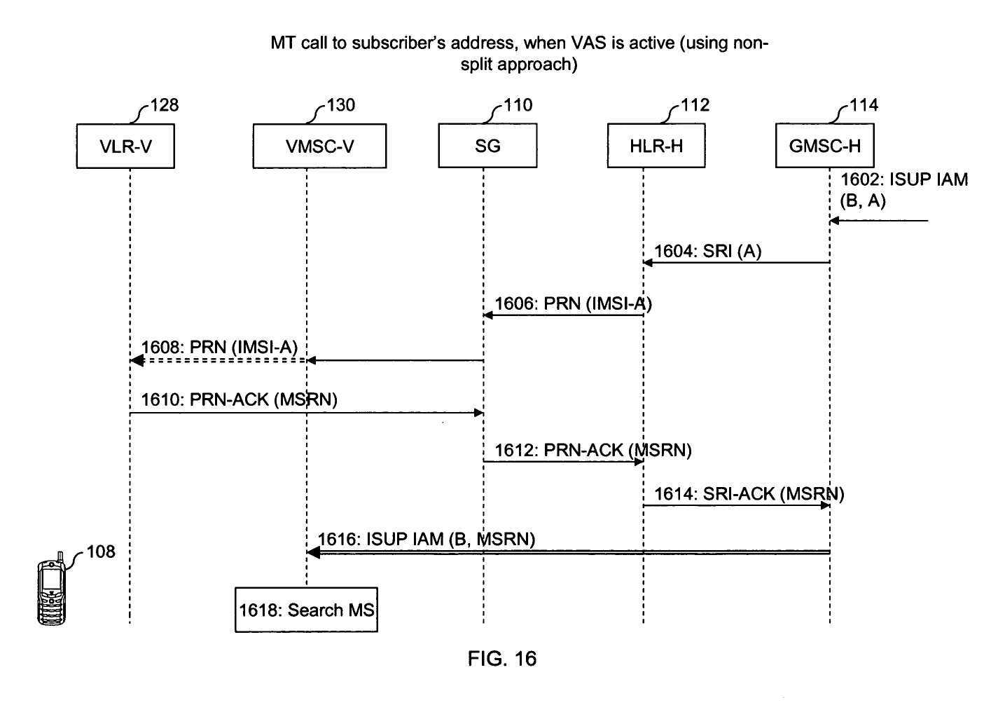

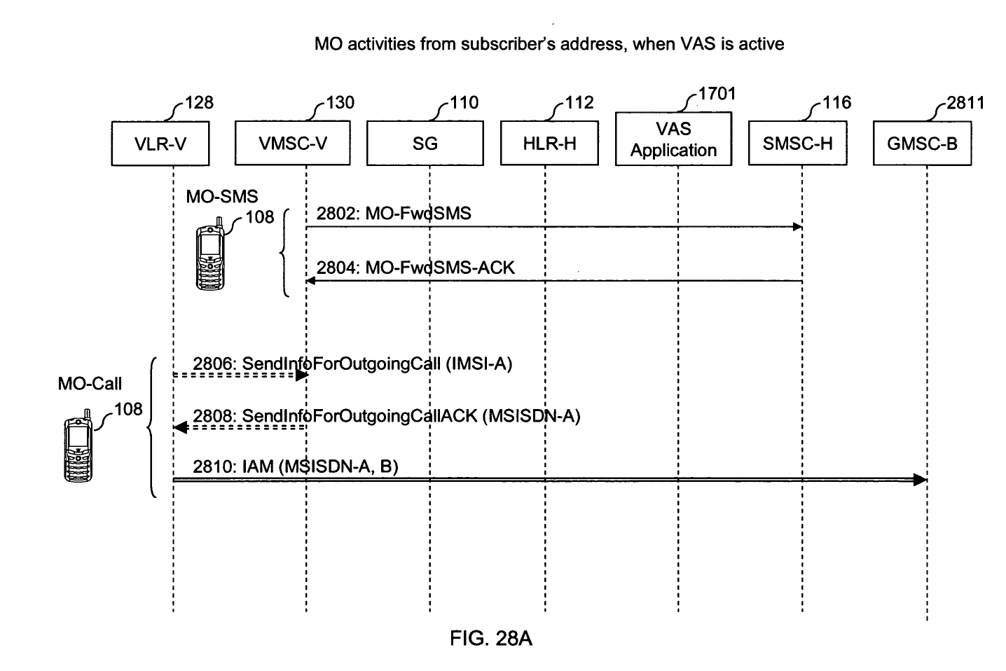

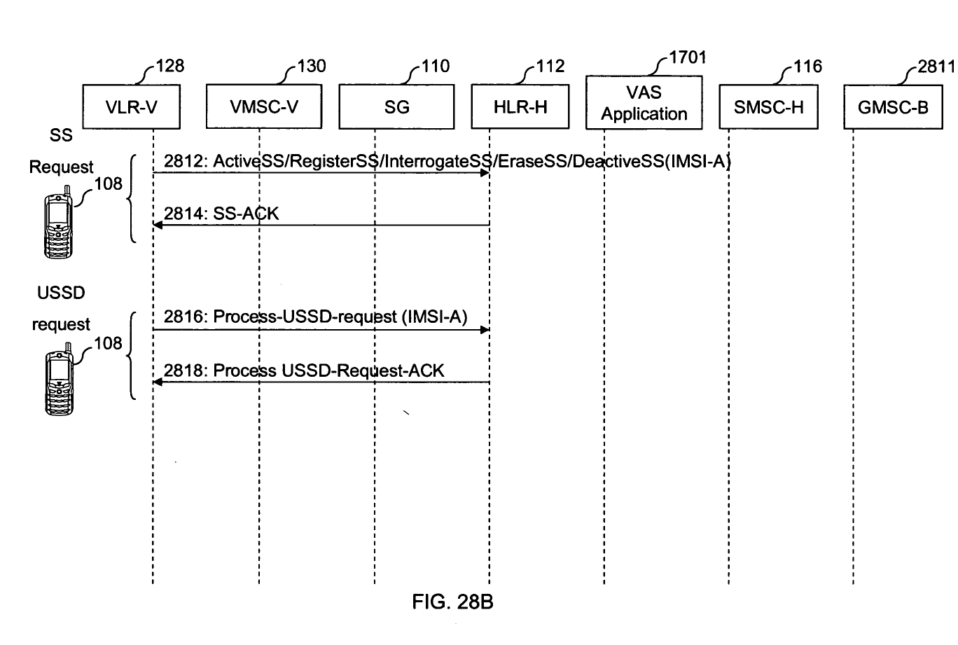

As mentioned earlier, and in accordance with various embodiments of the invention, subscriber 108 is able to carry out normal mobile communication while one or more VAS are active at MSISDN-A. Further, subscriber 108 can receive various MT activities, such as, but not limited to, MT call, MT SMS, MT USSD request, MT USSD Notify, MT PSL request, MT Anytime Interrogation (ATI)/Anytime Subscriber Information (ATSI)/Anytime Subscriber Modification (ATSM), RESET services, ForwardCheckSS services, MT ISD and MT Delete Subscriber Data (DSD) while being subscribed to one or more VAS. In various other embodiments of the present invention, subscriber 108 may subscribe to barring of blacklisted senders as a VAS, while he manages to receive MT call from senders that are not in subscriber's blacklist, on his handset. Barring of messages received from blacklisted senders, based on subscriber's blacklist of senders, is described in conjunction with FIG. 12. Further, subscriber 108 is also able to receive a call on his handset while one or more VAS are active for him. This embodiment is described in conjunction with FIG. 16. In another embodiment of the present invention, subscriber 108 can make various MO activities, such as, but not limited to, MO calls, MO SMS, MO USSD request, MO ActiveSS, MO RegisterSS, MO InterrogateSS, MO EraseSS and MO DeactiveSS while being subscribed to one or more VAS. This embodiment is described later in conjunction with FIGS. 28A and 28B.

Subscriber 108 can also receive the SMS at his our own address, i.e., subscriber's address. FIG. 10 represents a flow diagram for MT SMS delivery to the subscriber's address, in accordance with an embodiment of the present invention. This embodiment exemplifies an instance when subscriber 108 is able to receive an SMS at his number while one or more VAS are active for him. The flow for sending MT SMS to subscriber's handset is same for both, split approach and non-split approach. At step 1002, SMSC-O 801 which receives the MT SMS for the subscriber 108, sends a routing information query for short messages, such as SRI-SM, to HLR-H 112 for retrieving routing information for sending the SMS to MSISDN-A. Thereafter, at step 1004, HLR-H 112 replies to SMSC-O 801 with routing information of IMSI-A and address of SG 110. In case of non-split approach, SG 110 has presented itself as real VMSC and real VLR during the registration of VAS thus HLR-H 112 sends the address of SG 110 in place of real VMSC address and real VLR address. However, in case of split approach, HLR-H 112 sends address of SG 110 in place of real VMSC address, as during the registration of VAS, SG 110 faked only the real VMSC address.

Thereafter, at step 1006, SMSC-O 801 redirects the SMS for IMSI-A to SG 110. At step 1008, SG 110 applies the VAS logic to redirect messages to subscriber's handset. In one embodiment of the present invention, VAS logic is applied for multiple VAS based on subscriber's preferences. In second embodiment of the present invention, VAS logic is applied for multiple VAS based on operator's preferences. In third embodiment of the present invention, VAS logic determines whether subscriber 108 is a VIP subscriber. If subscriber 108 is determined to be a VIP subscriber, subscriber 108 is not charged for the VAS. In fourth embodiment of the present invention, VAS logic determines if sender, sending the MT SMS, is in whitelist of subscriber 108, if so, the SMS is sent to subscriber's handset. SG 110 applies VAS logic to perform various VAS such as, but not limited to, SMS forwarding, call forwarding, spam filtering, SMS advertising, SMS logging, barring blacklisted sender's messages and sending SMS copy to an email address.

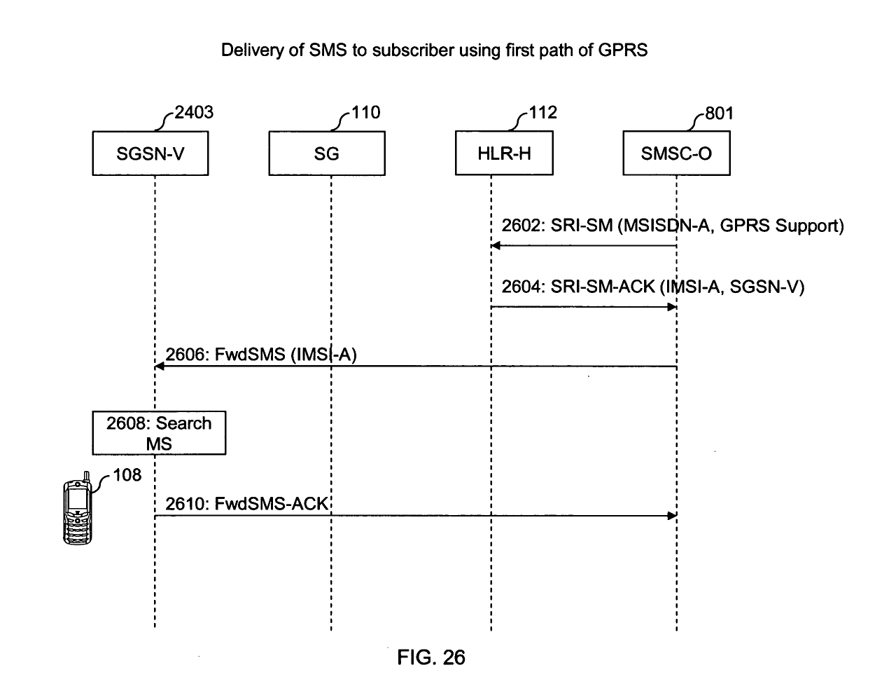

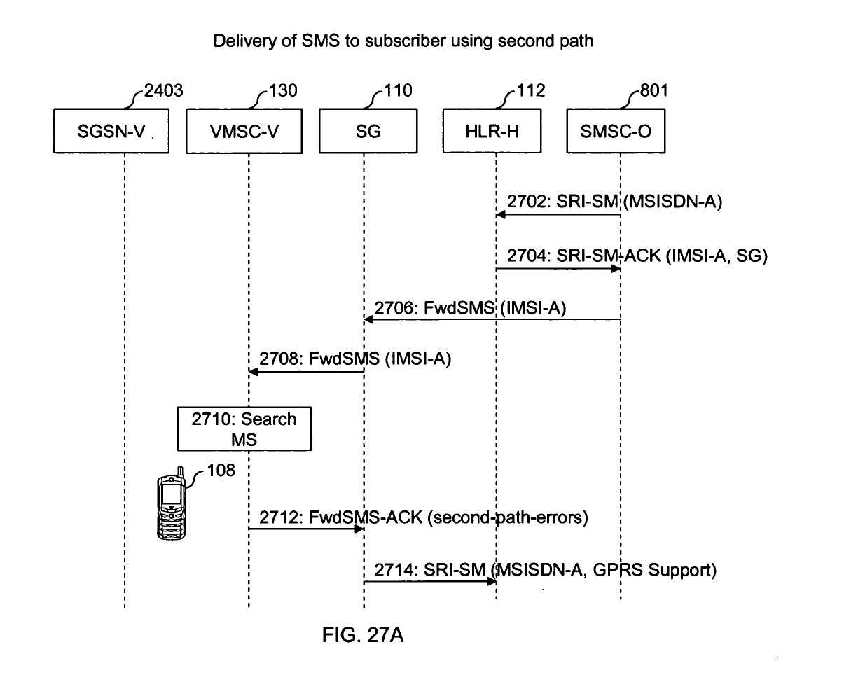

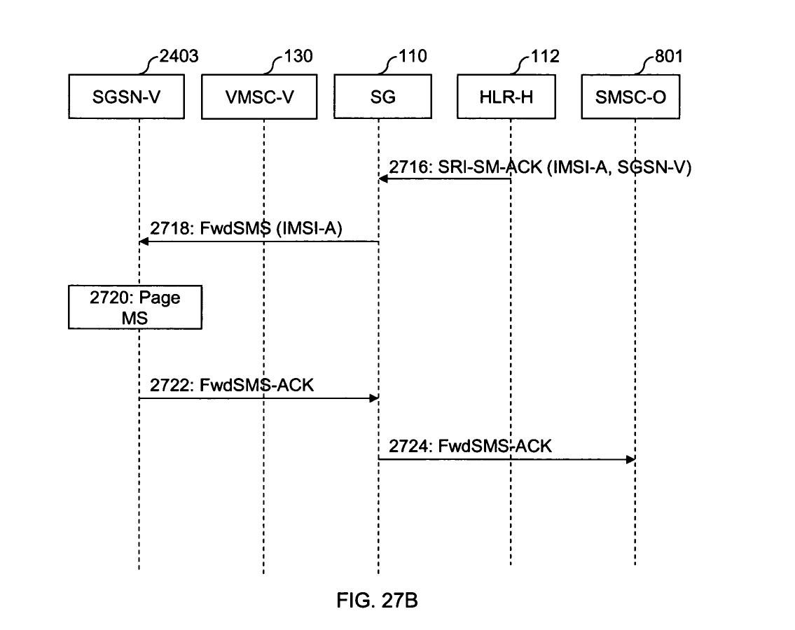

Further, at step 1010, SG 110 relays the SMS on IMSI-A to VMSC-V 130 with a signaling message, such as, SCCP CdPA SSN set to 8, which signifies called party as VMSC-V 130 itself. At step 1012, VMSC-V 130 may use SearchMS message to locate the subscriber's handset. At step 1014, VMSC-V 130 sends the acknowledgement to SG 110, indicating that subscriber 108 has received the SMS. Finally, at step 1016, SG 110 relays the acknowledgement of SMS delivery to SMSC-O 801. In an embodiment of the present invention, SMSC-O 801 directly sends the MT SMS to SGSN-V using GPRS, however, delivery of MT SMS through GPRS does not involve SG 110. MT SMS delivery at subscriber's address via GPRS, is described in conjunction with FIG. 26 and FIGS. 27A and 27B.

There may be a case, when the SMS is not delivered to subscriber's handset due to one or more failure reasons, such as, but not limited to, absent subscriber, system failure, unexpected data value and missing data. FIG. 11 represents a flow diagram of re-trying MT SMS delivery to the subscriber's address, upon detecting failure in the previous attempt. In case of failure, the acknowledgement received from VMSC-V 130 indicates that a failure occurred and SMS is not delivered to subscriber 108. The method for re-trying MT SMS delivery to subscriber's handset is same for both, split approach and non-split approach. SMS redelivery occurs when SMS delivery failure reason is due to absent subscriber. SMS failure due to absent subscriber might occur when subscriber's handset powers OFF or SMS memory capacity exceeded the maximum limit. At step 1102, SMSC-O 801 reports SMS delivery status to HLR-H 112 by sending a ReportSMSDelivery message on MSISDN-A. Thereafter, HLR-H 112, at step 1104, stores the delivery report in its records and acknowledges the receipt of the report to SMSC-O 801 using Report-ACK message.

Now, when subscriber's handset is powered ON or SMS memory is available to receive messages, VLR-V 128, at step 1106, sends an indication, such as, ReadyForSMS, to HLR-H 112 on IMSI-A that subscriber's handset is ready to receive messages. VLR-V 128 sends ReadyForSMS message with SCCP CdPA set to E214 address of IMSI-A. The reason for sending ReadyForSMS message with SCCP CdPA set to E214 is that VLR generally interacts with HLR via signaling messages, where VLR addresses HLR via E214 addressing to interact with HLR in mobile communication. At step 1108, HLR-H 112 sends the acknowledgement message to VLR-V 128, indicating that HLR-H 112 has successfully received the ready alert message from VLR-V 128. Thereafter, at step 1110, HLR-H 112 alerts SMSC-O 801 with an alert message, such as, AlertSC, on MSISDN-A for redelivery of the SMS that failed in the previous attempt. At step 1112, SMSC-O 801 acknowledges the receipt of the AlertSC message. Finally, at step 1114, SMSC-O 801 initiates redelivery of MT SMS on MSISDN-A, as described in conjunction with FIG. 10. In an embodiment of the present invention, instead of VMSC-V 130, SGSN-V sends the ReadyForSMS message to HLR-H 112 for redelivery of SMS using GPRS, however, redelivery of SMS using GPRS services does not involve SG 110.

FIG. 12 represents a flow diagram for applying spam control, as a VAS, for barring blacklisted senders, in accordance with a first embodiment of the present invention. SG 110 can apply VAS logic on MT SMS at subscriber's address. Some of the messages that subscriber 108 receives can be spam messages and may be received from an unknown source or blacklisted senders. Subscriber 108 may wish to block these messages by defining a blacklist or whitelist of senders. In one embodiment of the present invention, when the sender, sending message to subscriber 108 is determined to be in whitelist of subscriber 108, normal MT SMS delivery will follow as described earlier.

However, when the sender is determined to be in subscriber's blacklist, messages maybe applied with some post application logic so that subscriber 108 does not receive such spam or unwanted messages on his handset. Subscriber 108 opts for spam control as a VAS on these blacklisted senders. For barring blacklisted senders, subscriber 108 can define a list of senders that he wants to be added to his blacklist. Thus, when one of these blacklisted senders attempts to send the messages to subscriber 108, the message is redirected to SG 110. The VAS logic, at SG 110, determines sender to be a blacklisted sender and message is not sent to subscriber 108. As an exemplary case, a sender B sends MT SMS to subscriber 108 (i.e. subscriber A). MT SMS sent by sender B, destined for subscriber A, first arrives at SMSC-O 801. The flow for applying VAS logic for barring blacklisted senders as a VAS is same for both, split approach and non-split approach. At step 1202, SMSC-O 801 sends a routing information query for short messages, such as SRI-SM, to HLR-H 112 for retrieving routing information required to send MT SMS to MSISDN-A.

Thereafter, at step 1204, HLR-H 112 acknowledges SMSC-O 801 with routing information for IMSI-A and the address of SG 110 as subscriber's current VMSC address. Since, SMSC-O 801 has the destination address as the address of SG 110, at step 1206, SMSC-O 801 redirects the SMS to SG 110 for IMSI-A. Thereafter, at step 1208, SG 110 checks whether sender B is a blacklisted sender or whitelisted sender from the list that includes whitelist and blacklist of subscriber 108, maintained at SG's database. If SG 110 determines sender B to be blacklisted sender, then it applies various post application logic on the SMS and subscriber 108 does not receive such unwanted or spam messages on his handset. In an embodiment of the present invention, undelivered messages, such as, undelivered MT SMS from sender B to subscriber A, are processed through a post application logic. Post application logic sends undelivered messages to various subscribers' defined address, such as, but not limited to, an email address or simply logs the undelivered messages for viewing them offline via web interaction. Post application logic can also send undelivered messages based on operator's conditions or configuration.

Further, although failure reasons like system failure, unexpected data value and missing data parameter will not cause SMSC-O 801 to re-deliver SMS to subscriber 108, SMSC-O 801 might still try re-delivery of SMS on detecting such failure reasons, which will eventually lead to wastage of resources as re-delivery is not required in this case. Thus, success acknowledgement is usually sent to SMSC-O 801 in blacklist case so that SMSC-O 801 does not try re-delivery of SMS in order to save resources and unwanted signaling overhead. Further, at step 1210, SG 110 sends an acknowledgement, such as, FwdSMS-ACK, to SMSC-O 801 indicating successful delivery of SMS to subscriber A, although the SMS is not actually sent to subscriber A. The fake delivery of SMS sent to SMSC-O 801, is further relayed to sender B's handset. Moreover, as sender B is intimated with successful delivery of SMS to subscriber A, even though the SMS is not delivered to subscriber A, sender B may send the messages again in future to subscriber A, assuming that subscriber A is receiving the messages. Subscriber A is benefited as he won't receive any spam messages from spam sender B. Eventually, sender's network operator is also benefited from these services, as spammers or barred/blacklisted subscribers might send the messages again, leading to increase in revenue for network operators. In an embodiment of the present invention, SG 110 responds with a failure acknowledgement to SMSC-O 801 based on operator's configuration.

In an embodiment of the present invention, SG 110 sends a failure acknowledgement to SMSC-O 801 with various reasons, such as, but not limited to, absent subscriber or memory capacity exceeded to maximum limit. Failure reasons like unknown subscriber or illegal subscriber are not sent to SMSC-O 801 as these reasons might cause SMSC-O 801 not to send in future, any messages to subscriber A. Therefore, sender B is charged for the SMS that he sent to subscriber A.

FIGS. 13A, 13B and 13C represents a flow diagram for applying a two-way confirmation based spam control for barring senders, upon the sender being confirmed to be blacklisted by the subscriber, in accordance with a second embodiment of the present invention. A two-way confirmation SMS for avoiding spam messages to be sent to subscriber 108 is presented in this embodiment. When sender B is confirmed to be neither in blacklist nor in whitelist of subscriber A, VAS logic is performed at SG 110 to determine whether the sender B is to be included in whitelist or blacklist of subscriber A. This embodiment provides a facility to subscriber A for building up his whitelist in the network and control spam messages from reaching his handset. It involves one time confirmation from sender B and one time confirmation from subscriber A. The call flow for barring senders is same for split approach and non-split approach upon a sender being confirmed to be a spammer/blacklisted, using two-way confirmation based spam control. SG 110 sends the SMS to sender B to confirm the delivery of messages to subscriber's handset. Whenever an MT SMS arrives from sender B, destined for subscriber A, it first reaches SMSC-O 801.

At step 1302, SMSC-O 801 sends a routing information query for short messages, such as SRI-SM, to HLR-H 112 for retrieving routing information required to send the SMS from sender B to MSISDN-A. Thereafter, at step 1304, HLR-H 112 replies to SMSC-O 801 with routing information such as, IMSI-A and address of SG 110. Since, SMSC-O 801 has the information that the destination address is the address of SG 110, at step 1306, SMSC-O 801 redirects the SMS to SG 110 for IMSI-A. Thereafter, at step 1308, SG 110 applies the VAS logic to check whether sender B is a blacklisted sender or a whitelisted sender. If Sender B is neither found in whitelist nor in blacklist of subscriber A, SG 110 first sets at its own end, a delivery status of the SMS as system failure, unexpected data value and missing data. This delivery status is stored at SG 110's database as a delivery outcome. Delivery outcome is, hereinafter, referred to as a delivery status. At step 1310, SG 110 sends to SMSC-O 801 a failure acknowledgement message, such as FwdSMS-ACk, indicating absent subscriber or handset memory capacity exceeded above maximum limit. SMSC-O 801 can further send the SMS delivery report at step 1312 to HLR-H 112, indicating that the failure occurred while sending message to subscriber A. HLR-H 112 can store the delivery report for future re-delivery of SMS. Since, sender B is not found in whitelist or blacklist of A, SG 110 at step 1314, sends the SMS to SMSC-O 801 to confirm from sender B for sending the SMS to subscriber A. SMSC-O 801 then relays the request for confirmation SMS to sender B's handset, at step 1316. In an embodiment of the present invention, SG 110 sends the request for confirmation SMS directly via SS7 to sender B's handset.

In still another embodiment of the present invention, sender B may not reply to the confirmation request, sent to sender B at step 1316. In such a case sender B's SMS has to be delivered somewhere. Thus, SG 110 will fake the availability of subscriber A at HLR-H 112 using ReadyForSMS. HLR-H 112 can then alert SMSC-O 801 using AlertSC to cause redelivery of sender B's SMS to subscriber A. SMSC-O 810 can then redirect the SMS to SG 110, which then applies one or more post application logic on the SMS to deliver the SMS at a different address other than subscriber A's address. Further, the delivery status of SMS from sender B to subscriber A is still set to failure with reasons like system failure, unexpected data value and missing data, at SG 110, so that SG 110 does notcause re-delivery of SMS. SG 110 may send the undelivered SMS to an email address as one of the post application logic. Otherwise, SG 110 may maintain a log of the undelivered message for later viewing of the message offline via web interaction.

Sender B confirms to SMSC-O 801 his intent for sending the SMS to subscriber A in response to the first confirmation message, at step 1318. SMSC-O 801 relays the sender B's confirmation to SG 110, at step 1320, as an acknowledgement to the submit request. Now, SG 110 attempts to confirm from subscriber A that whether he wishes to receive the SMS from sender B. Hence, SG 110 sends a second confirmation message to VMSC-V 130, at step 1322. The second confirmation message is sent to subscriber A to confirm whether to accept sender B in whitelist or add sender in blacklist of subscriber A. At step 1324, VMSC-V 130 may use SearchMS to locate subscriber A's handset.

In first embodiment of the invention, subscriber A may accept sender B in its whitelist and hence, at step 1326, VMSC-V 130 responds to SG 110 with an accept message for accepting sender B in subscriber A's whitelist. Thereafter, SG 110 adds sender B in whitelist of subscriber A. In one embodiment of the present invention, SG 110 maintains the whitelist of subscriber A in the database associated with SG 110. As the delivery status of the SMS has been set to failure like system failure, unexpected data value and missing data, SG 110 cannot deliver sender's SMS directly to subscriber A. Thus, at step 1328, SG 110 fakes the availability for IMSI-A to HLR-H 112 by sending ReadyForSMS message to HLR-H 112. At step 1330, HLR-H 112 sends acknowledgement back to SG 110. As HLR-H 112 has the information that delivery failure occurred due to absent subscriber or handset memory capacity exceeded above maximum limit, it will then send AlertSC for MSISDN-A to SMSC-O 801, at step 1332. SMSC-O 801 sends the acknowledgement to HLR-H 112, at step 1334. Thereafter, at step 1336, as SMSC-O 801 has the information that subscriber A is an absent subscriber, SMSC-O 801 can once again initiate redelivery of SMS for MSISDN-A, sent by sender B.

In second embodiment of the present invention, subscriber A confirms to SG 110 that sender B is a blacklisted sender. SG 110 then adds sender B in blacklist of subscriber A and drops the SMS for applying the post application logics, as described above.

In third embodiment of the present invention, SMS may not be delivered to subscriber A due to no response to the second confirmation message sent to subscriber A. In such a case, the delivery status at SG 110 for SMS delivery from sender B to subscriber A is set to as failed with reasons like absent subscriber or handset memory capacity exceeded above maximum limit. At step 1338, SG 110 sends the delivery status, i.e. failure with reasons like absent subscriber, to HLR-H 112 in a DeliveryReport message. Later, at step 1340, when subscriber A is ready to receive messages, VLR-V 128 can send ReadyForSMS message to HLR-H 112. HLR-H 112, at step 1342, will send back the acknowledgement to VLR-V 128. Thereafter, at step 1344, setting up of failure reasons like absent subscriber or handset memory capacity exceeded above maximum limit will further cause SG 110 to receive AlertSC message from HLR-H 112 for redelivery of the second confirmation message. SG 110 sends the acknowledgement for received alert message to HLR-H 112, at step 1346. Hence, SG 110 will once again attempt to confirm from subscriber A for sender B, by sending the second confirmation message to subscriber A. However, if subscriber A still does not reply to the second confirmation message, this loop of sending the second confirmation message will continue for a pre-defined number of attempts. In one embodiment of the present invention, the operator may configure the pre-defined number of attempts.

In another embodiment of the present invention, if the subscriber A does not respond to the second confirmation message either until a configurable time period or until the pre-defined number of attempts, SG 110 then sets the delivery status as failure with reasons like system failure and it does not inform HLR-H 112 for future redelivery. Further, steps 1328 to 1336 will be performed in order to attempt redelivery of sender B's SMS to subscriber A. Further, at step 1348, SMSC-O 801 forwards the SMS for IMSI-A to SG 110. SG 110 will then set the delivery status for the sender B's SMS to subscriber A as failure with reasons like 'system failure'. Finally, at step 1350, SG 110 sends this failure status back to SMSC-O 801 in FwdSMS-Ack message.

Like SMS forwarding, subscriber 108 (subscriber A) may also like to forward MMS to one or more forward-to addresses, while being subscribed to SMS forwarding services. FIGS. 14A and 14B represents a flow diagram of MMS delivery to the forward-to address of the subscriber, while subscriber is subscribed to SMS forwarding, in accordance with an embodiment of the present invention. MMS delivery is usually performed using Wireless Application Protocol (WAP) over SMS push notification and confirmation. Further, a data pull is performed for retrieval of MMS content.

Generally, a WAP Push Proxy Gateway (PPG) allows WAP push messages to be sent from an application, such as WAP application, to subscriber's handset that has an MMS client. WAP push messages, such as bookmarks, MMS notifications and notifications for mobiles to retrieve specific content, are usually sent via SMS to subscriber's handset. In one instance, news headlines are sent via WAP Push that allows subscriber 108 to immediately download the news content. In another instance, a link is sent to the subscriber's handset to allow subscriber 108 to download a logo or ring tone that he might have purchased.

In one embodiment of the present invention, when the MMS is sent to subscriber's address, MMS notification to subscriber A is also forwarded to F, since SMS forwarding is active for subscriber A. However, when F is trying to retrieve the MMS content intended for subscriber A, F's handset will not be able to do so from an MMSC-F 1401 associated with F. Thus, a solution is required that allows subscriber A to successfully forward the MMS to F, while SMS forwarding is active for subscriber A.

At step 1402, when sender B sends the MMS message to subscriber A, an MMSC-H 132, associated with subscriber A, notifies an indication for the MMS message by sending an MMS-notification for subscriber A to a WAP/PPG 134. Further, at step 1404, WAP/PPG 134 relays the MMS-notification to SMSC-H 116. Thereafter, at step 1406, SMSC-H 116 sends the routing information query for short messages, such as SRI-SM, for MSISDN-A to HLR-H 112. HLR-H 112 then acknowledges SMSC-H 116 with the routing information of IMSI-A and SG 110, at step 1408. Since, the address of SG 110 is sent to SMSC-H 116 as the VMSC address of subscriber A, at step 1410, SMSC-H 116 redirects the SMS for IMSI-A to SG 110. SG 110 will then query its database to find out any active SMS forwarding services. Further, SG 110 will determine the SMS received for subscriber A to be the MMS notification message, such as MMS-Notify that includes, information of sending party (i.e. sender B), receiving party (i.e. subscriber A) and MMS-reference (i.e. MMS-URL). SG 110 sends a forwarding request to MMSC-H 132 using an MM1 interface.

In an embodiment of the present invention, SG 110 stores MMSC-H 132 in its database, as described earlier. Thus, at step 1412, SG 110 sends the forwarding request that includes information of forwarding party (i.e. subscriber A), receiving party (i.e. F) and MMS-reference (i.e. MMS-URL), to MMSC-H 132. Thereafter, at step 1414, SG 110 receives the acknowledgement from MMSC-H 132 with a “success” message indicating that MMSC-H 132 supports MMS message forwarding capability. In another embodiment of the present invention, where MMSC-H 132 does not support forwarding of MMS message to the forward-to handset is described in conjunction with FIGS. 15A and 15B.

As SG 110 does not have the routing information of F, SG 110, at step 1416, sends the routing information query for short messages, such as SRI-SM, for obtaining the routing information of F, to HLR-F 803. HLR-F 803 then acknowledges SG 110 with the routing information of IMSI-F and VMSC-F 805, at step 1418. Since, VMSC-F 805 is sent to SG 110 as the VMSC address of F, at step 1420, SG 110 redirects the SMS to notify IMSI-F for MMS notification, to VMSC-F 805. Further, SG 110 at step 1422 receives the acknowledgement from VMSC-F 805 for successful delivery of SMS. Thereafter, at step 1424, SG 110 relays the acknowledgement for successful delivery of SMS, to SMSC-H 116.

Further, at step 1426, SMSC-H 116 sends the acknowledgement to WAP/PPG 134, to indicate successful notification at SMSC-H 116 for MMS notification sent to subscriber A. WAP/PPG 134, at step 1428, relays the acknowledgement of the MMS notification sent to subscriber A, to MMSC-H 132. If, subscriber A and F, are not served by the same operator, the message is then forwarded over an MM4 interface to F's MMSC (i.e. an MMSC-F 1401) based on Simple Mail Transmission Protocol (SMTP). Thus, as MMSC-H 132 supports MMS capabilities, at step 1430, MMSC-H 132 sends the MMS message for subscriber A, to MMSC-F 1401 via interworking MMS transfer using the MM4 interface. F's handset can then retrieve the MMS from MMSC-F 1401. Further, at step 1432, MMSC-F 1401 forwards the MMS message for subscriber A to F's handset with a retrieve-MMS message.

In another embodiment of the present invention, when subscriber A and F are served by the same operator, SG 110 forwards the MMS notification message to F and F's handset can now directly retrieve the MMS message from MMSC-F 1401, which is same as MMSC-H 132. It will be apparent to a person skilled in the art that when delivery of subscriber A's MMS occurs from MMSC-H 132 to F's MMSC-F 1401, MM4 interface will not be involved.

Since, there might be a situation where MMSC-H 132 does not support capabilities for MMS message forwarding services, a solution is required to handle such situations. FIGS. 15A and 15B represents a flow diagram of MMS delivery to the forward-to address of the subscriber, when MMSC associated with the subscriber does not support MMS forwarding, while the subscriber is subscribed to SMS forwarding, in accordance with an embodiment of the present invention. MMS messages in non-split approach and split approach are forwarded to the forward-to address with a similar call flow. Thereafter, steps 1502 to 1512 are performed in a similar way as that performed in steps 1402 to 1412 in accordance with FIGS. 14A and 14B. Since, MMSC-H 132 does not support MMS forwarding, when MMSC-H 132 receives a forwarding request message from SG 110, a “failure” message is sent to SG 110, at step 1514. Thereafter, at step 1516, SG 110 sends the error acknowledgement to SMSC-H 116, indicating that MMSC-H 132 does not support MMS forwarding. SMSC-H 116 acknowledges WAP/PPG 134 with the MMS notification message that contains an error acknowledgement for subscriber A, at step 1518. WAP/PPG 134 further relays the MMS error notification acknowledgement to MMSC-H 132, at step 1520.

Since, MMSC-H 132 is unable to deliver the MMS message to F's handset, MMSC-H 132 can send an ordinary SMS with MMS-URL to subscriber A to provide a PIN for the retrieval of MMS via WAP or web. In an embodiment of the present invention, when MMSC-H 132 sends the routing information query for IMSI-A to HLR-H 112, MMSC-H 132 retrieves SG 110 as the VMSC address associated with subscriber A. Thus, at step 1522, MMSC-H 132 sends the ordinary SMS with MMS-URL to SG 110 for retrieving PIN information. Finally, at 1524, as SG 110 has the information that subscriber A has SMS forwarding active with forward-to number as F in the database, SG 110 redirects the ordinary SMS with MMS-URL on F to VMSC-F 805 and provides the PIN information to F. F then retrieves the MMS from MMSC-H 132 using the PIN provided to him.

FIG. 16 represents a flow diagram of Mobile Terminated (MT) call to the subscriber's address, while one or more VAS are active, in accordance with an embodiment of the present invention. Subscriber A can also make calls, while being subscribed to one or more VAS. FIG. 16 represents MT call to subscriber's address using non-split approach. A caller B, originates a call intended for subscriber A. Hence, at step 1602, a call request such as, ISUP IAM (B, A) from caller B reaches at a GMSC-H 114 associated with subscriber A's HPMN 102. Subscriber A may be present in VPMN 104. In another embodiment of the present invention, subscriber A may be present in HPMN 102. GMSC-H 114, at step 1604, sends a routing information query for subscriber A, such as SRI (A), to HLR-H 112 so as to retrieve the routing information for terminating the call at MSISDN-A.

As subscriber A is roaming in VPMN 104, the MT calls to subscriber A are terminated at a roaming number corresponding to subscriber A. Thus at step 1606, HLR-H 112 sends a roaming number request, such as PRN for IMSI-A to SG 110, for acquiring the roaming number corresponding to IMSI-A of subscriber A. As HLR-H 112 has the information that SG 110 is the real VMSC address and real VLR address, PRN request is sent to SG 110 assuming SG 110 to be real VLR associated with subscriber A.

However, in case of split approach, as HLR-H 112 has the information that VLR-V 128 is the real VLR, PRN request is sent directly to VLR-V 128. VLR-V 128 will then send the MSRN to HLR-H 112 as VLR-V 128 has the subscriber's profile information. The rest of the MT call flow using split approach is same as that of MT call using non-split approach.

Thereafter, SG 110 finds the VMSC address associated with subscriber A from its database. At step 1608, SG 110 further relays PRN request to VMSC-V 130 on IMSI-A, with SCCP CdPA SSN set to 7, indicating the recipient of the PRN request as VLR-V 128. Thereafter, at step 1610, VLR-V 128 responds to SG 110 with a roaming number for subscriber A, such as MSRN corresponding to VPMN 104. SG 110 on receiving the roaming number relays the obtained roaming number to HLR-H 112, at step 1612. Further, at step 1614, HLR-H 112 relays the routing information of MSRN to GMSC-H 114 for terminating the call to subscriber A. Thereafter, at step 1616, GMSC-H 114 routes the call to VMSC-V 130 by sending a call request message such as IAM (B, MSRN). Hence, the call is forwarded to MSISDN-A. Finally, at step 1618, VLR-V 128 instructs VMSC-V 130 to find the current location of subscriber's handset using Search MS, as VLR-V 128 may not have the location information of subscriber A. VMSC-V 130 sends the response of Search MS to VLR-V 128 and is stored in a database associated with VLR-V 128.

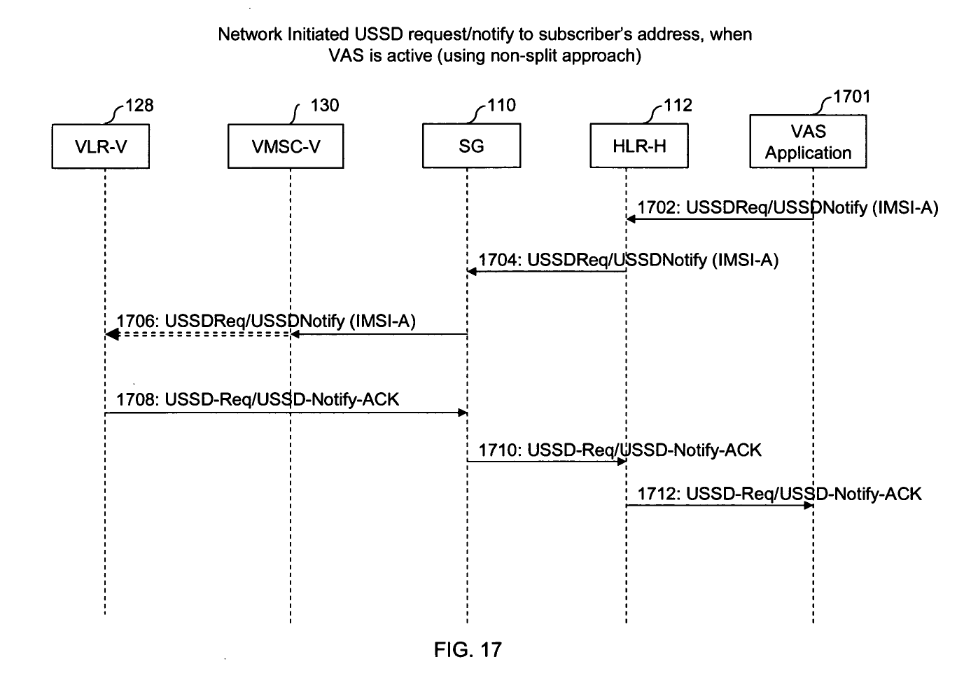

FIG. 17 represents a flow diagram of Network Initiated USSD to the subscriber's address, while one or more VAS are active, in accordance with an embodiment of the present invention. This embodiment explains the network initiated USSD request/notification using non-split approach. A VAS application 1701 can send the USSD request or USSD notify to subscriber's handset in order to request or to notify subscriber 108 with any information pertaining to some USSD services. Hence, the USSD notify or USSD request at subscriber's handset is an MT activity. For example, an USSD application (i.e. VAS application 1701) sends a notification to subscriber 108 with balance credit in his pre-paid account.

In this embodiment of the present invention, at step 1702, VAS application 1701 sends a message, such as, USSD request or USSD notify, to HLR-H 112 for IMSI-A. HLR-H 112 further relays the message to SG 110, at 1704. HLR-H 112 relays the message to SG 110, instead of VMSC-V 130, as the address of VMSC-V 130 and VLR-V 128 is replaced with the address of SG due to LUP performed at HLR-H 112. Thereafter, at step 1706, since SG 110 has VMSC-V 130 address stored in its database, SG 110 redirects the message for IMSI-A to VMSC-V 130 as an SCCP signaling message, with the called party address, i.e. CdPA SSN, set to 7. Thus, a message sent to VMSC-V 130 is relayed to VLR-V 128 as all messages received at VMSC-V 130 with CdPA=7, are sent to VLR-V 128.

If VAS application 1701 sends the network initiated USSD using split approach, SG 110 is not involved as HLR-H 112 has the information for real VLR (i.e. VLR-V 128). Thus, in split approach, when HLR-H 112 receives USSD request or USSD notify, as HLR-H 112 in this case has real VLR information, USSD request or USSD notify for IMSI-A is sent directly to VLR-V 128. Further, VLR-V 128 acknowledges HLR-H 112 directly for the receipt of USSD request or USSD notify, instead of using relay technique for acknowledging HLR-H 112 through SG 110 as in non-split approach.

Further at step 1708, VLR-V 128 acknowledges the receipt of USSD notify or USSD request message to SG 110 indicating that subscriber 108 is notified or the request task has been performed successfully based on the USSD message. Further, at step 1710, SG 110 relays the acknowledgement receipt to HLR-H 112. Finally, at step 1712, HLR-H 112 further sends the acknowledgement receipt to VAS application 1701, which confirms to VAS application 1701 that the requested task or notification, sent at step 1702, is performed successfully.

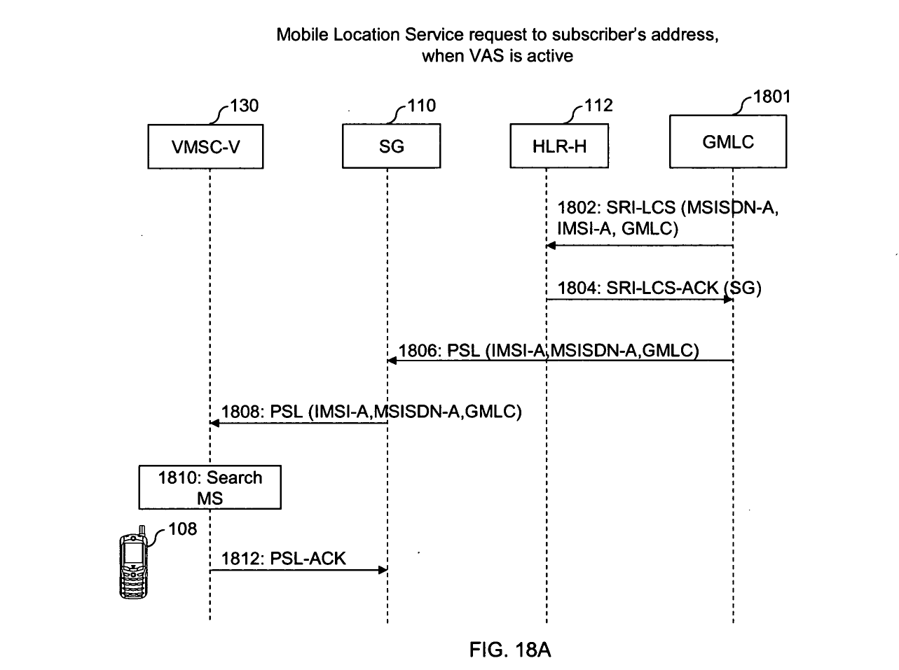

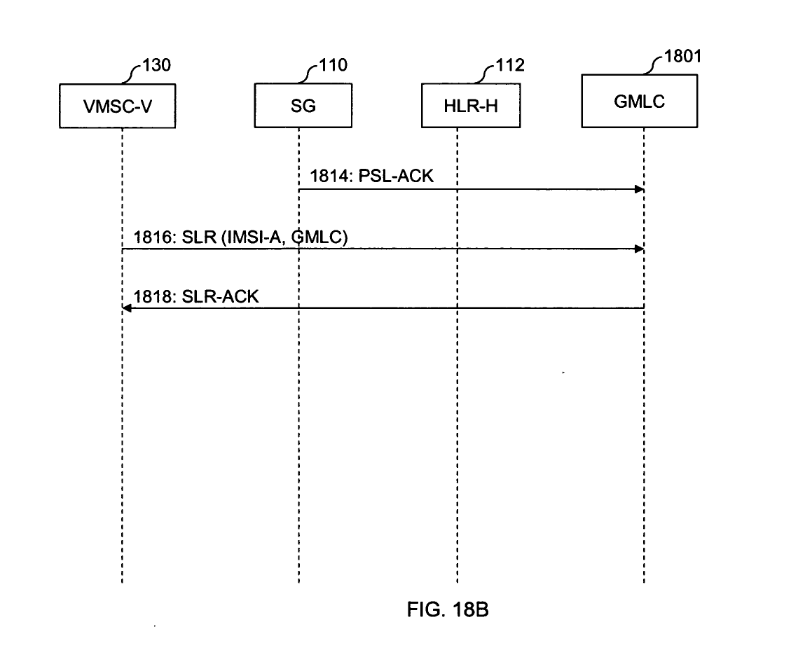

FIGS. 18A and 18B represents a flow diagram of Network Initiated Mobile Location Service to the subscriber's address, while one or more VAS are active, in accordance with a first embodiment of the present invention. The call flow for implementing network initiated mobile location services remains the same for both, non-split approach and split approach. The network initiated mobile location services can be implemented between a Gateway Mobile Location Centre (GMLC) 1801 and HLR-H 112 for retrieving routing information required for routing any location service request to the VMSC (i.e. VMSC-V 130) associated with the subscriber's registered network. It will be apparent to a person skilled in the art that GMLC 1801 is a location gateway that enables an operator to offer location based VAS. GMLC 1801 may use a Provide Subscriber Location (PSL) message for retrieving the current location of subscriber's handset, in order to provide various location based VAS.

At step 1802, GMLC 1801 sends to HLR-H 112, a routing information request for location services, such as Send Routing Information for LoCation Service (SRI-LCS) that extracts routing information corresponding to subscriber's MSISDN-A, IMSI-A and GMLC 1801. Thereafter, at step 1804, HLR-H 112 responds to GMLC 1801 with the address of SG 110 as the subscriber's location address. Since, SG 110 updated HLR-H 112 during registration attempt by subscriber 108, HLR-H 112 returns the address of SG 110, as explained in conjunction with FIGS. 3A and 3B and FIGS. 4A and 4B. Further, at step 1806, GMLC 1801 redirects the PSL request message to SG 110 for retrieving subscriber's location information corresponding to IMSI-A, MSISDN-A and GMLC 1801. Further, at step 1808, SG 110 further redirects the PSL request message to VMSC-V 130 by sending the SCCP signaling message with CdPA SSN set to 8. CdPA SSN set to 8 indicates that the called party is VMSC-V 130 and message is intended for VMSC-V 130 itself. This is done as the subscriber's location information is present with VMSC-V 130. SG 110 does not modify GMLC 1801 in the PSL message. At step 1810, VMSC-V 130 can use a SearchMS message to locate subscriber's handset. Thereafter, at step 1812, VMSC-V 130 provides SG 110 with subscriber location information in PSL-ACK message. Further SG 110, at step 1814, relays the PSL-ACK message to GMLC 1801.

In another embodiment of the present invention, when PSL request message is a Subscriber Location Report (SLR), VMSC-V 130 sends the SLR for IMSI-A and GMLC 1801 directly to GMLC 1801, at step 1816. In an embodiment of the present invention, SGSN-V sends SLR for IMSI-A directly to GMLC 1801 when GPRS services are used. GMLC 1801 on receiving SLR stores the report for performing further actions on location based VAS. Finally, at step 1818, GMLC 1801 acknowledges VMSC-V 130 with an SLR-ACK message.

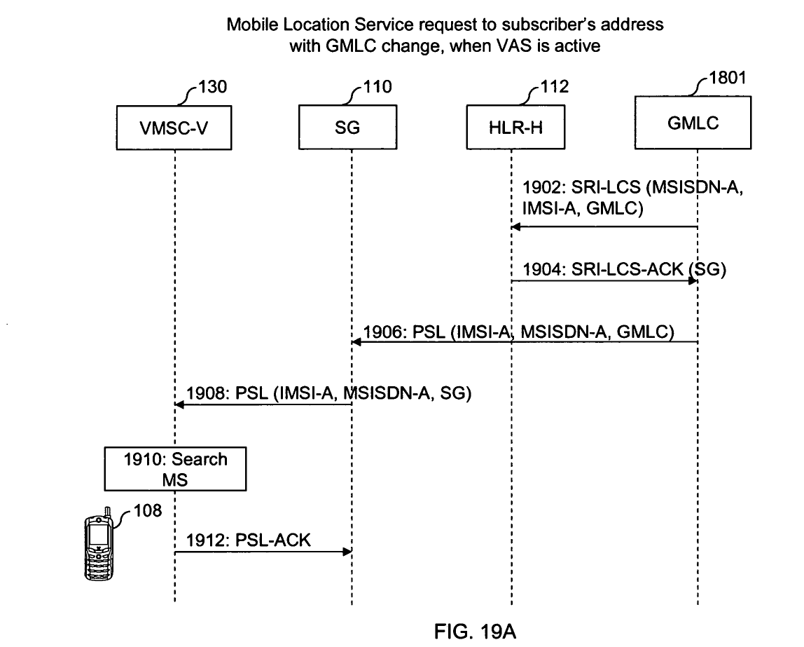

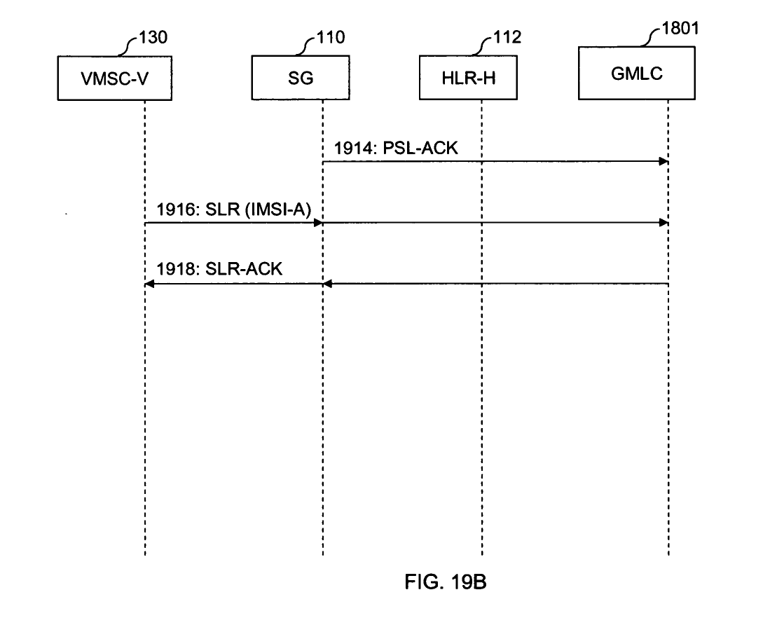

The current GSM standard does not differentiate between PSL requesting entity and MLC number corresponding to requesting entity. In other words, the current GSM standard does not support when the PSL requesting entity and its parameter i.e. the MLC number, are different. FIGS. 19A and 19B represents a flow diagram of the Network Initiated Mobile Location Service with Gateway Mobile Location Centre (GMLC) change, to the subscriber's address, while one or more VAS are active, in accordance with a second embodiment of the present invention. The call flow for implementing network initiated mobile location services with GMLC change remains the same for the non-split and split approach. VMSC-V 130 checks whether PSL requesting entity and its MLC number are same or different, in accordance with this embodiment. At step 1902, GMLC sends to HLR-H 112, a routing information request for location services, such as SRI-LCS, that extracts routing information corresponding to subscriber's MSISDN-A, IMSI-A and GMLC 1801.

Thereafter, at step 1904, HLR-H 112 responds to GMLC 1801 with the address of SG 110 as subscriber's location address. Since, SG 110 updated HLR-H 112 during registration attempt by subscriber 108, HLR-H 112 returns the address of SG 110, as explained in conjunction with FIGS. 3A and 3B and FIGS. 4A and 4B. Further, at step 1906, GMLC 1801 requests SG 110 for subscriber's location information, with a message, such as, PSL on IMSI-A, MSISDN-A and GMLC 1801. SG 110 further at step 1908, redirects the PSL message to VMSC-V 130 by sending the SCCP signaling message with CdPA SSN set to 8. CdPA SSN set to 8 indicates that called party is VMSC-V 130 itself. SG 110 obtains VMSC-V 130 address from its database. This is done as the current location of subscriber 108 is present only with the VMSC-V 130. SG 110 modifies the GMLC number and sets the MLC number to the address of SG 110. At step 1910, VMSC-V 130 uses a SearchMS message to locate subscriber's handset. Thereafter, at step 1912, VMSC-V 130 provides to SG 110 with subscriber location information in PSL-ACK message. Further SG 110 at step 1914, relays the PSL-ACK message to GMLC 1801.

At step 1916, when PSL request message is detected to be Subscriber Location Report (SLR), VMSC-V 130 sends the SLR for IMSI-A by relaying the SLR through SG 110 to GMLC 1801. GMLC 1801 on receiving SLR stores the report for performing further action on the location based VAS. Finally, at step 1918, GMLC 1801 acknowledges VMSC-V 130 with an SLR-ACK message by relaying through SG 110.

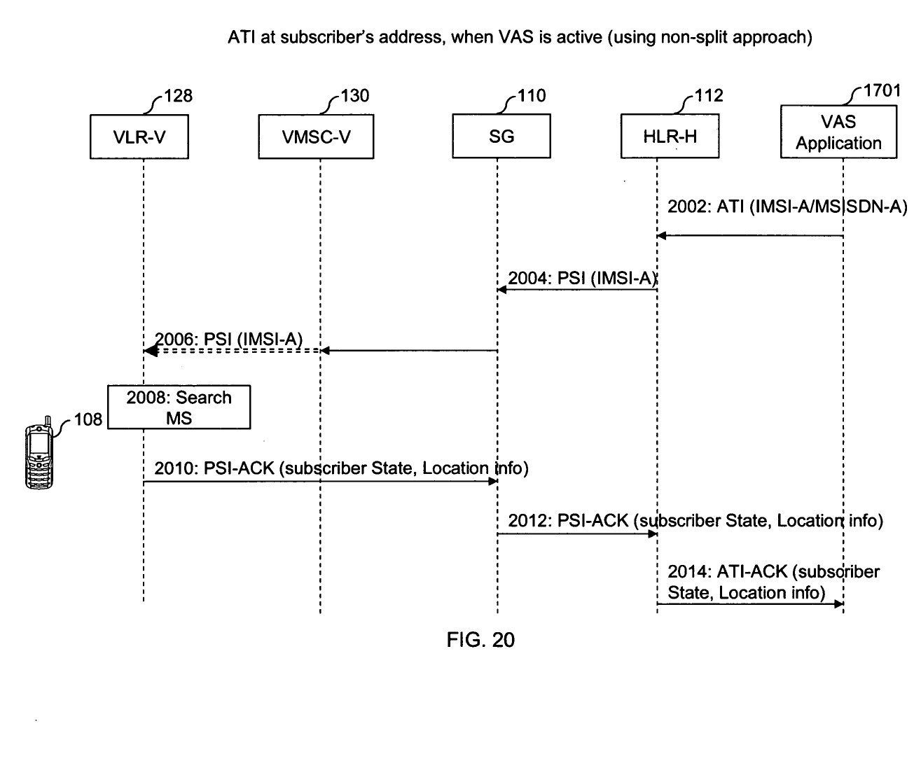

FIG. 20 represents a flow diagram of Anytime interrogation (ATI) at the subscriber's address, while one or more VAS are active, in accordance with an embodiment of the present invention. VAS application 1701 uses MAP ATI message for interrogating from HLR-H 112 for subscriber data, when subscriber 108 has one or more VAS active corresponding to VAS application 1701. This embodiment explains the flow diagram using non-split approach for sending ATI message to HLR-H 112 in order to interrogate HLR-H 112 for subscriber data. In an exemplary case, VAS application 1701 can check the status of any active VAS in HLR-H 112 by using MAP ATI message. At step 2002, VAS application 1701 sends the MAP ATI message to HLR-H 112, which includes a mobile station identifier, such as MSISDN-A or IMSI-A and preferably one or more parameters that may identify specific subscriber parameters of interest to VAS application 1701. Thereafter, at step 2004, since HLR-H 112 needs to possess subscriber's data from subscriber's real location (i.e. VLR-V 128), it sends the request to SG 110 assuming it to be subscriber's VLR for subscriber information corresponding to IMSI-A using a message, such as, Provide Subscriber Information (PSI).

Further, at step 2006, SG 110 redirects the PSI message to VMSC-V 130 with CdPA SSN set to 7 in the SSCP signaling message. SCCP CdPA SSN set to 7 indicates that called party is VLR-V 128 and even though the message is sent to VMSC-V 130, it is intended for VLR-V 128. SG 110 obtains VMSC-V 130 address from the database associated with SG 110. VLR-V 128 may instruct VMSC-V 130 to locate the subscriber's handset by issuing a SearchMS message, at step 2008, and the resultant outcome can be stored at VLR-V 128. Further, at step 2010, VLR-V 128 responds to SG 110 with the acknowledgement message, such as, PSI-ACK. Subscriber state and subscriber's location information may be included in the PSI-ACK message. Thereafter, at step 2012, SG 110 relays the PSI-ACK message to HLR-H 112. Therefore, HLR-H 112 receives subscriber's state and subscriber's location information. Finally, at step 2014, HLR-H 112 provides subscriber state and location information using ATI-ACK message to VAS application 1701 that has requested for subscriber data.

In an alternate embodiment, when split approach is used for sending ATI to HLR-H 112 for interrogating subscriber data, PSI message at step 2004 is directly sent from HLR-H 112 to VLR-V 128, as at the time of registration of one or more VAS, VLR-V 128 is not replaced with address of SG 110. Hence, HLR-H 112 still has the address of VLR-V 128 stored with it.

VAS application 1701 can access, retrieve or modify subscription information corresponding to an active VAS in subscriber's profile. For instance, VAS application 1701 retrieves subscription information from HLR-H 112 by sending a message, such as, AnytimeSubscriptionInformation (ATSI) for IMSI-A (or MSISDN-A). In another embodiment, VAS application 1701 modifies subscriber's subscription information by sending a message, such as, AnytimeSubscriptionModification (ATSM) to HLR-H 112 for IMSI-A (or MSISDN-A). Thereafter, HLR-H 112 can acknowledge with a corresponding acknowledgement to VAS application 1701. Further routing of ATSI and ATSM messages is similar to routing of for ATI message, as explained in the above embodiment.

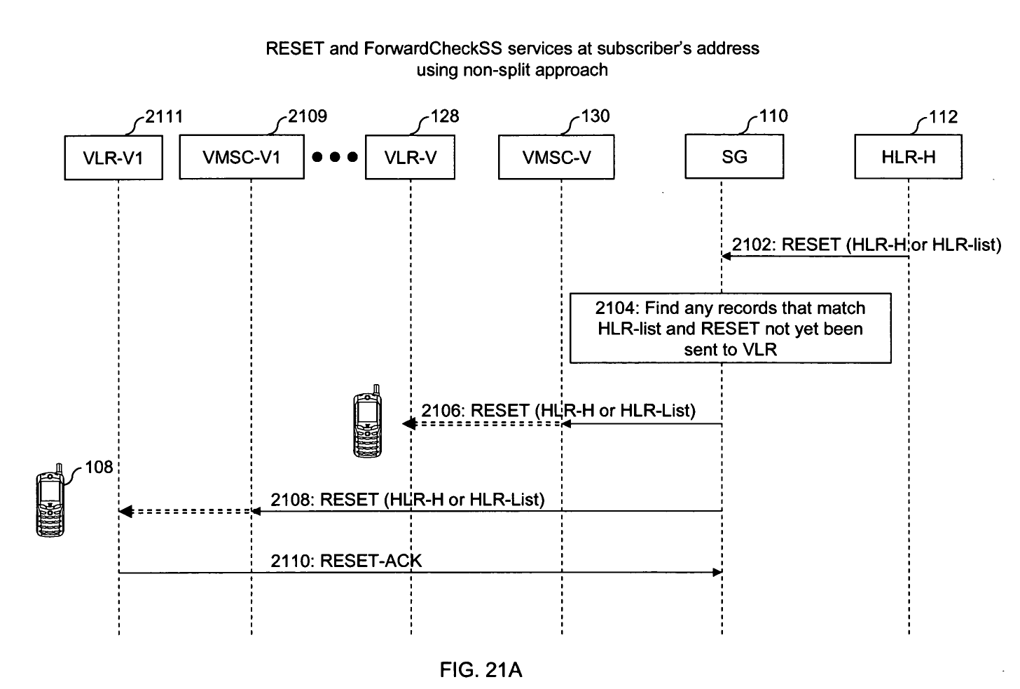

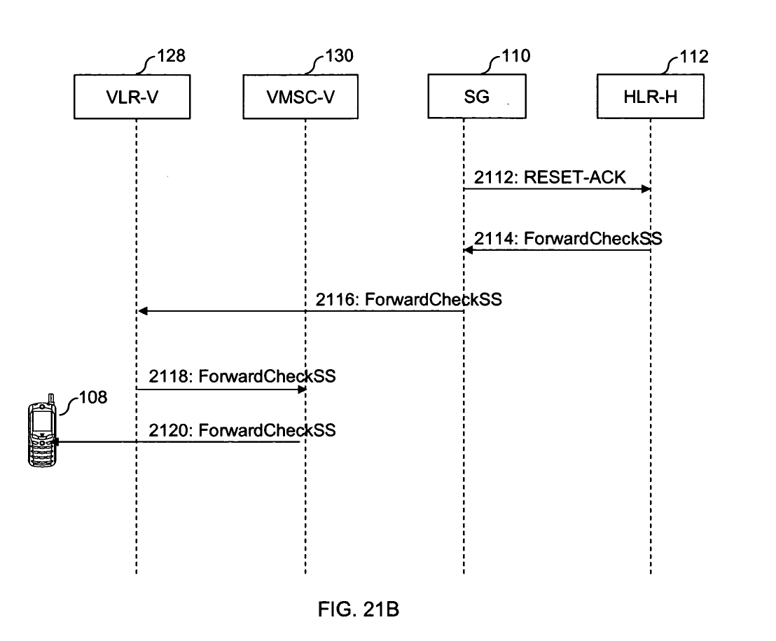

FIGS. 21A and 21B represents a flow diagram of RESET and ForwardCheckSS services at the subscriber's address, while one or more VAS are active, in accordance with an embodiment of the present invention. HLR-H 112 uses RESET services, after a restart of HLR-H 112. The MAP RESET request message includes the HLR number, which is the E.164 number of the HLR, and optionally, an HLR identity (Id) list. The HLR Id list is a list of the possible combinations of leading digits of the IMSIs that belong to the concerned HLR, including Country Code (CC), network code and the leading digits of the National Destination Code (NDC). If the HLR Id list parameter is present in the RESET message, the affected subscribers are those, whose IMSI leading digits matches the digits of either of the HLR identities in the HLR Id list parameter. However, if the HLR Id list parameter is not present in the RESET message, the affected subscribers are derived using the HLR number in the RESET message, i.e., the affected subscribers are those for which the HLR number stored in the subscriber's record in the VLR, matches the HLR number received in the RESET message. In other words, the corresponding VLR restores the subscribers for whom the OriginatingEntityNumber (i.e. HLR number) received during the LUP registration matches the equivalent parameter of the Reset Indication.

HLR-H 112 sends the RESET message, with an HLR Id or a list of HLR Ids, to a list of VLRs indicating that a failure occurred, however as SG 110 is the known VLR, all RESET messages are sent to SG 110. At step 2102, HLR-H 112 sends RESET message to SG 110, with a list of HLR Ids. At step 2104, SG 110 searches its database, for any records associated with subscriber 108 that match with the HLR Id parameters. SG 110 determines those subscribers that VLR currently serves which are associated with HLR-H 112 in RESET message. If a subscriber match is found, after SG 110 performs a check in its database, a further check is performed to confirm that RESET process has not yet been performed for the matched records.

If check determines that RESET process is not yet been performed, then at step 2106, SG 110 sends the RESET message to VMSC-V 130 with an SCCP signaling message with CdPA SSN set to 7. Hence, VLR-V 128 may appropriately restore the subscribers associated with HLR-H 112. At step 2108, SG 110 sends the RESET message to other VMSC-V1 2109 as per the information in the HLR Id list. VMSC-V1 2109 forwards the message with CdPA SSN set to 7, thus the message is relayed to a corresponding VLR-V1 2111. In an embodiment of the present invention, HLR Id is set to address of SG 110 before relaying RESET message to VMSC-V 130 with called part address as VLR-V 128. This helps SG 110 to receive the information from VLR-V 128 (and VLR-V1 2111) about all those subscribers that are restored due to HLR RESET. Thereafter, at step 2110, SG 110 receives a RESET-ACK from VLR-V 128 (and VLR-V1 2111), indicating successful restoration of IMSI associated with the subscriber. Further, at step 2112, SG 110 relays the RESET-ACK to HLR-H 112. In another embodiment of the present invention, in case of GPRS registration, HLR-H 112 sends the RESET message to a list of SGSNs to indicate that a failure occurred. In an embodiment of the present invention, the VLR sets the “Location Information Confirmed in HLRT” flag for all of the affected subscribers to “Not Confirmed”. Setting this flag may force the VLR to perform a LUP registration to update HLR-H 112 at the next time it authenticates each affected subscriber. The location updates sent from the VLR to HLR-H 112 will restore and confirm the subscriber data of the restarted HLR-H 112.

Subscriber 108 may have one or more supplementary services (SS) activated before the HLR-H 112 is RESET. Due to RESET of HLR-H 112 these SS may be modified. In such a case, HLR-H 112 may use ForwardCheckSS-indication as one implementation option, to indicate to subscriber 108 for any modification to the supplementary services active on his profile. HLR-H 112 sends ForwardCheckSS-indication message on successful retrieval of subscriber data from HLR-H 112 to VLR-V 128 during the location update procedure as explained earlier. Hence, at step 2114, HLR-H 112 sends the ForwardCheckSS-indication message to SG 110. Thereafter, at step 2116, SG 110 relays the ForwardCheckSS-indication message to VMSC-V 130 with CdPA SSN set to 7, indicating that the message is intended for VLR-V 128. Thereafter, at step 2118, VLR-V 128 relays the ForwardCheckSS-indication to VMSC-V 130. Finally, at step 2120, VMSC-V 130 forwards the received indication to subscriber 108 for any modification in the supplementary services active for subscriber 108.

In an alternate embodiment of the present invention, in case the split approach is used, HLR-H 112 directly sends the RESET request message to VMSC-V 130 (or VMSC-V1 2109), which in turn relay the RESET message to VLR-V 128 (and VLR-V1 2111), respectively. This is done since VLR-V 128 (or VLR-V1 2111) is not modified in this approach, at the time of registration of one or more VAS. Further, VLR-V 128 (or VLR-V1 2111) can directly send the RESET-ACK to HLR-H 112, instead of relaying it through SG 110 as done in non-split case. In case of the split approach, HLR-H 112 can send the ForwardCheckSS-indication directly to VLR-V 128, instead of relaying through SG 110 as in the non-split approach. In this embodiment, VLR-V 128 can send the indication back to VMSC-V 130, which can further sent the indication to subscriber A.

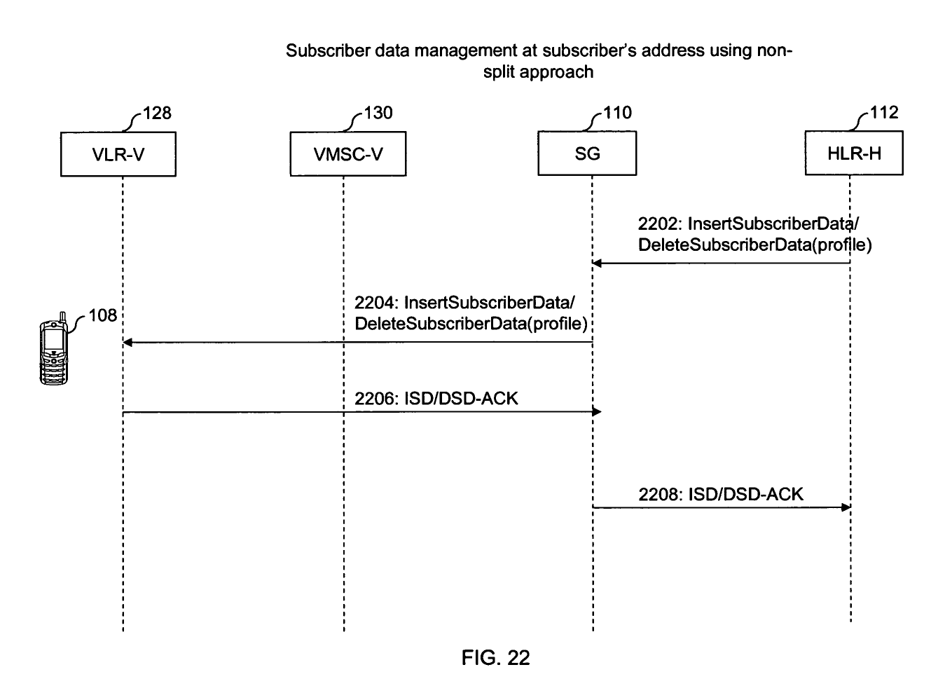

FIG. 22 represents a flow diagram of subscriber data management at the subscriber's address, while one or more VAS are active, in accordance with an embodiment of the present invention. Since, the present invention facilitates subscriber's MO and MT activities, while he is subscribed to one or more VAS, the subscriber's information and his profile can be updated, or modified, as and when required. This embodiment uses the non-split approach for subscriber data management. In one embodiment of the present invention, HLR-H 112 uses an Insert Subscriber Data (ISD) service to update or add subscriber data in the subscriber's profile stored at VLR-V 128. In another embodiment of the present invention, HLR-H 112 can use Delete Subscriber Data (DSD) service to remove certain subscriber data from the subscriber's profile at VLR-V 128. The modification of the subscriber's data can occur when one or more supplementary services or basic services are withdrawn from subscriber 108.

At step 2202, HLR-H 112 sends an ISD message or a DSD message to SG 110 for inserting subscriber data or removing subscriber data, respectively. Thereafter, at step 2204, SG 110 relays ISD message or DSD message to VMSC-V 130 by sending the SCCP signaling message with CdPA SSN set to 7. Consequently, VMSC-V 130 relays the SCCP message to VLR-V 128. At step 2206, SG 110 receives the acknowledgement message, such as ISD-ACK or DSD-ACK, from VLR-V 128, indicating successful addition of subscriber's profile at VLR-V 128, or successful removal of subscriber's profile from VLR-V 128, respectively. Finally, at step 2208, SG 110 relays the ISD-ACK or DSD-ACK to HLR-H 112 indicating successful execution of the task.

In an alternate embodiment, the split approach is used to add or remove subscriber data at VLR-V 128. In this embodiment, HLR-H 112 sends the ISD message or DSD message directly to VLR-V 128, as no change occurs at VLR-V 128 at the time of registration of one or more VAS. Further, VLR-V 128 can send the ISD-ACK or DSD-ACK directly to HLR-H 112, instead of relaying it through SG 110 as done in the non-split case.

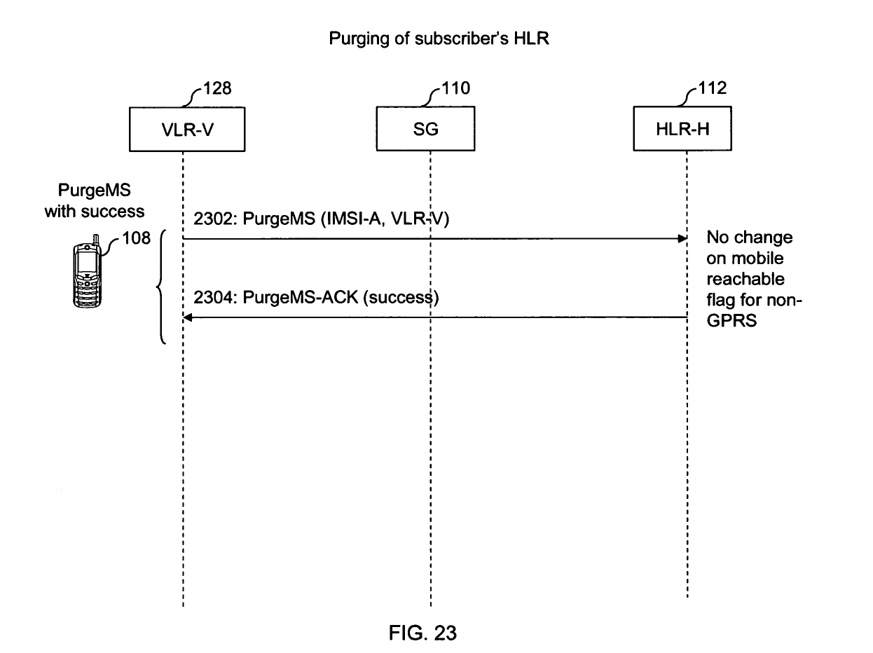

FIG. 23 represents a flow diagram of PurgeMS messages at the subscriber's HLR, while one or more VAS are active, in accordance with an embodiment of the present invention. PurgeMS service is used between VLR and HLR to cause the HLR to mark in its records a subscriber as not reachable. Therefore, the HLR accordingly treats any request for routing information request for an MT call or an MT SMS as if the subscriber is not reachable. The flow of implementing the PurgeMS service for purging HLR-H 112 is same for the non-split and split approach. PurgeMS service is invoked, when the subscriber's record is deleted from his corresponding VLR via an MMI interaction. In another embodiment of the invention, the subscriber records may be removed from the VLR automatically due to subscriber being inactive for several days.

For subscriber 108 to allow MO and MT activities, while being subscribed to one or more VAS, subscriber's profile should be active at VLR-V 128. As VLR-V 128 purges subscriber data, by sending PurgeMS message to HLR-H 112, it restricts the MT activities at the subscriber's handset. This might lead to a problem, in case PurgeMS is received from a new VLR, which is other than current registered VLR-V 128 stored in HLR-H 112's database. However, current GSM standard is able to differentiate between the new VLR and stored VLR-V (i.e. stored at HLR-H 112), and takes appropriate action for updating subscriber's profile at new VLR. In this embodiment, when HLR-H 112 receives a PurgeMS message, HLR-H 112 performs a search to check whether the PurgeMS message came from the new VLR or from the stored VLR, i.e., VLR-V 128.

At step 2302, HLR-H 112 receives the PurgeMS from VLR-V 128 with IMSI-A and corresponding VLR number. HLR-H 112 performs a search for comparing the VLRs (i.e. VLR-V 128 with stored VLR). Both the VLRs are identical, i.e., PurgeMS request came from subscriber's current registered VLR. Further, HLR-H 112 sets a message flag, such as, “MS purged for non-GPRS” for subscriber 108 and sends a “success” message to VLR-V 128, indicating a successful outcome. In other words, at step 2304, HLR-H 112 responds to VLR-V 128 with an acknowledgement, such as PurgeMS-ACK, indicating successful outcome. In second embodiment of the present invention, if the new VLR in PurgeMS message is different from stored VLR (VLR-V 128), then HLR-H 112 sends an empty MAP-PurgeMS message to the new VLR, indicating successful outcome. Since, the new VLR in the PurgeMS message is different from the currently registered VLR (VLR-V 128), it is un-appropriate to deactivate the services (basic as well as VAS) for subscriber 108, as subscriber 108 is present in VLR-V 128 (and not in new VLR). Hence, empty PurgeMS message indicates to the new VLR to delete the subscriber's profile from its database, while VLR-V 128 still maintains the subscriber's profile. This facilitates the subscriber's mobile communication and other VAS associated with subscriber 108. It will be apparent to a person skilled in the art that SGSN-V can send the purge message, instead of VLR-V 128, when using GPRS services to send PurgeMS, to HLR-H 112.

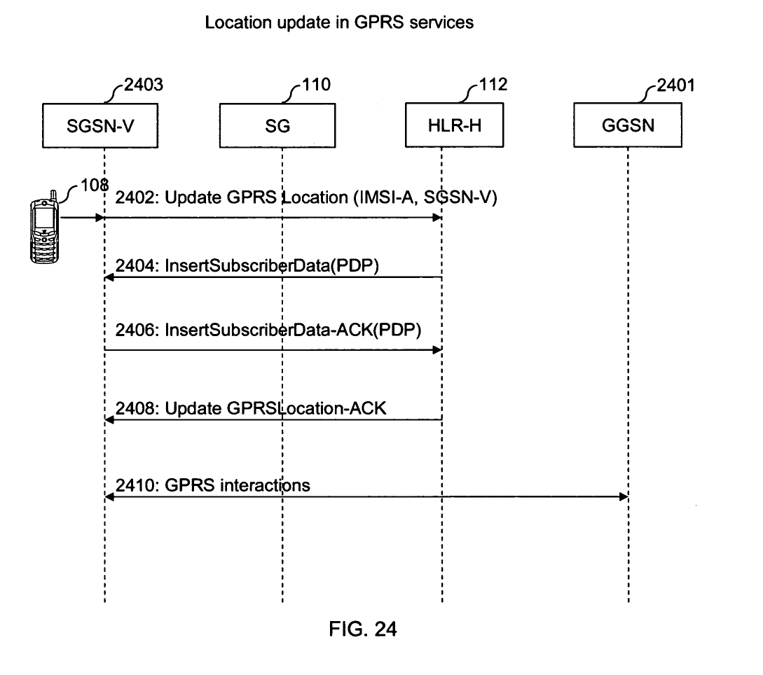

FIG. 24 represents a flow diagram of GPRS location update by subscriber's handset, upon subscriber changing the location, while one or more VAS are active, in accordance with an embodiment of the present invention. Since, in various embodiments of the location update performed by SG 110 as explained in conjunction with FIGS. 3A and 3B, FIGS. 4A and 4B, FIGS. 6A and 6B, and FIGS. 7A and 7B, does not change the GPRS location of subscriber 108, the GPRS services are not affected for subscriber 108. Further, due to this reason SG 110 is not involved in any GPRS interactions. The call flow for implementing GPRS interactions is identical for both the non-split approach and the split approach. FIG. 24 describes how a GGSN 2401 is updated with subscriber's profile when a location update is received by a SGSN 2403 associated with subscriber 108. SGSN 2403 is present in subscriber's current location which is VPMN 104, hence SGSN 2403 is hereinafter, referred to as SGSN-V 2403. It will be apparent to a person skilled in the art that SGSN-V 2403 is replaced with a SGSN-H, if subscriber 108 is located in HPMN 102. SGSN-V 2403 keeps track of subscriber's location and performs various security functions and access control associated with subscriber 108. Further, it is described how subscriber 108 interacts with GGSN 2401 for using various GPRS services, while being subscribed to one or more VAS. In one instance, subscriber 108 sends a PDP context activation request to SGSN-V 2403 to obtain an IP address corresponding to subscriber's handset. Subscriber 108 can then establish a PDP session. Subscriber 108 can use this session for using various GPRS services.

GPRS location update can be performed by SGSN-V 2403 due to various reasons, such as, but not limited to, subscriber 108 leaving his existing SGSN and trying to associate with a new SGSN, or subscriber 108 resetting the power of his handset. At step 2402, SGSN-V 2403 sends a registration message such as, Update GPRS Location, to HLR-H 112 to update HLR-H 112 with IMSI-A and SGSN-V 2403. Thereafter, at step 2404, HLR-H 112 issues InsertSubscriberData (ISD) message to SGSN-V 2403 with a PDP message for updating subscriber data. Thereafter, at step 2406, SGSN-V 2403 acknowledges to HLR-H 112 with an ISD-ACK, to confirm to HLR-H 112 that SGSN-V 2406 has successfully received PDP and other subscriber data. Further, at step 2408, SGSN-V 2403 receives the acknowledgement from HLR-H 112, indicating that HLR-H 112 is updated successfully with IMSI-A and SGSN-V 2403 address, at HLR-H 112. Finally, at step 2410, SGSN-V 2403 establishes GPRS session with GGSN 2401 to proceed with GPRS interactions. Subscriber 108 can now use various GPRS services, while being subscribed to one or more VAS.

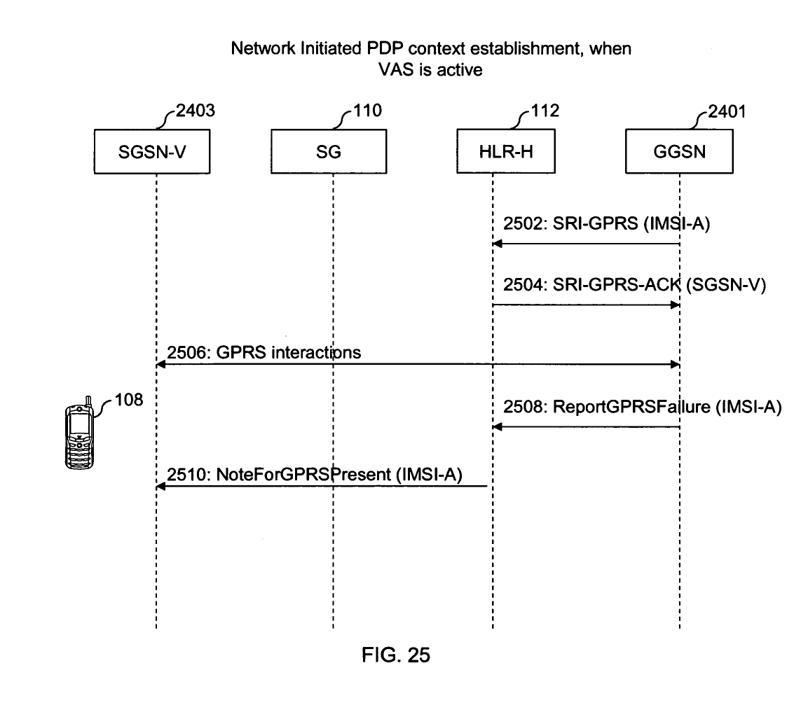

In some cases, instead of subscriber 108 initiating a PDP context, network may initiate the PDP context establishment. FIG. 25 represents a flow diagram of Network Initiated PDP context establishment with the subscriber, while one or more VAS are active, in accordance with an embodiment of the present invention. The method for implementing network initiated GPRS interactions is same for the non-split and the split approach. For GGSN 2401 to initiate PDP context establishment with subscriber 108, GGSN 2401 requires routing information of IMSI-A. At step 2502, GGSN 2401 sends a routing information query for GPRS, such as SRI-GPRS for IMSI-A, to HLR-H 112. Thereafter, at step 2504, HLR-H 112 returns routing information of SGSN-V 2403 to GGSN 2401, as GPRS services are not affected during LUP. As GGSN 2401 now has the routing information of subscriber's SGSN, GGSN 2401 sends PDP notification to SGSN-V 2403. SGSN-V 2403 can then send an acknowledgement message to GGSN 2401, indicating that SGSN-V 2403 can now establish GPRS interaction with GGSN 2401. Thus, at step 2506, SGSN-V 2403 establishes PDP session with GGSN 2401 without involving SG 110 at the time of interaction.

It will be apparent to a person skilled in the art that SGSN-V 2403 can be replaced with SGSN-H, if subscriber 108 is currently located in HPMN 102. In an embodiment of the present invention, when a failure occurs during GPRS interaction, subscriber 108 is unable to use GPRS services. GGSN 2401 can send a failure notification message for IMSI-A, such as, ReportGPRSFailure, to HLR-H 112. At step 2508, HLR-H 112 relays the ReportGPRSFailure acknowledgement to GGSN 2401. In one embodiment of the invention, HLR-H 112 may store the failure delivery report for applying further process, if required. Later, GGSN 2401 might again notify SGSN-V 2403 for establishing GPRS session. At step 2510, GGSN 2401 sends for IMSI-A a message, such as NoteForGPRSPresent, to notify SGSN-V 2403 that GPRS interaction can be established again.

FIG. 26 represents a flow diagram of MT SMS delivery in a first path via GPRS at the subscriber's address, while one or more VAS are active, in accordance with a first embodiment of the present invention. The call flow for delivery of SMS in a first path via GPRS, to subscriber's address is identical for the non-split and the split approach. Subscriber 108 subscribed to one or more VAS, can receive SMS at his handset using GPRS services. The delivery of MT SMS (in this case) to subscriber 108 does not involve SG 110 and the SMS is delivered directly to subscriber's SGSN-V 2403 in the first path. This method of MT SMS delivery is, referred to as first path SMS delivery via GPRS. In a second embodiment of the present invention, MT SMS is delivered to subscriber's handset via GPRS, using VMSC-V 130 as a second path, which is described later in conjunction with FIGS. 27A and 27B.

In the first path embodiment, for SMSC-O 801 to deliver the SMS to subscriber 108, SMSC-O 801 requires routing information of subscriber's current SGSN and IMSI associated with subscriber 108. At step 2602, SMSC-O 801 sends to HLR-H 112 the routing information query for short messages such as, SRI-SM, for MSIDSN-A and GPRS support. Thereafter, at step 2604, HLR-H 112 acknowledges to SMSC-O 801 with the routing information of IMSI-A and SGSN-V 2403. At step 2606, SMSC-O 801 from the retrieved routing information of SGSN-V 2403 and IMSI-A, redirects SMS to SGSN-V 2403. Thereafter, at step 2608, SGSN-V 2403 uses SearchMS to locate the subscriber's handset. Once, subscriber's handset is located, SMS is delivered to subscriber 108 on his handset. Finally, at step 2610, SGSN-V 2403 sends the acknowledgement message to SMSC-O 801, indicating successful delivery of SMS to subscriber's handset.

SMS delivery to subscriber's handset is generally not preferred using the first path of GPRS. Therefore, a more generalized method of SMS delivery is required. FIGS. 27A and 27B represents a flow diagram of MT SMS delivery using the second path via GPRS at the subscriber's address, while one or more VAS are active, in accordance with a second embodiment of the present invention. The SMS delivery using second path of VMSC-V 130 requires subscriber 108 to register via GPRS and involves interception of SG 110. In this embodiment, SG 110 can first redirect the SMS to VMSC-V 130. However, VMSC-V 130 can send an error notification to SG 110, which further queries HLR associated with subscriber 108 for routing information of subscriber's current SGSN (i.e. SGSN-V 2403). Finally, on retrieving the routing information, HLR-H 112 redirects the SMS using subscriber's current SGSN path. The call flow for delivery of MT SMS using a second path of VMSC 130, via GPRS, to subscriber's address is same for non-split approach and split approach.

For SMSC-O 801 to deliver the SMS to subscriber's handset, SMSC-O 801 requires routing information of subscriber's current VMSC address and IMSI associated with subscriber 108. At step 2702, SMSC-O 801 sends to HLR-H 112, the routing information query for short messages such as, SRI-SM on MSIDSN-A. Thereafter, at step 2704, HLR-H 112 responds to SMSC-O 801 with the routing information of IMSI-A and address of SG 110. At step 2706, SMSC-O 801 redirects the SMS for IMSI-A to SG 110, on the basis of IMSI-A information and routing information of SG 110, obtained from HLR-H 112. In an embodiment of the present invention, SG 110 applies the VAS logic based on the request sent by subscriber 108 in the activation request. Thereafter, at step 2708, SG 110 redirects the SMS for IMSI-A, to VMSC-V 130. VMSC-V 130 address is retrieved from the database associated with SG 110. Further, at step 2710, VMSC-V 130 may use SearchMS to locate the subscriber's handset. At step 2712, VMSC-V 130 may respond to SG 110 with an error acknowledgement, indicating that SMS delivery using VMSC-V 130 failed. SG 110 may further opt for forwarding the SMS using a different path. Therefore, at step 2714, SG 110 sends SRI-SM message on MSISDN-A and GPRS support for retrying delivery of SMS, to HLR-H 112, using an alternate path (i.e. SGSN-V path), which is the first path as described above.

In an embodiment of the present invention, HLR-H 112 may perform a check to find out if subscriber 108 has registered for the GPRS service or not. If subscriber 108 registered for GPRS services, subscriber's current SGSN corresponding to subscriber 108, is sent to SG 110. At step 2716, HLR-H 112 sends to SG 110 the routing information for IMSI-A and SGSN-V 2403. Further, at step 2718, SG 110 redirects the SMS to SGSN-V 2403. Thereafter, at step 2720, SGSN-V 2403 may page the subscriber's handset with a message, such as, PageMS. This is an alternate message instead of SearchMS (as used by VMSC-V 130), used by SGSN-V 2403 to locate the subscriber's handset. At step 2722, SGSN-V 2403 responds to SG 110 with the acknowledgement message that indicates successful delivery of SMS to subscriber 108. Finally, at step 2724, SG 110 relays the acknowledgement message to SMSC-O 810 for indicating successful delivery of SMS.

It would be apparent to a person skilled in the art, that subscriber A is also able to perform any mobile originated activity from his handset while one or more VAS are active. FIGS. 28A and 28B represent a flow diagram of various MO activities from the subscriber's address, while one or more VAS are active, in accordance with an embodiment of the present invention. It would be apparent to a person skilled in the art that for making any MO activities, subscriber 108 does not require an interception of SG 110. As faking is performed at HLR-H 112 by replacing subscriber's location address with the address of SG 110, subscriber 108 still possess the information for real VLR and real VMSC. Thus, MO activities will not involve SG 110. The call flow of subscriber 108 performing MO-activities is same for the non-split and split approach, in accordance with the present invention. In case of an MO-SMS, subscriber 108 (present in VPMN 104) sends the SMS from his handset that reaches VMSC-V associated with subscriber 108. At step 2802, VMSC-V 130 forwards the SMS to SMSC-H 116, with a message, such as, FwdSMS. SMSC-H 116 can then route the SMS to receiver's handset using standard routing procedure. Thereafter, at step 2804, SMSC-H 116 acknowledges to the forward SMS request by sending FwdSMS-ACK to VMSC-V 130. In one embodiment of the present invention, the acknowledgement message indicates a successful delivery of SMS. In second embodiment of the present invention, the acknowledgement message indicates a failure delivery of the SMS.

Subscriber's mobile communication is facilitated by allowing subscriber 108 to make calls from its current location, while he is subscribed to one or more VAS. Subscriber 108 initiates an outgoing call to a called number, referred to as, called party B. This causes VLR-V 128 to retrieve outgoing call information from VMSC-V 130 for IMSI-A by using message, such as, SendInfoForOutgoingCall, at step 2806. Thereafter, at step 2808, VMSC-V 130 sends MSISDN-A in the acknowledgement to VLR-V 128. Further, at step 2810, VLR-V 128 sends a call initiation request using MSISDN-A to a GMSC-B 2811 associated with the called party B.

In one embodiment of the present invention, subscriber 108 can opt to activate or register to various supplementary services as VAS. In second embodiment of the present invention, subscriber 108 can opt to de-activate or erase various supplementary services. In third embodiment of the present invention, subscriber 108 may interrogate for retrieving various information, such as, but not limited to, supplementary services active on subscriber's profile or any other information pertaining to the supplementary services corresponding to subscriber 108. In yet another embodiment of the invention, subscriber 108 may send an active SS message to HLR-H 112 for receiving information about the supplementary services active on the subscriber's profile. In an embodiment of the present invention, when subscriber 108 is subscribing for SMS forwarding service, SG 110 interrogates HLR-H 112 using a message, such as interrogate SS, to retrieve a forward-to number at which the messages sent to subscriber 108 are redirected. Current VLR associated with subscriber 108 can send one or more of the above messages. As an exemplary case, at step 2812, VLR-V 128 may send one or more messages, such as, but not limited to, Active SS, RegisterSS, InterrogateSS, EraseSS or De-activateSS to HLR-H 112 for requesting or performing various supplementary services. Further, at step 2814, HLR-H 112 sends the acknowledgement message to VLR-V 128. The acknowledgment may indicate the status, such as successful or failed implementation or status of the SS at the subscriber's profile.

In one embodiment of the invention, subscriber 108 may also use an Unstructured Supplementary Service Data (USSD), message from his handset. For example, at step 2816, subscriber 108 sends an USSD request for IMSI-A from his handset which is routed to HLR-H 112 via VLR-V 128. Finally, at step 2818, HLR-H 112 sends the acknowledgment to VLR-V 128 and may even display the acknowledgment message on subscriber's handset.

Like various modifications in settings for VAS active in subscriber's profile as described above, subscriber 108 can also de-activate one or more currently active VAS. FIGS. 29A and 29B represents a flow diagram of de-activation of one or more VAS, upon receiving a de-activation request, in accordance with an embodiment of the present invention. The de-activation request can be, but not limited to, a Short Message Service (SMS) message, an Unstructured Supplementary Service Data (USSD) message, a customer care interaction, a Wireless Application Protocol (WAP) interaction, a web interaction, an Interactive Voice Response (IVR) message and a SIM Tool Kit (STK) menu. In an embodiment of the present invention, the activation request and the deactivation request are different. In an exemplary case, the subscriber 108 may send an SMS for activation request and an USSD message for de-activating one or more VAS.

FIGS. 29A and 29B describes the flow for de-activation of one or more VAS using non-split approach. Subscriber 108 sends the SMS with a Short Message Entity (SME) number, intended for SG 110. SMS request for de-activation of one or more VAS first reaches VMSC-V 130. At step 2902, VMSC-V 130 relays the indication for de-activation request on MSISDN-A, SME of SG 110 and the indication of one or more VAS, to SMSC-H 116. In an embodiment of the present invention, subscriber 108 can send the de-activation request from VMSC-H 120, if subscriber 108 is located in HPMN 102. At step 2904, SMSC-H 116 further submits the SMS for de-activation of one or more VAS, to SG 110. Thereafter, at step 2906, SG 110 first queries its own database in order to check the status of one or more VAS. On detection of single active VAS in the database, SG 110 stores the de-activation request in its database. At step 2908, SG 110 sends the acknowledgement back to SMSC-H 116, indicating successful de-activation of VAS based on the de-activation request sent by subscriber 108. Further, SMSC-H 116 relays the acknowledgement to VMSC-V 130, at step 2910. In an embodiment of the present invention, if subscriber 108 has requested for the delivery report, an SMS is sent to his handset, indicating successful de-activation of services. Thereafter, at step 2912, SG 110 sends a registration message, such as LUP, to HLR-H 112 to update HLR-H 112 with subscriber's current VMSC-V 130 and VLR-V 128 and also with other capabilities. SG 110 sends LUP as SCCP signaling message with CdPA set to E214 address of IMSI-A.

Thereafter, at step 2914, HLR-H 112 sends an ISD message for updating subscriber's profile, to SG 110 in response to the LUP message. Thereafter, at step 2916, SG 110 acknowledges to HLR-H 112 with ISD-ACK, indicating successful addition of subscriber's profile at SG 110. At step 2918, SG 110 receives a LUP acknowledgement from HLR-H 112 to indicate successful addition of VMSC-V 130 and VLR-V 128 addresses at HLR-H 112. Further, at step 2920, as subscriber's current VMSC address is restored to VMSC-V 130, HLR-H 112 sends a registration cancellation message on IMSI-A, to SG 110. Finally, at step 2922, SG 110 sends back the acknowledgement message to HLR-H 112 indicating successful registration cancellation of SG 110. This removes SG 110 from the loop of signaling exchange from and to subscriber 108.

In second embodiment of the present invention, when more than one VAS is detected to be active in the database, SG 110 simply stores an indication of de-activation request in its database, the de-activation of one or more requested VAS is performed for subscriber 108 and no further action occurs (i.e. no LUP occurs). SG 110 is still maintained in the loop of signaling exchange from and to subscriber 108.

In an alternate embodiment of the present invention, if split approach is used for de-activation of one or more VAS, step 2902 to step 2918 remains the same, however, registration cancellation message is not received at SG 110 in case of split approach. In case of split approach, HLR-H 112 has the real VLR information (i.e. VLR-V 128); however, the address of SG 110 replaces VMSC-V 130 during registration process. Thus, there is a need to notify SG 110 for any LUP that might occur at HLR-H 112. The monitoring system, as described in conjunction with FIGS. 7A and 7B, can be used to detect LUP message received at HLR-H 112 so that when the indication of de-activation request is received at HLR-H 112, the monitoring system can detect the indication and thus perform the desired task. If no monitoring is performed, SG 110 will not be indicated for any location update that might occur at HLR-H 112, for instance, when location update received at HLR-H 112 is due to subscriber 108 sending de-activation request for de-activating one or more VAS.

Hereinafter, subscribers subscribed to one or more VAS and using prepaid account, interchangeably, are referred to as prepaid subscribers. In case of MO activities, as there is no intervention by SG 110 as VLR-V 128 has the subscriber's profile information and prepaid services for MO activities are not affected. Therefore, Customized Applications for Mobile network Enhanced Logic (CAMEL), Intelligent Network (IN) and other service node for prepaid subscribers are not affected.

For MT activities, performed by prepaid subscriber, as HLR-H 112 has the information that SG 110 is the VMSC address of prepaid subscriber, prepaid charging is not a problem when the prepaid subscriber is not roaming. However, when subscriber 108 is roaming, prepaid charging will be a problem. VMSC address associated with subscriber 108, is often used for determining call rerouting charging in prepaid services. Further, as all rerouting operations for MT activities involve SG 110, billing may be a problem for the prepaid subscriber. Many service node-based prepaid systems also use routing information query for short messages, such as, SRI-SM, to get the VMSC address associated with the prepaid subscriber, to determine charging when ISUP call on prepaid subscriber is diverted through service node.

One solution to this above mentioned problem with prepaid systems is to use MSRN to determine charging on MT calls to the prepaid subscriber. The prepaid system issues SRI on MSISDN-A, to HLR-H 112, which can further request SG 110 for PRN. SG 110 can further relay the PRN request to VLR-V 128, which relays MSRN to HLR-H 112, through SG 110. HLR-H 112 can then send the MSRN to the prepaid system. In one embodiment of the present invention, SG 110 sends the PRN request to VLR-V 128 by sending signaling message, such as, SCCP, with called party, to VMSC-V 130 with called party address, CdPA, as VLR-V 128. In second embodiment of the present invention, SG 110 sends PRN request directly to VLR-V 128 by using a mapping table of VMSC and VLR. As the prepaid system gets MRSN for prepaid subscriber directly from subscriber's real VLR, the charging problem when the prepaid subscriber is roaming is resolved.

However, if VMSC address associated with prepaid subscriber is used to determine charges for the MT calls to the prepaid subscriber, then this solution is not applicable. In an embodiment of the present invention, one solution to this problem treats address of SG 110, received at the prepaid system, as a special address.

In first embodiment of the present invention, when VMSC address is determined to be a roaming address, the prepaid system defines a roaming rate in its charging table. Moreover, if there are different charging tariffs for different roaming zones, then SG 110 is assigned different global titles corresponding to different roaming zones. In second embodiment, when subscriber's VMSC address is determined to be a non-roaming address, normal tariff is applied. This approach can be adopted only by configuring the tariff table at the prepaid system.

In another embodiment of the present invention, if the prepaid system can be modified, then prepaid system interrogates the database associated with SG 110, for real VMSC address of the prepaid subscriber for exact roaming tariff. For instance, the prepaid system can send InterrogateSS message to SG 110 to retrieve VMSC-V 130 address in order to determine the exact roaming charges, in accordance with the present invention.

It will be apparent to a person skilled in the art, that the VAS services can also be provided to subscribers using CDMA/ANSI-41D, and other technologies such as, but may not be limited to, VoIP, WiFi, 2 G, 3 G, and inter-standard roaming. For example, a CDMA roaming subscriber traveling to VPMN may choose to subscribe to one or more VAS. To support these variations, the SG 108 will have a SS7 and network interface corresponding to the VPMN network as well as a SS7 and network interface corresponding to the HPMN network. It would be obvious to a person skilled in the art, that these two interfaces in different directions may not have to be the same technologies. In addition, there could be multiple types of interfaces in both directions.

An exemplary list of the mapping between GSM MAP and ANSI41D is described in the table below as a reference.

| GSM MAP | ANSI 41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCATION REQUEST |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTING REQUEST |

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

A computer usable medium provided herein includes a computer usable program code, which when executed, applies one or more value added service (VAS) on messages sent to a subscriber without affecting the subscriber's mobile communication. The computer program product further includes a computer usable program code for receiving an activation request from the subscriber for activating one or more VAS, at the SG. The computer program product further includes a computer usable program code for retrieving the subscriber's visited switching address and the subscriber's address from a home location information database associated with the subscriber. The computer program product further includes a computer usable program code for storing the subscriber's visited switching address, the home location information database address and an indication for activating the one or more VAS in a database associated with the SG. The computer program product further includes a computer usable program code for updating the home location information database to redirect the messages, sent to the subscriber's address, to the SG. The computer program product further includes a computer usable program code for applying a logic corresponding to the VAS on the redirected messages, at the SG.

An operator uses one or more variations of the present invention to provide subscribers, associated with its network, with one or more VAS even when they are not in the coverage of home network and are in VPMN networks. The present invention facilitates the subscribers to subscribe to various VAS without affecting their mobile communication, even when they are in VPMN networks. The system provides multiple VAS to the subscriber at the same time. The present system allows the subscriber to subscribe to message forwarding or other VAS, irrespective of the status of call forwarding. The subscriber may forward an SMS to one handset and calls on another handset, and may still be able to make calls from his forwarding handset. The subscribers who are associated with network operators that operate both CDMA and GSM networks are also able to subscribe to the services of the present invention. Subscriber can initiate mobile activities and receive MT activities from his handset, while being subscribed to one or more VAS. A spam filtering approach that controls spam by defining filter rules is well known and is in use, however, defining filter rules is a subscriber intensive process and often many of the spam messages are not filtered. Although intelligent and self-learning filters can be one of the solutions, however, even this solution quite often fails to filter some of the spam messages. Thus, the subscriber is provided with a spam service, which provides subscriber with an improved version of controlling spam messages from reaching his handset as compared to existing spam filtering services.

The present system facilitates the subscribers to use call related and value added services at any of their registered networks. The subscriber's handset can make or receive any calls or messages, while being subscribed to one or more VAS, irrespective of his current location. The present system allows subscriber to receive a copy of messages at his handset while one or more VAS is active for the subscriber. Furthermore, the subscriber can indicate one or more desired services that he wants to activate or de-activate without affecting other active VAS. Further, the present system caters to both post-paid and pre-paid subscribers. Moreover, the present system provides one or more VAS based on whether the subscriber is a VIP subscriber or an ordinary subscriber. Further, the present system also facilitates the operators by allowing them to provide services based on their choice and configuration settings. Operators can further earn revenues from senders who are blacklisted by the subscriber, while the messages from those blacklisted senders are blocked by the system.

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

### Other Variations

Provided above for the edification of those of ordinary skill in the art, and not as a limitation on the scope of the invention, are detailed illustrations of a scheme for applying one or more value added services (VAS) on messages sent to a subscriber without affecting the subscriber's mobile communication. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3 G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3 GSM, 3 G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

### TECHNICAL REFERENCES (EACH OF WHICH IS INCORPORATED HEREIN IN ITS ENTIRETY)

GSM 902 on MAP specification
Digital cellular telecommunications system (Phase 2+);
Mobile Application Part (MAP) Specification (3GPP TS 09.02 version 7.9.0 Release 1998)
GSM 340 on SMS
Digital cellular telecommunications system (Phase 2+);
Technical realization of the Short Message Service (SMS); (GSM 03.40 version 7.4.0 Release 1998)
GSM 378 on CAMEL
Digital cellular telecommunications system (Phase 2+);
Customized Applications for Mobile network Enhanced Logic (CAMEL) Phase 2;
Stage 2 (GSM 03.78 version 6.7.0 Release 1997)
GSM 978 on CAMEL Application protocol
Digital cellular telecommunications system (Phase 2+);
Customized Applications for Mobile network Enhanced Logic (CAMEL);
CAMEL Application Part (CAP) specification (GSM 09.78 version 7.1.0 Release 1998)
Signalling procedures and the Mobile Application Part (MAP) (Release 1999)
Q1214-Q1218 on Intelligent Networks
Q701-704 on SS7 MTP
Q711-Q714 on SS7 SCCP
Q760-Q769 on SS7 ISUP
3GPP 22140 Stage 1: MMS Services
3GPP 23140 Stage 2: Functional Description
3GPP 26140 MMS Formats and Codecs
WAP205 MMS Architecture
WAP206 MMS Client Transaction
WAP209 MMS Encapsulation

APPENDIX

| Acronym | Description |
|---|---|
| 3G | Third generation of mobile |
| ACM | ISUP Address Completion Message |
| ANM | ISUP Answer Message |
| ANSI-41 | American National Standards Institute |
| | #41 |
| ATI | Any Time Interrogation |
| BCSM | Basic Call State Model |
| BSC | Base Station Controller |
| CAMEL | Customized Application for Mobile |
| | Enhanced Logic |
| CAP | Camel Application Part |
| CB | Call Barring |
| CC | Country Code |
| CDMA | Code Division Multiplexed Access |
| CdPA | Called Party Address |
| CgPA | Calling Party Address |
| CLI | Calling Line Identification |
| CSD | Circuit Switched Data |
| CSI | Camel Subscription Information |
| DPC | Destination Point Code |
| DSD | Delete Subscriber Data |
| ERB | CAP Event Report Basic call state model |
| FPMN | Friendly Public Mobile Network |
| F | Forward-To Number |
| GLR | Gateway Location Register |
| GMLC | Gateway Mobile Location Centre |
| GMSC | Gateway MSC |
| GMSC-F | GMSC in FPMN |
| GMSC-H | GMSC in HPMN |
| GMSC-V | GMSC in VPMN |
| GPRS | General Packet Radio System |
| GSM | Global System for Mobile |
| GSM SSF | GSM Service Switching Function |
| gsmSCF | GSM Service Control Function |
| GT | Global Title |
| HLR | Home Location Register |
| HLR-F | Forward-to number HLR |
| HLR-H | HPMN HLR |
| HLR-V | VPMN HLR |
| HPMN | Home Public Mobile Network |
| GTT | Global Title Translation |
| IAM | Initial Address Message |
| IDP | Initial DP IN/CAP message |
| IMSI | International Mobile Subscriber Identity |
| IMSI-H | HPMN IMSI |
| IN | Intelligent Network |
| INAP | Intelligent Network Application Part |
| INE | Interrogating Network Entity |
| IP | Internet Protocol |
| ISC | International Service Carrier |
| ISD | MAP Insert Subscriber Data |
| ISG | International Signal Gateway |
| ISTP | International STP |
| ISTP-F | ISTP connected to FPMN STP |
| ISTP-H | ISTP connected to HPMN STP |
| ISUP | ISDN User Part |
| ITR | Inbound Traffic Redirection |
| IVR | Interactive Voice Response |
| LCS | LoCation Service |
| LU | Location Update |
| LUP | MAP Location Update |
| MAP | Mobile Application Part |
| MCC | Mobile Country Code |
| MCC | Mobile Country Code |
| ME | Mobile Equipment |
| MGT | Mobile Global Title |
| MMS | Multimedia Message Service |
| MMSC | Multimedia Message Service Center |
| MMSC-F | Forward-to number MMSC |
| MMSC-H | HPMN MMSC |
| MMSC-V | VPMN MMSC |
| MNC | Mobile Network Code |
| MO | Mobile Originated |
| MSC | Mobile Switching Center |
| MSISDN | Mobile Station International Subscriber |
| | Directory Number |
| MSISDN-H | Forward-to number MSISDN |
| MSISDN-H | HPMN MSISDN |
| MSRN | Mobile Station Roaming Number |
| MSRN-F | Forward-to number MSRN |
| MSRN-H | HPMN MSRN |
| MT | Mobile Terminated |
| MTP | Message Transfer Part |
| NDC | National Dialing Code |
| NP | Numbering Plan |
| NPI | Numbering Plan Indicator |
| O-CSI | Originating CAMEL Subscription |
| | Information |
| ODB | Operator Determined Barring |
| OTA | Over The Air |
| PPG | Push Proxy Gateway |
| PRN | MAP Provide Roaming Number |
| PSL | Provide Subscriber Location |
| PSI | MAP Provide Subscriber Information |
| RI | Routing Indicator |
| RNA | Roaming Not Allowed |
| RR | Roaming Restricted due to unsupported |
| | feature |
| RRB | CAP Request Report Basic call state |
| | model |
| RSD | ReStore Data |
| SAI | Send Authentication Information |
| SCCP | Signal Connection Control part |
| SCP | Signaling Control Point |
| SCP-H | HPMN SCP |
| SG | Signaling Gateway |
| SGSN | Serving GPRS Support Node |
| SGSN-H | HPMN SGSN |
| SGSN-F | Forward-to number SGSN |
| SGSN-V | VPMN SGSN |
| SIM | Subscriber Identity Module |
| SME | Short Message Entity |
| SM-RP-UI | Short Message Relay Protocol User |
| | Information |
| SMS | Short Message Service |
| SMSC | Short Message Service Center |
| SMSC-O | Originating SMSC |
| SMSC-F | Forward-to number SMSC |
| SMSC-H | HPMN SMSC |
| SMSC-V | VPMN SMSC |
| SPC | Signal Point Code |
| SRI | MAP Send Routing Information |
| SRI-LCS | MAP Send Routing Information For |
| | LoCation Service |
| SRI-SM | MAP Send Routing Information For Short |
| | Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TCAP | Transaction Capabilities Application |
| | Part |
| T-CSI | Terminating CAMEL Service Information |
| TP | SMS Transport Protocol |
| TR | Traffic Redirection |
| TT | Translation Type |
| UD | User Data |
| UDH | User Data Header |
| UDHI | User Data Header Indicator |
| USSD | Unstructured Supplementary Service Data |
| VAS | Value Added Service |
| VLR | Visited Location Register |
| VLR-F | Forward-to Number VLR |
| VLR-H | HPMN VLR |
| VLR-V | VPMN VLR |
| VMSC | Visited Mobile Switching Center |
| VMSC-F | Forward-to Number VMSC |
| VMSC-H | HPMN VMSC |
| VMSC-V | VPMN VMSC |
| VPMN | Visited Public Mobile Network |
| WAP | Wireless Access Protocol |

I claim:

1. A method for applying one or more value added services (VAS) on messages sent to a subscriber without affecting the subscriber's mobile communication, the method comprising:
receiving an activation request from the subscriber for activating one or more VAS, at a signaling gateway (SG);
retrieving the subscriber's visited switching address and the subscriber's address from a home location information database associated with the subscriber;
storing the subscriber's address, the subscriber's visited switching address, the home location information database address and an indication for activating the one or more VAS in a database associated with the SG;
updating the home location information database so as to redirect the messages, sent to the subscriber's address, to the SG; and
applying a logic corresponding to the VAS on the redirected messages, at the SG.

2. The method of claim 1, wherein the VAS logic corresponds to at least one of SMS forwarding, SMS transcoding, SMS translation, SMS to multimedia message enhancement, an MMS forwarding, spam control, spam filtering, SMS advertising, SMS logging, barring blacklisted sender's messages and SMS copy to an email address.

3. The method of claim 1, wherein the VAS logic is applied based on operator's preferences.

4. The method of claim 1, wherein the subscriber's visited switching address is a Visited Mobile Switching Center (VMSC) associated with the subscriber's registered network.

5. The method of claim 1, wherein the home location information database is a Home Location Register (HLR) associated with the subscriber.

6. The method of claim 1 further, comprising: storing in the database, a visited location information database associated with the subscriber's registered network.

7. The method of claim 6, wherein the visited location information database is a Visitor Location Register (VLR) associated with the subscriber's registered network.

8. The method of claim 1, wherein the subscriber's address is at least one of a Mobile Station International Subscriber Directory Number (MSISDN), an International Mobile Subscriber Identity (IMSI), a Mobile Directory Number (MDN) and a Mobile Identification Number (MIN).

9. The method of claim 1, wherein the SG and the home location information database are coupled to a first network, and a visited location information database and the subscriber's visited switching address are coupled to a second network.

10. The method of claim 9, wherein the second network and the first network are identical.

11. The method of claim 1, wherein retrieving the subscriber's visited switching address and the subscriber's address comprises: sending a routing information query, corresponding to an MSISDN of the subscriber, to the home location information database.

12. The method of claim 1, wherein updating the home location information database comprises: sending a first registration message to the home location information database with the subscriber's visited switching address and a visited location information database being replaced by an address of SG.

13. The method of claim 12, further comprising: fetching the subscriber's visited switching address, upon receipt of a registration cancellation message at the SG from the home location information database, when the one or more VAS is active.

14. The method of claim 12, further comprising: causing the home location information database to send a registration cancellation message to the visited location information database.

15. The method of claim 12, further comprising: relaying from the SG, a reset request for the subscriber's profile to one or more visited location information database associated with one of the home location information database and the subscriber's profile, upon receipt of the reset request from the home location information database, at the SG.

16. The method of claim 12, further comprising: causing restoration of the subscriber's profile at the visited location information database, to facilitate the subscriber's mobile communication.

17. The method of claim 16, wherein causing the restoration comprises: sending a roaming number request to the visited location information database.

18. The method of claim 17, further comprising: sending profile restoration request from the visited location information database to the home location information database.

19. The method of claim 17, wherein the roaming number request is sent to the visited location information database based on a mapping table for the subscriber's visited switching address and the visited location information database.

20. The method of claim 19, wherein the mapping table is created from information associated with a first network, the first network and a second network being same.

21. The method of claim 19, wherein the mapping table is created from information retrieved by monitoring roaming signaling exchange associated with the subscriber when a first network and a second network are distinct.

22. The method of claim 19, wherein the mapping table is created based on an IR 21 database exchange between a first network and a second network, the first network and the second network being distinct.

23. The method of claim 1, wherein updating the home location information database comprises: sending a first registration message to the home location information database with the subscriber's visited switching address being replaced by an address of SG.

24. The method of claim 23, further comprising: sending from the home location information database, a reset request for the subscriber's profile to one or more visited location information database associated with one of the home location information database and the subscriber's profile.

25. The method of claim 23, further comprising: receiving at the SG, an indication of at least one of an updated visited switching address associated with the subscriber's registered network and an updated visited location information database associated with the subscriber's registered network, upon a receipt of a second registration message from the subscriber's address at the home location information database.

26. The method of claim 25, wherein the SG monitors the receipt of the second registration message at the home location information data.

27. The method of claim 26, wherein the monitoring comprises: tapping the exchange of messages at signaling links coupled to the home location information database.

28. The method of claim 27, wherein the tapping is performed by an external monitoring system coupled to the SG.

29. The method of claim 27, wherein the monitoring comprises: retrieving a location change notification from the home location information database.

30. The method of claim 26, wherein the monitoring comprises: interfacing the home location information database.

31. The method of claim 1, wherein applying the VAS logic comprises: sending the redirected messages to one or more forward-to addresses, indicated in the activation request.

32. The method of claim 31, wherein the one or more forward-to addresses are stored in the database.

33. The method of claim 31, further comprising: querying the home location information database by the SG, to retrieve routing information corresponding to the one or more forward-to addresses associated with the subscriber.

34. The method of claim 31, wherein sending the redirected messages comprises:
extracting the subscriber's address from the activation request; and
retrieving at least one forward-to address from the one or more forward-to addresses stored in the database.

35. The method of claim 31, further comprising: resending the redirected messages to the forward-to address upon unsuccessful delivery of the redirected messages to the forward-to address in an earlier attempt, wherein one or more messages corresponding to the redirected messages are resent by the SG.

36. The method of claim 35, wherein the SG stores the one or more messages when the forwarding of the messages was unsuccessful in the earlier attempt.

37. The method of claim 31, wherein sending the redirected messages is independent of status of call forwarding indicated by the subscriber.

38. The method of claim 31, wherein the SG redirects an MMS sent to the subscriber's address to a forward-to address, when status of SMS forwarding, as the VAS, is active in the database.

39. The method of claim 38, wherein the SG intercepts a receipt of an MMS notification sent to the subscriber's address.

40. The method of claim 39, further comprising: sending a forwarding request by the SG to a first MMSC associated with the subscriber for redirecting the MMS to the forward-to address.

41. The method of claim 40, wherein the SG sends the forwarding request using an MM1 interface.

42. The method of claim 40, wherein the first MMSC is coupled to a first network and a second MMSC associated with the forward-to address is coupled to a second network.

43. The method of claim 42, wherein the first MMSC uses an MM4 interface to forward the MMS to the second MMSC.

44. The method of claim 1, wherein the forward-to-address is at least one of the subscriber's address, a mobile number associated with the subscriber, a fixed-line number, an email address, a Session Initiation Protocol (SIP) address, a Voice over Internet Protocol (VoIP) number, and an RSS feed generator address.

45. The method of claim 1, further comprising: presenting an address of the SG to comprise a roaming identifier while the SG communicates with a first network, when the subscriber is roaming in a second network.

46. The method of claim 1, further comprising: presenting an address of the SG to comprise a non-roaming identifier while the SG communicates with a first network, when the subscriber is present in the first network.

47. The method of claim 1, further comprising:
receiving a de-activation request at the SG for deactivating one or more VAS; and
querying the database for status of the one or more VAS.

48. The method of claim 47, further comprising:
storing the de-activation request in the database; and
re-updating the home location information database so as to redirect the messages sent to the subscriber, to the subscriber's visited switching address, when one VAS is active in the database.

49. The method of claim 48, wherein re-updating the home location information database comprises: facilitating the subscriber's mobile communication, wherein the subscriber's visited switching address was being replaced by an address of SG in a registration message sent from the SG to the home location information database.

50. The method of claim 48, wherein re-updating the home location information database comprises:
causing the home location information database to send a registration cancellation message to the SG, wherein the subscriber's visited switching address and a visited location information database were being replaced by an address of SG in a registration message sent from the SG to the location information database; and
facilitating the subscriber's mobile communication.

51. The method of claim 47, further comprising: storing an indication of the de-activation request in the database, when a plurality of VAS is active in the database.

52. The method of claim 47, wherein the de-activation request comprises one of a Short Message Service (SMS) message, an Unstructured Supplementary Service Data (USSD) message, a customer care interaction, a Wireless Application Protocol interaction, a web interaction, an Interactive Voice Response (IVR) message and a SIM Tool Kit (STK) menu.

53. The method of claim 1, wherein the redirected messages are sent to one forward-to address by the SG.

54. The method of claim 1, wherein the redirected messages are sent to distinct forward-to addresses by the SG.

55. The method of claim 1, wherein the activation request comprises: one of a Short Message Service (SMS) message, an Unstructured Supplementary Service Data (USSD) message, a customer care interaction, a Wireless Application Protocol interaction, a web interaction, an Interactive Voice Response (IVR) message and a SIM Tool Kit (STK) menu.

56. The method of claim 1, wherein applying the VAS logic comprises: sending an indication from the SG to a sender for a successful delivery of a message sent to the subscriber, wherein the sender is defined as blacklisted by the subscriber, and the sender sends the message as a part of the redirected messages received at the SG.

57. The method of claim 1, wherein applying the VAS logic comprises: sending a first confirmation message from the SG to a sender, after detecting the sender's status from the database, the sender sends the message to the subscriber as a part of the redirected messages received at the SG.

58. The method of claim 57, further comprising: sending a second confirmation message from the SG to the subscriber's address.

59. The method of claim 58, further comprising: sending by the SG to the sender, an indication of successful delivery of the message at the subscriber's address, when the sender is indicated as blacklisted by the subscriber in a response of the second confirmation message.

60. The method of claim 58, further comprising:
storing in the database, a delivery outcome and an indication of the sender as a whitelisted, wherein the indication is received in a response to the second confirmation message; and
sending by the SG, the message to the one or more forward-to addresses.

61. The method of claim 58, further comprising: sending by the SG to the sender, an indication of unsuccessful delivery of the message at the subscriber's address, when the sender is unconfirmed to be one of whitelisted or blacklisted by the subscriber.

62. The method of claim 61, further comprising:
updating the home location information database for an availability of the subscriber, upon non-receipt of a response of the second confirmation message; and
causing the message to be resent to the one or more forward-to addresses.

63. The method of claim 62, wherein causing the message to be resent further comprises: sending by the SG to the sender the stored delivery outcome.

64. A system for applying one or more value added services (VAS) on messages sent to a subscriber without affecting the subscriber's mobile communication, the system comprising:
a signaling gateway (SG) for receiving an activation request from the subscriber for activating one or more VAS, the SG further retrieves the subscriber's visited switching address and the subscriber's address from a home location information database associated with the subscriber, the SG further stores the subscriber's address, the subscriber's visited switching address, the home location information database and an indication for activating the one or more VAS in a database associated with the SG, the SG further updates the home location information database so as to redirect the messages to the SG, and the SG further applies a logic corresponding to the VAS on the redirected messages.

65. The system of claim 64, wherein the VAS logic corresponds to at least one of SMS forwarding, SMS transcoding, SMS translation, SMS to multimedia message enhancement, an MMS forwarding, spam control, spam filtering, SMS advertising, SMS logging, barring blacklisted sender's messages and SMS copy to an email address.

66. The system of claim 64, wherein the VAS logic is applied based on operator's preference.

67. The system of claim 64, wherein the SG further stores in the database, a visited location information database associated with the subscriber's registered network.

68. The system of claim 64, wherein the subscriber's address is at least one of a Mobile Station International Subscriber Directory Number (MSISDN), an International Mobile Subscriber Identity (IMSI), a Mobile Directory Number (MDN) and a Mobile Identification Number (MIN).

69. The system of claim 64, wherein the SG and the home location information database are coupled to a first network, and a visited location information database and the subscriber's visited switching address are coupled to a second network.

70. The system of claim 69, wherein the second network and the first network are identical.

71. The system of claim 64, wherein the SG retrieves the subscriber's visited switching address and the subscriber's address by sending a routing information query corresponding to an IMSI of the subscriber to the home location information database.

72. The system of claim 64, wherein the SG updates the home location information database by sending a registration message to the home location information database with the subscriber's visited switching address and a visited location information database being replaced by an address of SG.

73. The system of claim 72, wherein the SG further fetches the subscriber's visited switching address, upon receipt of a registration cancellation message from the home location information database, when one or more VAS is active.

74. The system of claim 72, wherein the SG causes the home location information database to send a registration cancellation message to the visited location information database.

75. The system of claim 72, wherein SG further relays a reset request for the subscriber's profile to one or more visited location information database associated with one of the home location information database and the subscriber's profile, upon receipt of the reset request from the home location information database.

76. The system of claim 72, wherein the SG causes restoration of subscriber's profile at the visited location information database, to facilitate the subscriber's mobile communication.

77. The system of claim 76, wherein the SG causes the restoration by sending a roaming number request to the visited location information database.

78. The system of claim 77, wherein the visited location information database sends a profile restoration request to the home location information database.

79. The system of claim 77, wherein the SG sends the roaming number request to the visited location information database based on a mapping table for the subscriber's visited switching address and the visited location information database.

80. The system of claim 79, wherein the mapping table is created from information associated with a first network, the first network and a second network being same.

81. The system of claim 79, wherein the SG creates the mapping from information retrieved by monitoring signaling exchange associated with the subscriber when a first network and a second network are distinct.

82. The system of claim 79, wherein the SG creates the mapping table based on an IR 21 database between a first network and a second network, the first network and the second network being distinct.

83. The system of claim 64, wherein the SG updates the home location information database by sending a first registration message to the home location information database with the subscriber's visited switching address being replaced by an address of SG.

84. The system of claim 83, further comprising: sending from the home location information database, a reset request for the subscriber's profile to one or more visited location information database associated with one of the home location information database and the subscriber's profile.

85. The system of claim 83, wherein the SG receives an indication of at least one of an updated current switching address associated with the subscriber's registered network and an updated visited location information database associated with the subscriber's registered network, upon a receipt of a second registration message from the subscriber's address at the home location information database.

86. The system of claim 85, wherein the SG monitors the receipt of the second registration messages at the home location information data.

87. The system of claim 86, wherein the monitoring comprises: tapping the exchange of messages at signaling links coupled to the home location information database.

88. The system of claim 87, wherein the tapping is performed by an external monitoring system coupled to the SG.

89. The system of claim 87, wherein the monitoring comprises: retrieving a location change notification from the home location information database.

90. The system of claim 86, wherein the monitoring comprises: interfacing the home location information database.

91. The system of claim 64, wherein the VAS logic is applied by sending the redirected messages to one or more forward-to addresses, indicated in the activation request.

92. The system of claim 91, wherein the one or more forward-to addresses are stored in the database.

93. The system of claim 91, wherein the SG queries the home location information database to retrieve routing information corresponding to the one or more forward-to addresses associated with the subscriber.

94. The system of claim 91, wherein sending the redirected messages by the SG comprises:
extracting the subscriber's address from the activation request; and
retrieving at least one forward-to address from the one or more forward-to addresses stored in the database.

95. The system of claim 91, wherein the SG resends the redirected messages to the forward-to address upon unsuccessful delivery of the redirected messages to the forward-to address in an earlier attempt, wherein one or more messages corresponding to the redirected messages are resent.

96. The system of claim 95, wherein the SG stores the one or more messages when the forwarding of the messages was unsuccessful in the earlier attempt.

97. The system of claim 91, wherein the SG sends the redirected messages independent of status of call forwarding indicated by the subscriber.

98. The system of claim 91, wherein the SG redirects an MMS sent to the subscriber's address to a forward-to address, when status of SMS forwarding, as the VAS, is active in the database.

99. The system of claim 98, wherein the SG intercepts a receipt of an MMS notification sent to the subscriber's address.

100. The system of claim 99, further comprising: sending a forwarding request by the SG to a first MMSC associated with the subscriber for redirecting the MMS to the forward-to address.

101. The system of claim 100, wherein the SG sends the forwarding request using an MM1 interface.

102. The system of claim 100, wherein the first MMSC is coupled to a first network and a second MMSC associated with the forward-to address is coupled to a second network.

103. The system of claim 102, wherein the first MMSC uses an MM4 interface to forward the MMS to the second MMSC.

104. The system of claim 64, wherein the forward-to-address is at least one of the subscriber's address, a mobile number associated with the subscriber, a fixed-line number, an email address, a Session Initiation Protocol (SIP) address, a Voice over Internet Protocol (VoIP) number, and an RSS feed generator address.

105. The system of claim 64, wherein an address of the SG is presented to comprise a roaming identifier while the SG communicates with a first network, when the subscriber is roaming in a second network.

106. The system of claim 64, wherein an address of the SG is presented to comprise a non-roaming identifier while the SG communicates with a first network, when the subscriber is present in the first network.

107. The system of claim 64, wherein the SG receives a de-activation request for deactivating one or more VAS, and the SG further queries the database for status of the one or more VAS.

108. The system of claim 107, wherein the SG stores the de-activation request in the database, and the SG further re-updates the home location information database so as to redirect the messages sent to the subscriber, to the subscriber's visited switching address, when one VAS is active in the database.

109. The system of claim 108, wherein the SG re-updates the home location information database by facilitating the subscriber's mobile communication, wherein the subscriber's visited switching address was being replaced by an address of SG in a registration message sent from the SG to the home location information database.

110. The system of claim 108, wherein the SG re-updates the home location information database by:
causing the home location information database to send a registration cancellation message to the SG, wherein the subscriber's visited switching address and a visited location information database were being replaced by an address of SG in a registration message sent from the SG to the home location information database; and
facilitating the subscriber's mobile communication.

111. The system of claim 107, wherein the SG stores an indication of the de-activation request in the database, when a plurality of VAS is active in the database.

112. The system of claim 107, wherein the de-activation request comprises one of a Short Message Service (SMS) message, an Unstructured Supplementary Service Data (USSD) message, a customer care interaction, a Wireless Application Protocol interaction, a web interaction, an Interactive Voice Response (IVR) message and a SIM Tool Kit (STK) menu.

113. The system of claim 64, wherein the SG sends the redirected messages to one forward-to address.

114. The system of claim 64, wherein the SG sends the redirected messages to distinct forward-to addresses.

115. The system of claim 64, wherein the activation request comprises one of a Short Message Service (SMS) message, an Unstructured Supplementary Service Data (USSD) message, a customer care interaction, a Wireless Application Protocol interaction, a web interaction, an Interactive Voice Response (IVR) message and a SIM Tool Kit (STK) menu.

116. The system of claim 64, wherein the VAS logic is applied by sending an indication from the SG to a sender for a successful delivery of a message sent to the subscriber, wherein the sender is defined as blacklisted by the subscriber, and the sender sends the message as a part of the redirected messages as received at the SG.

117. The system of claim 64, wherein the VAS logic is applied by sending a first confirmation message from the SG to a sender, after detecting the sender's status from the database, the sender sends the message to the subscriber as a part of the redirected messages received at the SG.

118. The system of claim 117, wherein the SG sends a second confirmation message from the SG to the subscriber's address.

119. The system of claim 118, wherein the SG sends to the sender, an indication of successful delivery of the message at the subscriber's address, when the sender is indicated as blacklisted by the subscriber in a response of the second confirmation message.

120. The system of claim 118, wherein the SG stores in the database, a delivery outcome and an indication of the sender as a whitelisted, wherein the indication is received in a response to the second confirmation message, and the SG further sends the message to the one or more forward-to addresses.

121. The system of claim 118, wherein the SG sends to the sender, an indication of unsuccessful delivery of the message at the subscriber's address, when the sender is unconfirmed to be one of whitelisted or blacklisted by the subscriber.

122. The system of claim 121, wherein the SG updates the home location information database for an availability of the subscriber, upon non-receipt of a response of the second confirmation message, and the SG further causes the message to be resent to the one or more forward-to addresses.

123. The system of claim 122, wherein causing the message to be resent further comprises: sending by the SG to the sender the stored delivery outcome.

124. The system of claim 64, wherein the subscriber's visited switching address is a VMSC associated with the subscriber.

125. The system of claim 64, wherein the home location information database is an HLR associated with the subscriber.

126. The system of claim 64, wherein the visited location information database is a VLR associated with the subscriber.

127. A computer program product comprising a computer usable medium including a computer usable program code applying one or more value added service (VAS) on messages sent to a subscriber without affecting the subscriber's mobile communication, the computer program product comprising:
computer usable program code for receiving an activation request from the subscriber for activating one or more VAS, at a signaling gateway (SG);
computer usable program code for retrieving the subscriber's visited switching address and the subscriber's address from a home location information database associated with the subscriber;
computer usable program code for storing the subscriber's visited switching address, the home location information database address and an indication for activating the one or more VAS in a database associated with the SG;
computer usable program code for updating the home location information database so as to redirect the messages, sent to the subscriber's address, to the SG; and
computer usable program code for applying a logic corresponding to the VAS on the redirected messages, at the SG.

128. The computer program product of claim 127, further comprising: computer usable program code for storing in the database, a visited location information database associated with the subscriber's registered network.

129. The computer program product of claim 127, wherein computer usable program code for retrieving the subscriber's visited switching address further comprises: computer usable program code for sending a routing information query, corresponding to an IMSI of the subscriber, to the home location information database.

130. The computer program product of claim 127, wherein computer usable program code for updating the home location information database further comprises computer usable program code for sending a first registration message to the home location information database with the subscriber's visited switching address and a visited location information database being replaced by an address of SG.

131. The computer program product of claim 130, further comprising: computer usable program code for fetching the subscriber's visited switching address, upon receipt of a registration cancellation message at the SG from the home location information database.

132. The computer program product of claim 130, further comprising: computer usable program code for causing the home location information database to send a registration cancellation message to the visited location information database.

133. The computer program product of claim 130, further comprising: computer usable program code for relaying from the SG, a reset request for the subscriber's profile to one or more visited location information database associated with one of the home location information database and the subscriber's profile, upon receipt of the reset request from the home location information database, at the SG.

134. The computer program product of claim 130, further comprising: computer usable program code for causing restoration of subscriber's profile at the visited location information database, to facilitate the subscriber's mobile communication.

135. The computer program product of claim 134, wherein computer usable program code for causing the restoration further comprises: computer usable program code for sending a roaming number request to the visited location information database.

136. The computer program product of claim 135, further comprising: computer usable program code for sending profile restoration request from visited location information database to the home location information database.

137. The computer program product of claim 127, wherein computer usable program code for updating the home location information database further comprises: computer usable program code for sending a registration message to the home location information database with the subscriber's visited switching address being replaced by an address of SG.

138. The computer program product of claim 137, further comprising: computer usable program code for sending from the home location information database, a reset request for the subscriber's profile to one or more visited location information database associated with one of the home location information database and the subscriber's profile.

139. The computer program product of claim 137, further comprising: computer usable program code for receiving at the SG, an indication of at least one of an updated current switching address and an updated visited location information database, upon a receipt of a second registration message from the subscriber's address at the home location information database.

140. The computer program product of claim 139, further comprising: computer usable program code for monitoring the receipt of the second registration messages at the home location information data.

141. The computer program product of claim 140, wherein computer usable program code for monitoring further comprises: computer usable program code for tapping the exchange of messages at signaling links coupled to the home location information database.

142. The computer program product of claim 141, wherein computer usable program code for monitoring further comprises: computer usable program code for retrieving a location change notification from the home location information database.

143. The computer program product of claim 141, wherein computer usable program code for monitoring further comprises: computer usable program code for interfacing the home location information database.

144. The computer program product of claim 127, wherein computer usable program code for applying the VAS logic further comprises: computer usable program code for sending the redirected messages to one or more forward-to addresses, indicated in the subscriber's preferences in the activation request.

145. The computer program product of claim 144, wherein computer usable program code for applying the VAS logic further comprises: computer usable program code for storing the one or more forward-to addresses in the database.

146. The computer program product of claim 144, further comprising: computer usable program code for querying the home location information database to retrieve routing information corresponding to the one or more forward-to addresses associated with the subscriber.

147. The computer program product of claim 144, wherein computer usable program code for sending the redirected messages further comprises computer usable program code for:
extracting the subscriber's address from the activation request; and
retrieving at least one forward-to address from the one or more forward-to addresses stored in the database.

148. The computer program product of claim 144, further comprising: computer usable program code for resending the redirected messages to the forward-to address upon unsuccessful delivery of the redirected messages to the forward-to address in an earlier attempt.

149. The computer program product of claim 144, further comprising: computer usable program code for redirecting an MMS sent to the subscriber's address to a forward-to address.

150. The computer program product of claim 149, further comprising: computer usable program code for sending a forwarding request by the SG to a first MMSC associated with the subscriber for redirecting the MMS to the forward-to address.

151. The computer program product of claim 127, further comprising: computer usable program code for presenting an address of the SG to comprise a roaming identifier while the SG communicates with a first network.

152. The computer program product of claim 127, further comprising: computer usable program code for presenting an address of the SG to comprise a non-roaming identifier while the SG communicates with a first network.

153. The computer program product of claim 127, further comprising computer usable program code for:
receiving a de-activation request at the SG for deactivating one or more VAS; and
querying the database for status of the one or more VAS.

154. The computer program product of claim 153, further comprising computer usable program code for:
storing the de-activation request in the database; and
re-updating the home location information database so as to redirect the messages sent to the subscriber, to the subscriber's visited switching address.

155. The computer program product of claim 154, wherein re-updating the home location information database further comprises: computer usable program code for facilitating the subscriber's mobile communication.

156. The computer program product of claim 111, wherein re-updating the home location information database further comprises: computer usable program code for:
causing the home location information database to send a registration cancellation message to the SG, wherein the subscriber's visited switching address and a visited location information database were being replaced by an address of SG in a registration message sent from the SG to the home location information database; and
facilitating the subscriber's mobile communication.

157. The computer program product of claim 110, further comprising: computer usable program code for storing an indication of the de-activation request in the database associated.

158. The computer program product of claim 127, wherein applying the VAS logic further comprises computer usable program code for sending an indication from the SG to a blacklisted sender for a successful delivery of a message sent by the blacklisted sender to the subscriber.

159. The computer program product of claim 127, wherein applying the VAS logic further comprises: computer usable program code for sending a first confirmation message from the SG to a sender, after detecting the sender's status from the database.

160. The computer program product of claim 159, further comprising: computer usable program code for sending a second confirmation message from the SG to the subscriber's address.

161. The computer program product of claim 160, further comprising: computer usable program code for sending by the SG to the sender, an indication of successful delivery of the message at the subscriber's address, when the sender is indicated as blacklisted by the subscriber in a response of the second confirmation message.

162. The computer program product of claim 160, further comprising computer usable program code for:
storing in the database, an indication of the sender as a whitelisted; and
sending by the SG, the message to the one or more forward-to addresses.

163. The computer program product of claim 160, further comprising: computer usable program code for sending by the SG to the sender, an indication of unsuccessful delivery of the message at the subscriber's address, when the sender is unconfirmed to be one of whitelisted or blacklisted by the subscriber.

164. The computer program product of claim 163, further comprising computer usable program code for:
updating the home location information database for an availability of the subscriber, upon non-receipt of a response of the second confirmation message; and
causing the message to be resent to the one or more forward-to addresses.

165. The computer program product of claim 164, wherein computer usable program code for causing the message to be resent further comprises: computer usable program code for sending by the SG to the sender the stored delivery outcome.
